(19) United States
(12) Patent Application Publication
(10) Pub. No.: US 2026/0044189 A1
(43) Pub. Date: Feb. 12, 2026

(54) HINGE STRUCTURE AND FOLDABLE ELECTRONIC DEVICE INCLUDING THE SAME

(71) Applicant: SAMSUNG ELECTRONICS CO., LTD., Suwon-si (KR)

(72) Inventors: Jongkeun KIM, Suwon-si (KR); Wonyoung SEO, Suwon-si (KR); Hyeonseok SEO, Suwon-si (KR); Jinju LEE, Suwon-si (KR)

(21) Appl. No.: 19/296,938

(22) Filed: Aug. 12, 2025

Related U.S. Application Data
(63) Continuation of application No. PCT/KR2025/011987, filed on Aug. 8, 2025.

(30) Foreign Application Priority Data
Aug. 12, 2024 (KR) 10-2024-0107844
Nov. 22, 2024 (KR) 10-2024-0168612
Aug. 6, 2025 (KR) 10-2025-0108550

(51) Int. Cl. G06F 1/16

(52) U.S. Cl. CPC G06F 1/1681; G06F 1/1647; G06F 1/1652

(57) ABSTRACT

A foldable electronic device includes at least one of hinge structure with a friction structure disposed between a first arm member and a second arm member. The friction structure includes a first friction member including a first curved surface corresponding to a first outer peripheral surface of the first arm member, a second friction member including a second curved surface corresponding to a second outer peripheral surface of the second arm member, and a support member configured to allow the first curved surface of the first friction member to form a frictional contact with the first outer peripheral surface in at least a partial rotation range of the first arm member and to allow the second curved surface of the second friction member to form a frictional contact with the second outer peripheral surface in at least a partial rotation range of the second arm member.

### CROSS-REFERENCE TO RELATED APPLICATIONS

This application is a continuation application, under 35 U.S.C. § 111(a), of International Patent Application No. PCT/KR2025/011987, filed on Aug. 8, 2025, which claims priority to Korean Patent Application No. 10-2024-0107844, filed on Aug. 12, 2024, Korean Patent Application No. 10-2024-0168612, filed on Nov. 22, 2024 and Korean Patent Application No. 10-2025-0108550, filed on Aug. 6, 2025, the contents of which in their entirety are herein incorporated by reference.

### BACKGROUND

### 1. Field

Various embodiments of the disclosure relate to a foldable electronic device including a hinge structure.

### 2. Description of the Related Art

A portable electronic device, such as a smartphone, may support call functions and various content search functions based on various types of applications. The portable electronic device may output a screen corresponding to each function in a process of providing various functions. When the user uses the above-described various functions, the user may want to use a wider screen. In general, when a display device is to be expanded for screen display in a portable electronic device, the overall size of the electronic device has to be increased, which may deteriorate portability. Accordingly, a foldable portable electronic device, in which a display is folded to increase the size of the screen while maintaining portability has been provided. Such a foldable portable electronic device may have folded and unfolded states.

An electronic device having a hinge structure may include a plurality of housings that may support respective areas of a display in an unfolded state, and a hinge structure that interconnects the plurality of housings. The hinge structure may support connecting the plurality of housings and allowing them to be held at a predetermined angle while the plurality of housings are in a folded or unfolded state.

The information may be provided as related art to help understanding the disclosure. None of the above may be claimed as a prior art related to the disclosure or used to determine the prior art.

### SUMMARY

A foldable electronic device (a portable electronic device, a portable communication device, a foldable electronic device, or a foldable electronic device having a communication function) according to the disclosure includes a display, a first housing and a second housing, in which at least a portion of the display is disposed, and a hinge structure and coupled to the first housing and the second housing, at least any one of the hinge structures includes a first rotation member being rotated in response to rotation of the first housing, a second rotation member being rotated in response to rotation of the second housing, a first arm member being rotated in response to rotation of the first rotation member, a second arm member being rotated in response to rotation of the second rotation member, a first shaft coupled to the first arm member, a second shaft coupled to the second arm member, a third shaft and a fourth shaft disposed between the first shaft and the second shaft, a first elastic structure including a first elastic member disposed in the first shaft, a second elastic member disposed in the second shaft, a third elastic member disposed in the third shaft, and a fourth elastic member disposed in the fourth shaft, and a friction structure disposed between the first arm member and the second arm member. In an embodiment, the friction structure includes a first friction member disposed between the first elastic member and a portion of the first arm member, and including a first curved surface corresponding to a first outer peripheral surface of the first arm member, a second friction member disposed between the second elastic member and a portion of the second arm member, and including a second curved surface corresponding to a second outer peripheral surface of the second arm member, and a support member disposed between the first friction member and the second friction member, that presses the second friction member in a second direction facing the second arm member while pressing the first friction member in a first direction facing the first arm member based on an elastic force from the third elastic member and the fourth elastic member, that allows the first curved surface of the first friction member to form a frictional contact with the first outer peripheral surface of the first arm member in at least a partial rotation range of the first arm member and to allow the second curved surface of the second friction member to form a frictional contact with the second outer peripheral surface of the second arm member in at least a partial rotation range of the second arm member.

A hinge structure in an embodiment of the disclosure includes a first rotation member being rotated around a first axis, a first arm member being rotated in response to rotation of the first rotation member, a second rotation member being rotated around a second axis, a second arm member being rotated in response to rotation of the second rotation member, a first shaft fastened to the first arm member, a second shaft coupled to the second arm member, a third shaft disposed between the first shaft and the second shaft, a fourth shaft disposed between the third shaft and the second shaft, a first elastic structure including a plurality of elastic members disposed in the first shaft, the second shaft, the third shaft, and the fourth shaft, respectively, and a friction structure disposed between the first arm member and the second arm member, and the friction structure includes a first friction member disposed between the first elastic member and the first arm member, and including a first curved surface contacting a first outer peripheral surface of the first arm member, a second friction member disposed between the first elastic member and the second arm member, and including a second curved surface contacting a second outer peripheral surface of the second arm member, and a support member disposed between the first friction member and the second friction member, and that presses the first friction member and the second friction member.

### BRIEF DESCRIPTION OF DRAWINGS

The above and other embodiments, advantages and features of this disclosure will become more apparent by describing in further detail embodiments thereof with reference to the accompanying drawings.

FIG. 1A is a perspective view of an embodiment of a front surface of an electronic device. FIG. 1B is a plan view of a rear surface of an electronic device.

FIG. 2 is a partial exploded perspective view of an embodiment of the electronic device of FIGS. 1A and 1B including a hinge structure according to the disclosure.

FIG. 3 is a perspective view illustrating an embodiment of a first type hinge structure of a foldable electronic device.

FIG. 4 is a plan view illustrating an embodiment of a first type hinge structure of a foldable electronic device.

FIG. 5 is an exploded perspective view illustrating an embodiment of a first type hinge structure.

FIG. 6A is a view illustrating an embodiment of a first arm member, FIG. 6B is a view illustrating an embodiment of an interlocking gear, FIG. 6C is a view illustrating an embodiment of a cam member, FIG. 6D is a view illustrating an embodiment of states of an arm member and a cam member in an unfolded state, and FIG. 6E is a view illustrating an embodiment of states of an arm member and a cam member in an unfolded state in a folding electronic device.

FIG. 7 is a view illustrating an embodiment of a portion of a hinge structure including a friction structure.

FIG. 8 is a view illustrating an embodiment of a first friction member included in a friction structure.

FIG. 9 is a view illustrating an embodiment of a support member included in a friction structure.

FIG. 10 is a perspective view illustrating an embodiment of a coupling relationship between a friction structure of a hinge structure and a first arm member.

FIG. 11 is a plan view illustrating an embodiment of a hinge structure including a friction structure.

FIG. 12 is a view illustrating an embodiment of a force transmission state of a first friction member and a second friction member.

FIG. 13 is a view illustrating an embodiment of a force transmission state of a support member.

FIG. 14 is a view illustrating an embodiment of a state of a hinge structure in an unfolded state of a foldable electronic device.

FIG. 15 is a view illustrating an embodiment of states of a friction structure and a cam member in an unfolded state of a foldable electronic device.

FIG. 16 is a view illustrating an embodiment of a state of a hinge structure in an intermediate state of a first angle in a foldable electronic device.

FIG. 17 is a view illustrating an embodiment of a state of a friction structure and a cam member in an intermediate state of a first angle in a foldable electronic device.

FIG. 18 is a view illustrating an embodiment of a state of a hinge structure in a folded state of a foldable electronic device.

FIG. 19 is a view illustrating an embodiment of a state of a friction structure and a cam member in a folded state of a foldable electronic device.

FIG. 20 is a view illustrating an embodiment of a portion of a second type hinge structure.

FIG. 21 is a view illustrating an embodiment of a portion of a third type hinge structure.

FIG. 22 is a view illustrating an embodiment of a friction structure of a third type hinge structure in detail.

FIGS. 23A and 23B are views illustrating an embodiment of a portion of a fourth type hinge structure.

FIG. 24 is a view illustrating an embodiment of a friction structure member included in a friction structure of a fourth type hinge structure.

FIG. 25 is a view illustrating an embodiment of a support member included in a friction structure.

FIG. 26 is a view illustrating an embodiment of a portion of a fifth type hinge structure.

FIG. 27 is views illustrating an embodiment of an arm member and an interlocking member of a hinge structure.

FIGS. 28A, 28B, and 28C are views illustrating an embodiment of a slide motion of an interlocking member.

FIG. 29 is a view illustrating an embodiment of a rotation member and a spiral rotation member included in a hinge structure.

FIG. 30 is a view illustrating an embodiment of a portion of a sixth type hinge structure.

FIG. 31 is a view illustrating an embodiment of a portion of a seventh type hinge structure.

FIG. 32 is a view illustrating an embodiment of an arm member included in a seventh type hinge structure.

FIG. 33 is a view illustrating an embodiment of a disposition of an arm member and a friction member in an unfolded state of a seventh type hinge structure.

FIG. 34 is a view illustrating an embodiment of a disposition of an arm member and a friction member in an intermediate state of a seventh type hinge structure.

FIG. 35 is a view illustrating an embodiment of a disposition of an arm member and a friction member in a folded state of a seventh type hinge structure.

FIG. 36 is a view illustrating an embodiment of a portion of an eighth type hinge structure.

FIG. 37 is a view illustrating an embodiment of a portion of an arm member included in an eighth type hinge structure.

FIG. 38 is a view illustrating an embodiment of a friction member included in an eighth type hinge structure.

FIG. 39A is a view illustrating an embodiment of an unfolded state of an electronic device, and FIG. 39B is a view illustrating an embodiment of a folded state of an electronic device.

FIG. 40 is an exploded perspective view of an embodiment of at least a portion of an electronic device including a hinge.

FIG. 41 is a view illustrating an embodiment of a plurality of housings, on which a hinge is disposed (e.g., mounted).

FIG. 42 is a view illustrating an embodiment of a hinge structure included in a first hinge and a hinge structure included in a second hinge.

### DETAILED DESCRIPTION

Hereinafter, various embodiments of the disclosure may be described with reference to accompanying drawings.

Hereinafter, various embodiments of the disclosure may provide a foldable electronic device that may implement slimness by decreasing a thickness of a hinge structure.

The foldable electronic device in an embodiment may include a portable electronic device, such as a smartphone, a tablet, a notebook computer, a slate PC, or a laptop computer, and may support a call function and various content providing functions based on various types of applications.

The foldable electronic device in an embodiment may secure a frictional force that is desired to maintain an angle in a flex operation through a cylindrical frictional force and a rotational frictional force even when a size of a cam member is decreased even when the frictional force due to the cam operation is decreased in a process of implementing a slim foldable electronic device.

In addition, various purposes and effects provided by the foldable electronic device including an improved hinge structure according to various embodiments may be mentioned in embodiments of the detailed description.

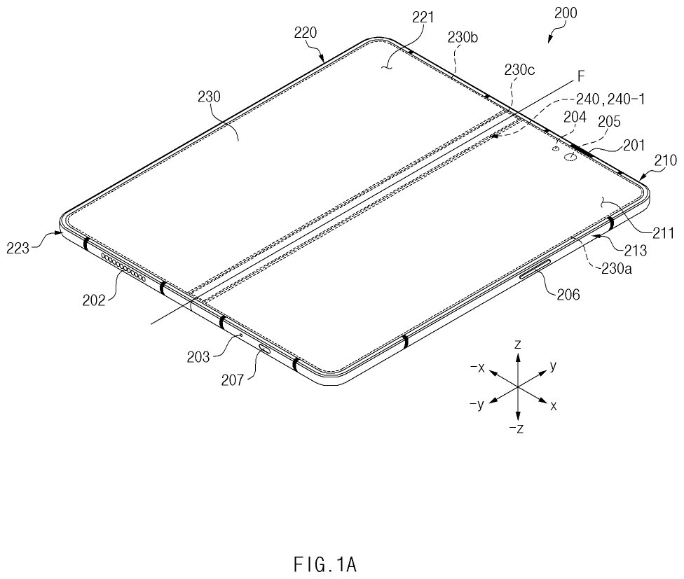

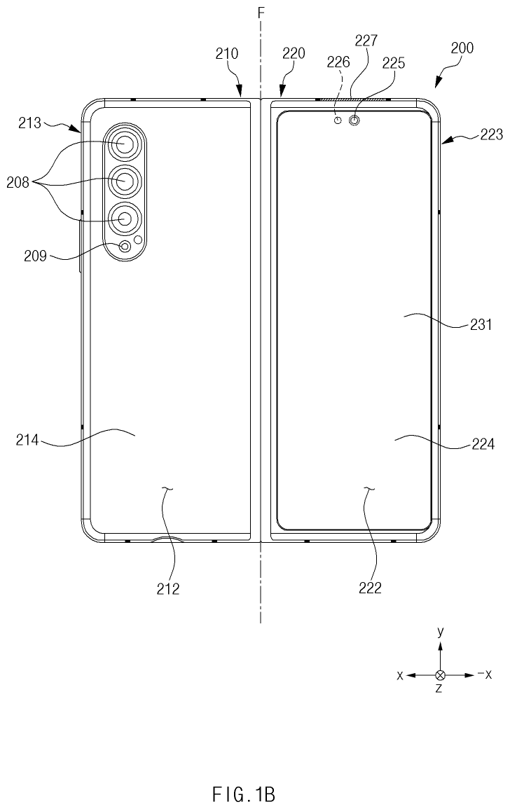

FIG. 1A is a perspective view of an embodiment of a front surface of an electronic device. FIG. 1B is a plan view of an embodiment of a rear surface of an electronic device.

Referring to FIGS. 1A and 1B, an electronic device 200 may include a first housing 210 (e.g., a first housing structure) including a first side member 213 (e.g., a side bezel) and a second housing 220 (e.g., a second housing structure) including a second side member 223 (e.g., a side bezel). The first housing 210 and the second housing 220 are coupled to each other to be foldable with respect to each other through at least one hinge structure 240 and 240-1 (e.g., a hinge module or a hinge device), with respect to a folding axis “F”. In an embodiment, the first housing 210 and the second housing 220 may be configured as foldable housings (e.g., housing structures), for example. In an embodiment, the electronic device 200 may include a first display 230 (e.g., a flexible display, a foldable display, or a main display) that is disposed to be supported by the first housing 210 and the second housing 220, for example. In an embodiment, the first housing 210 may include a first surface 211, and a second surface 212 that faces an opposite direction (e.g., the −z-axis direction) to the first surface 211, for example. In an embodiment, the second housing 220 may include a third surface 221, and a fourth surface 222 that faces an opposite direction (e.g., the −z-axis direction) to the third surface 221, for example. In an embodiment, the first housing 210 may include a first rear cover 214 that is coupled to the first side member 213, for example. In an embodiment, the second housing 220 may include a second rear cover 224 that is coupled to the second side member 223, for example. In an embodiment, when the electronic device 200 is in a fully unfolded first state (e.g., an unfolding state or an unfolded state), the first surface 211 and the third surface 221 may be operated to face substantially the same direction (e.g., the z-axis direction), for example. In an embodiment, when the electronic device 200 is in a fully folded second state (e.g., a folding state or a folded state), the first surface 211 and the third surface 221 may be operated to face each other or to face opposite directions, for example. In an embodiment, the electronic device 200 may be operated to be maintain in a third state (e.g., an intermediate state) between the first state and the second state, for example.

In an embodiment, the electronic device 200 may include a first receiver 201 that is disposed on the first surface 211 of the first housing 210, at least one first sensor module 204 (e.g., an illuminance sensor), and/or at least one first camera module 205 (e.g., an under-display camera (UDC)). In an embodiment, the electronic device 200 may include at least one key 206 that is disposed in the first side member 213, for example. In an embodiment, the electronic device 200 may include at least one second camera module 208 and/or a flash 209 that are disposed on the second surface 212 (e.g., the first rear cover 214) of the first housing 210, for example. In an embodiment, the electronic device 200 may include a second display 231 that is disposed on a fourth surface 222 of the second housing 220, at least one third camera module 225 (e.g., a UDC), at least one second sensor module 226, and/or a second receiver 227, for example. In an embodiment, the second display 231 may be viewed from the outside through at least a portion of the second rear cover 224, for example. In an embodiment, the electronic device 200 may include a speaker 202 that is disposed in the second side member 223, a microphone 203 that is disposed in the first side member 213, and/or a connector port 207, for example. At least some of the plurality of components described above may be disposed in the first housing 210 and/or the second housing 220 through changes.

In an embodiment, the first display 230 (e.g., the flexible display) may include a first area 230a (e.g., a first planar part) corresponding to at least a portion of the first surface 211, a second area 230b (e.g., a second planar part) corresponding to at least a portion of the third surface 221, and a third area 230c (e.g., a flexible part) that connects the first area 230a and the second area 230b, and in which the electronic device 200 is changed from the second state (e.g., the folding state) and/or the third state. In an embodiment, the third area 230c may be disposed in a position, in which the first display 230 at least partially overlaps at least one hinge structure 240 and 240-1 when it is viewed from a top (e.g., in the z-axis direction), for example. In an embodiment, in the second state, the first display 230 may be disposed such that the first surface 211 and the third surface 221 face each other not to be viewed from the outside (e.g., an in-fold type), for example. In an embodiment, in the second state, the first display 230 may be disposed such that the first surface 211 and the third surface 221 face opposite directions to be viewed from the outside (e.g., an out-fold type), for example.

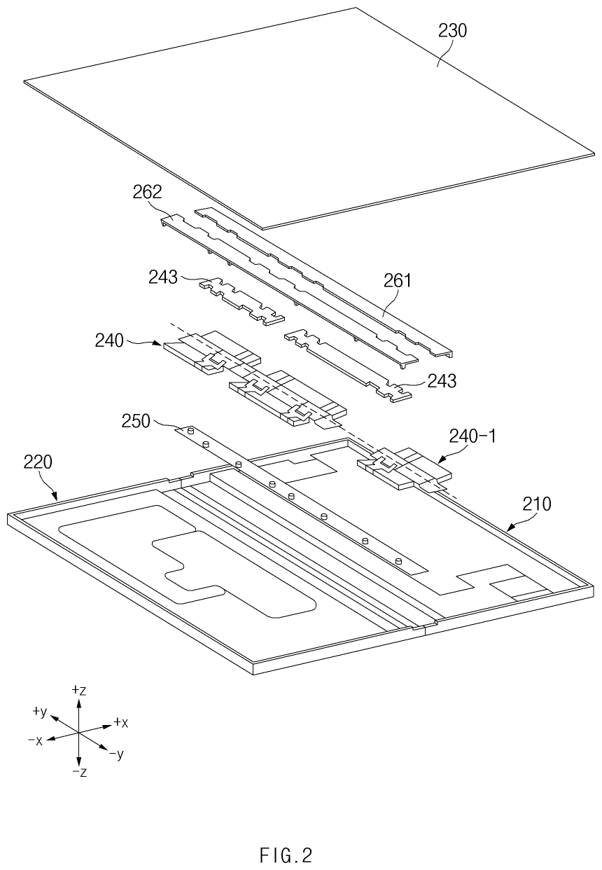

FIG. 2 is a partial exploded perspective view of an embodiment of the electronic device of FIGS. 1A and 1B including an embodiment of a hinge structure according to the disclosure.

Referring to FIG. 2, the electronic device 200 may include at least one hinge structure 240 and 240-1 (e.g., a hinge module or a hinge device) that connects the first housing 210 and the second housing 220 under the first display 230 (e.g., the −z-axis direction). In an embodiment, the at least one hinge structure 240 and 240-1 may include a first hinge structure 240, and a second hinge structure 240-1 that is spaced apart from the first hinge structure 240 in a direction (e.g., ±y-axis direction) that is parallel to the folding axis “F”, for example. In an embodiment, the at least one hinge structure 240 and 240-1 may be disposed between the first housing 210 and the second housing 220 not to be visible from the outside through a hinge housing 250 (e.g., a hinge cover), for example.

In a folded state, the electronic device 200 may support securing a folding curvature “R” that prevents cracks or buckling from occurring in a folded area (or a folding area) of the first display 230 by forming the folded area of the first display 230 in a shape of a water droplet (or a dumbbell shape), to which the gravity is applied. Furthermore, by disposing the dumbbell-shaped display folded area in a predetermined space of the housings 210 and 220, the housings 210 and 220 may be disposed to face each other when the electronic device 200 is in the folded state, and thus, a gap between the housings 210 and 220 having an 11-shaped disposition state may be decreased. Accordingly, an overall size of the electronic device 200 may be decreased by reducing a gap between the housings 210 and 220 in the folded state, and block or reduce introduction of foreign substances between the housings 210 and 220.

In an embodiment, the electronic device may include at least one center bar 243 that is disposed between the first display 230 and the hinge structures 240 and 240-1. The center bar 243 may be disposed to cover at least a portion of a central area of at least one of the first hinge structure 240 and the second hinge structure 240-1. In an embodiment, the center bar 243 may be disposed to cover at least a portion of a central area of each of the first hinge structure 240 and the second hinge structure 240-1. The center bar 243 may be fastened and fixed to at least one of the hinge housing 250 and the hinge structures 240 and 240-1.

Wing plates 261 and 262 are coupled to the at least one hinge structure 240 and 240-1, and is disposed to cover at least a portion of a surface, in the z-axis direction, of the at least one hinge structure 240 and 240-1 when the electronic device 200 is in the unfolded state. The wing plates 261 and 262 are provided in a form, in which they are separated from the housings 210 and 220. Accordingly, a gap may be formed between the wing plates 261 and 262 and the housings 210 and 220. The wing plates 261 and 262 may be disposed on opposite sides with the center bar 243 interposed therebetween. In an embodiment, the first wing plate 261 may be disposed in the x-axis direction with respect to the center bar 243, and the second wing plate 262 may be disposed in the −x-axis direction with respect to the center bar 243, for example. In a state, in which the wing plates 261 and 262 are coupled to the hinge structures 240 and 240-1, they may be disposed at the same height or on the same xy plane as that of the center bar 243 with respect to the z axis. The wing plates 261 and 262 may be rotated clockwise or counterclockwise in response to a hinge operation of at least one hinge structure 240 and 240-1. In an embodiment, the second wing plate 262 may be rotated clockwise while the first wing plate 261 is rotated counterclockwise, and the second wing plate 262 may be rotated counterclockwise while the first wing plate 261 is rotated clockwise, for example. The first wing plate 261 may support a flat first surface of the third area 230c of the display 230, which is folded in a dumbbell shape (or a water droplet shape, to which the gravity is applied), and the second wing plate 262 may support a flat second surface (a surface that is symmetrical to the first surface with respect to the z axis) of the third area 230c of the display 230, which is folded in a dumbbell shape.

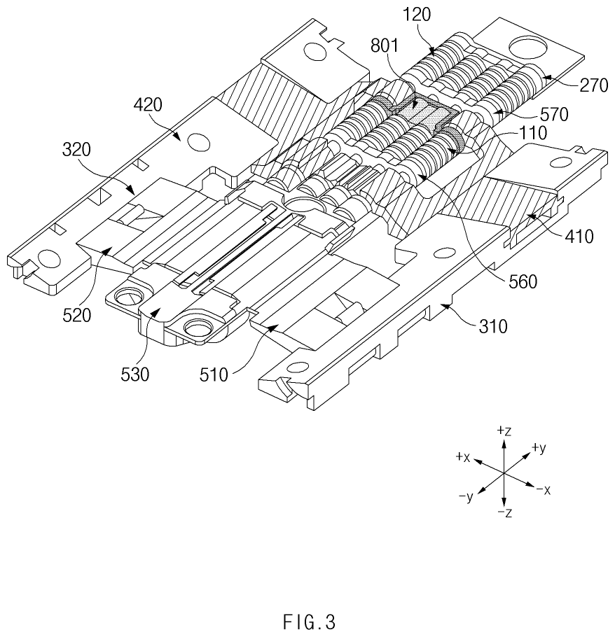

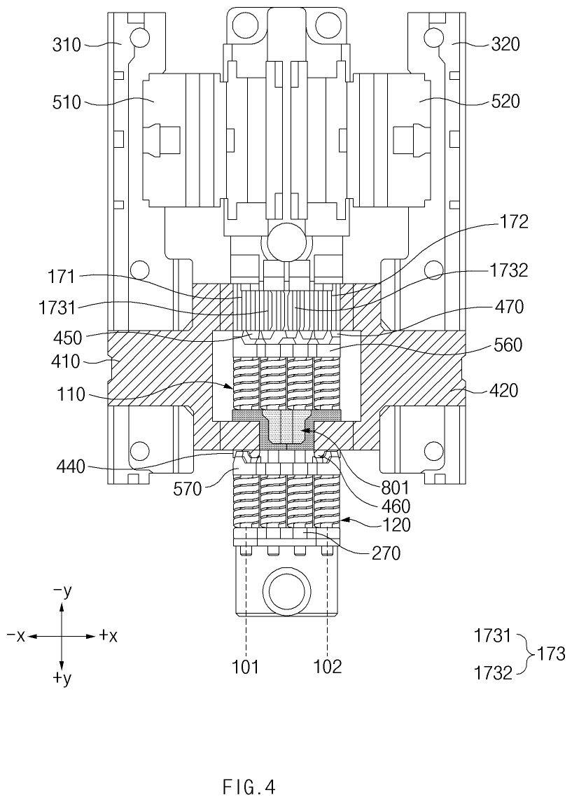

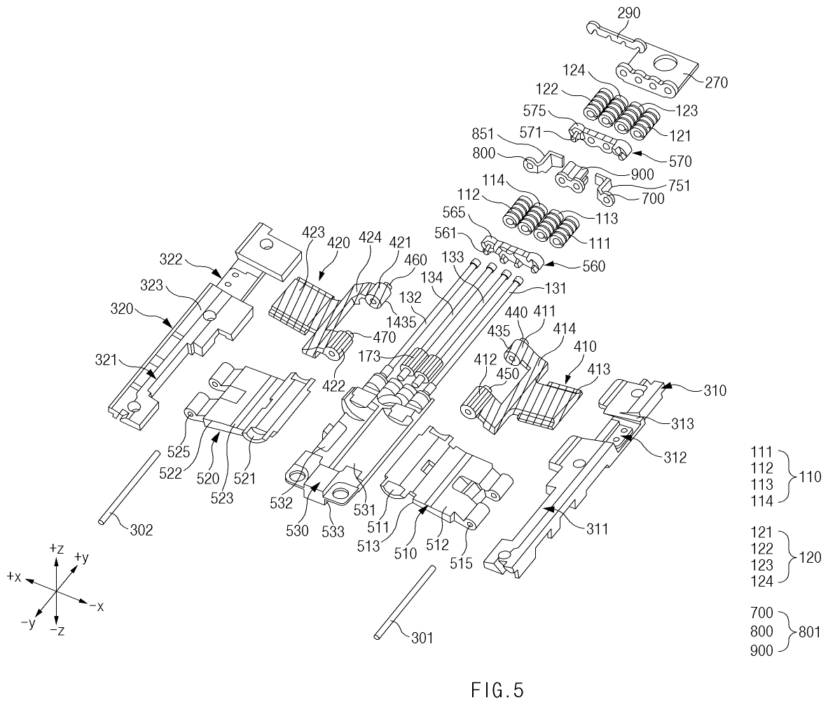

FIG. 3 is a perspective view illustrating an embodiment of a first type hinge structure of a foldable electronic device, FIG. 4 is a plan view illustrating an embodiment of a first type hinge structure of a foldable electronic device, and FIG. 5 is an exploded perspective view illustrating an embodiment of a first type hinge structure. In FIGS. 3, 4, and 5, the first hinge structure 240, among the first type hinge structures 240 and 240-1, will be described as an example. The configuration of the first hinge structure 240 described in FIGS. 3, 4, and 5 may have the same or similar structure and configuration to those of the second hinge structure 240-1 described above.

Referring to FIGS. 1 to 5, a first hinge structure (hereinafter, also referred to as a first type hinge structure) 240 includes a fixing bracket 530 (or center bracket), a first rotation member 510 (or a first rotation structure or a first rotation body), a second rotation member 520 (or second rotation structure or a second rotation body), a first link member 310 (or a first slide link, a first rotation support structure, or a first arm link member), a second link member 320 (or a second slide link, a second rotation support structure, or a first rotation link member), a first arm member 410 (or a first arm structure or a first arm), and a second arm member 420 (or a second arm structure or a second arm).

In an embodiment, at least one of the components included in the first hinge structure 240 may be omitted. In an embodiment, when the first rotation member 510 and the second rotation member 520 are directly coupled to the housings 210 and 220, the arm members 410 and 420 are rotated in response to the rotation of the rotation members 510 and 520 while being coupled to the rotation members 510 and 520, the first link member 310 and the second link member 320 may be omitted, for example.

The first hinge structure 240 includes a plurality of shafts 131, 132, 133, and 134, cam members 560 and 570 (or cam structures), a first main gear 171, a second main gear 172, at least one interlocking gear 173, a shaft fixing part 270 (or a shaft bracket), at least one cam member 560 and 570, a first elastic structure 110 (or an elastic assembly, an elastic coupling body, an elastic assembly, or an elastic unit), a second elastic structure 120, and a plurality of coupling members 290 (or fixing clips or E-rings).

At least a portion of at least some of the above-described components of the first hinge structure 240 may include or consist of a metallic material and may have a predetermined rigidity. In an alternative embodiment, when desired, the first hinge structure 240 may have a reinforced plastic or resin material. In an embodiment, at least a portion of the above-described first hinge structure 240 may be omitted or modified. In an embodiment, washer rings may be provided corresponding to the plurality of shafts 131, 132, 133, and 134, and in another embodiment, at least some of washer rings may be omitted, for example. In an alternative embodiment, a predetermined structure or configuration may be integrated or incorporated into another structure or configuration. The first hinge structure 240 in an embodiment may include a friction structure 801 (or a first friction structure, a friction member, a force transmission member, a torque providing member) that generates rotation friction with the arm member, and generates cylindrical friction with the arm member.

The fixing bracket 530 may include a bracket body 533, a first rail 531 (or a first fixed rail), and a second rail 532 (or a second fixed rail). Grooves, in which one side periphery (e.g., the +y-axis periphery) of at least any one of a first shaft 131 (or a first outer shaft), a second shaft 132 (or a second outer shaft), a third shaft 133 (or a first inner shaft), and a fourth shaft 134 (or a second inner shaft) may be held, may be formed on one side (e.g., a side wall that faces the −y-axis direction) of the bracket body 533. Grooves, in which at least one interlocking gear 173 may be disposed (e.g., mounted), may be formed on one side (e.g., a side wall that faces the y-axis direction) of the bracket body 533.

At least a portion of the fixing bracket 530 may be seated on and fixed to one side of the hinge housing 250. In an embodiment, the fixing bracket 530 may be fixed to a −y-axis periphery or a y-axis periphery of the hinge housing 250. The fixing bracket 530 may include a structure (e.g., a first rail 531 and a second rail 532), in which a portion of the first rotation member 510 (e.g., a first rail structure 511) and a portion of the second rotation member 520 (e.g., a third rail structure 521) may be rotatably fastened, for example.

The first rail 531 of the fixing bracket 530 may be formed in a structure corresponding to the first rail structure 511 of the first rotation member 510, and the second rail 532 may be formed in a structure corresponding to the third rail structure 521 of the second rotation member 520. At least a portion of a cross section of the first rail 531 and/or the second rail 532 in a direction from an upper surface (e.g., a surface that faces the +z axis) to a lower surface (e.g., a surface that faces the-z axis) of the fixing bracket 530 may include an arc shape or a half-moon shape.

The first rail 531 of the fixing bracket 530 may be displaced in the-x-axis direction than the second rail 532 with respect to the first axis 101 and the second axis 102, and the second rail 532 may be displaced in the +x-axis direction than the first rail 531 with respect to the first axis 101 and the second axis 102.

In an embodiment, the first axis 101 and the second axis 102 may be spaced apart from each other by a specified interval. In an embodiment, an interval between the first axis 101 and the second axis 102 may be smaller than an interval between the first shaft 131 and the second shaft 132. In an embodiment, the first axis 101 and the second axis 102 may be formed above the first shaft 131 and the second shaft 132 with respect to the z axis. In an alternative embodiment, the first axis 101 and the second axis 102 may be formed closer to the first display 230 than the first shaft 131 and the second shaft 132 with respect to the z axis.

The first rotation member 510 may include a first rotation body 513, a first rail structure 511 that extends to one end (e.g., an end in the x-axis direction) of the first rotation body 513, and a second rail structure 512 that extends to an opposite end (e.g., an end in the −x-axis direction) of the first rotation body 513. The first rotation body 513 may be disposed between the first rail structure 511 and the second rail structure 512 having a rail shape. At least a portion of the first rotation body 513 may be fastened to an opposite side of the fixing bracket 530. The first rail structure 511 and the second rail structure 512 may be stepped with respect to the first rotation body 513.

The first rail structure 511 of the first rotation member 510 may be fastened to one side (e.g., the first rail 531) of the fixing bracket 530 to be hinged. The second rail structure 512 of the first rotation member 510 may be coupled to one side of the first link member 310 to perform a sliding operation (or a rotation operation or an arc operation) in response to the hinge operation (or a rotation operation or a sliding operation) of the first rail structure 511. A first rotation pin 301 may be inserted into a first pin opening 515 formed in the second rail structure 512 of the first rotation member 510. The second rail structure 512 of the first rotation member 510 may be coupled to the third rail 311 of the first link member 310 by the first rotation pin 301. While the first link member 310 coupled to the first housing 210 is moved in response to the movement of the first housing 210, the first rail structure 511 of the first rotation member 510, which is fastened to the fixing bracket 530, may be rotated in place around the first axis 101. In an embodiment, the second rail structure 512 of the first rotation member 510 may be rotated (or slid) in the first link member 310 while being moved in one direction (e.g., counterclockwise while the foldable electronic device 200 is folded from the unfolded state or clockwise while the foldable electronic device 200 is unfolded from the folded state). At least a portion of the first wing plate 261, among the wing plates 261 and 262, may be fixed to the first rotation member 510. In this regard, the first rotation body 513 may include at least one hole or groove that is to be coupled to the first wing plate 261.

In an embodiment, the second rotation member 520 may include a second rotation body 523, a third rail structure 521 that extends to an opposite end (e.g., an end in the −x-axis direction) of the second rotation body 523, and a fourth rail structure 522 that extends to one end (e.g., an end in the +x-axis direction) of the second rotation body 523. The second rotation body 523 may be disposed between the third rail structure 521 and the fourth rail structure 522 having a rail shape. At least a portion of the second rotation body 523 may be fastened to one side of the fixing bracket 530. The third rail structure 521 and the fourth rail structure 522 may be stepped with respect to the second rotation body 523.

The third rail structure 521 may be fastened to an opposite side (e.g., the second rail 532) of the fixing bracket 530 to be hinge. The third rail structure 521 may be rotated in place around the second axis 102 while the second link member 320 coupled to the second housing 220 is moved in response to the movement of the second housing 220. In an embodiment, the third rail structure 521 may include a rail structure that is similar to or the same as that of the first rail structure 511.

The fourth rail structure 522 may be coupled to the second link member 320. A second rotation pin 302 may be inserted into a second pin opening 525 formed in the fourth rail structure 522 of the second rotation member 520. The fourth rail structure 522 of the second rotation member 520 may be coupled to the fourth rail 321 of the second link member 320 by the second rotation pin 302. The fourth rail structure 522 may be rotated (or slid) in the second link member 320 while being moved in one direction (e.g., counterclockwise while the foldable electronic device 200 is folded from the unfolded state or clockwise while the foldable electronic device 200 is unfolded from the folded state). In this regard, the second link member 320 may include rail wings, in which an empty space formed at a center thereof similar to the first link member 310, and including curved surfaces disposed on opposite sides thereof. In an embodiment, the fourth rail structure 522 may include a rail structure that is similar to or the same as that of the second rail structure 512.

The second rotation member 520 may be moved in an opposite direction to the first rotation member 510. In an embodiment, while the first rail structure 511 of the first rotation member 510 is rotated in place counterclockwise, the third rail structure 521 of the second rotation member 520 may be rotated in place clockwise, for example.

While the foldable electronic device 200 is folded, the first rail structure 511 of the first rotation member 510 may be rotated counterclockwise, and the first link member 310 inserted into the second rail structure 512 may be slid clockwise along the second rail structure 512. Because the sliding operation is relative, the first link member 310 may be slid clockwise with respect to the second rail structure 512. While the foldable electronic device 200 is folded, the third rail structure 521 of the second rotation member 520 may be rotate clockwise along the second rail 532 of the fixing bracket 530, and the second link member 320 inserted into the fourth rail structure 522 may slide counterclockwise. The second link member 320 may be slid clockwise with respect to the fourth rail structure 522.

In an embodiment, the first link member 310 may include a structure that is coupled and fixed to one side of the first housing 210. The first link member 310 may include a third rail 311, on which a portion (e.g., the second rail structure 512) of the first rotation member 510 is seated. The first link member 310 may include a first sliding holding part 312, on which a first slide part 413 of the first arm member 410 is seated. A length of the first link member 310 in the y-axis direction may be larger than a length thereof in the x-axis direction such that it may accommodate the third rail 311 and the first sliding holding part 312. A first link body 313 of the first link member 310 may be fixed to the first housing 210. The third rail 311 may be disposed in one direction (e.g., the −y-axis direction) of the first link body 313. The first sliding holding part 312 may be disposed in an opposite direction (e.g., the +y-axis direction) of the first link body 313. The first slide part 413 of the first arm member 410 may be seated on the first sliding holding part 312 to guide the sliding operation of the first slide part 413.

In an embodiment, the second link member 320 may include a structure that is coupled and fixed to one side of the second housing 220. The second link member 320 may include a fourth rail 321, on which a portion (e.g., the fourth rail structure 522) of the second rotation member 520 is seated. The second link member 320 may include a second sliding holding part 322, on which a second slide part 423 of the second arm member 420 is seated. A length of the second link member 320 in the y-axis direction may be larger than a length thereof in the x-axis direction such that it may accommodate the fourth rail 321 and the second sliding holding part 322. The second link body 323 of the second link member 320 may be fixed to the second housing 220. The fourth rail 321 may be disposed in one direction (e.g., the −y-axis direction) of the second link body 323. The second sliding holding part 322 may be disposed in an opposite direction (e.g., the +y-axis direction) of the second link body 323. The second slide part 423 of the second arm member 420 may be seated on the second sliding holding part 322 to guide the sliding operation of the second slide part 423.

In an embodiment, the first arm member 410 may be symmetrical to the second arm member 420 with respect to the +y axis or the −y axis. The first arm member 410 may be rotated in the −x-axis direction from the z axis or in the z-axis direction from the −x axis. The first arm member 410 may include a first arm body 414, a first slide part 413, a first arm part 411, and a second arm part 412. The first arm body 414 may be disposed between the first arm part 411 and the second arm part 412. The first arm part 411 is formed to extend from the first arm body 414 in the x-axis direction, and may include a first arm hole 441, through which the first shaft 131 passes. A peripheral structure that defines the first arm hole 441 may be provided with a cam structure that performs a cam operation while contacting one side (e.g., a cam portion disposed in the −y-axis direction) of a second cam member 570. The cam structure of the first arm part 411 may be formed on a surface (e.g., a surface in the +y-axis direction of the first arm part 411 or a central direction of the hinge housing 250) that faces the second cam member 570. The second arm part 412 is formed to extend from the first arm body 414 in the x-axis direction, and may be spaced apart from the first arm part 411. The second arm part 412 may include a through-hole such that the first shaft 131 may pass therethrough. The through-hole included in the second arm part 412 and the through-hole included in the first arm part 411 may communicate with each other. A cam structure that performs a cam operation while contacting one side (e.g., a cam portion disposed in the −y-axis direction) of the first cam member 560 may be provided in a peripheral structure that defines the through-hole of the second arm part 412. The cam structure of the second arm part 412 may be formed on a surface (e.g., a surface in the +y-axis direction of the second arm part 412 or a central direction of the hinge housing 250) that faces the second cam member 570. The first slide part 413 may be formed to extend from the first arm body 414 in the −x-axis direction. The first slide part 413 may be fastened to the first link member 310 to perform a sliding operation along the rail wings formed in the first sliding holding part 312 while the foldable electronic device 200 performs a hinge operation. The first slide part 413 may include rail grooves that may be fastened to the rail wings formed on the first sliding holding part 312 of the first link member 310.

In an embodiment, the second arm member 420 may be symmetrical to the first arm member 420 with respect to the +y axis or the −y axis. The second arm member 420 may be rotated in the x-axis direction from the z axis or in the z-axis direction from the x axis. The second arm member 420 may be rotated in a direction that is opposite to the direction of a motion of the first arm member 410. The second arm member 420 may include a second arm body 424, a third arm part 421, a fourth arm part 422, and a second slide part 423. The second arm body 424 may be disposed between the third arm part 421 and the fourth arm part 422. The fourth arm part 422 is formed to extend from the second arm body 424 in the −x-axis direction, and may include a through-hole, through which the second shaft 132 passes. A peripheral structure that defines the through-hole may be provided with a cam structure that performs a cam operation while contacting one side (e.g., a cam portion disposed in the −y-axis direction) of the second cam member 570. The cam structure of the third arm part 421 may be formed on a surface (e.g., a surface in the +y-axis direction of the third arm part 421 or a central direction of the hinge housing 250) that faces the second cam member 570. The fourth arm part 422 is formed to extend from the second arm body 424 in the −x-axis direction, and may be spaced apart from the third arm part 421. The fourth arm part 422 may include a through-hole such that the second shaft 132 may pass therethrough. The through-hole included in the fourth arm part 422 and the through-hole included in the third arm part 421 may communicate with each other. A cam structure that performs a cam operation while contacting one side (e.g., a cam portion disposed in the −y-axis direction) of the first cam member 560 may be provided in a peripheral structure that defines the through-hole of the fourth arm part 422. The cam structure of the fourth arm part 422 may be formed on a surface (e.g., a surface in the +y-axis direction of the fourth arm part 422 or a central direction of the hinge housing 250) that faces the first cam member 560. The second slide part 423 may be formed to extend from the second arm body 424 in the −x-axis direction. The second slide part 423 may be fastened to the second link member 320 to perform a sliding operation along the rail wings formed in the second sliding holding part 322 while the foldable electronic device 200 performs a hinge operation. The second slide part 413 may include rail grooves that may be fastened to the rail wings formed on the second sliding holding part 322 of the second link member 320.

In an embodiment, the first shaft 131 may have a rod shape, in which a length thereof in the y-axis or −y-axis direction is larger than a length thereof in the x-axis or z-axis direction. The first shaft 131 may include or consist of a metallic material to support inserted components. In an embodiment, a portion of the first arm part 411 of the first arm member 410, the second arm part 412, the cam members 560 and 570, the first friction member 700 of the friction structure 801, the at least one washer ring, the first elastic member 111, the fifth elastic member 121, the shaft fixing part 270, and the coupling member 290 may be inserted into the first shaft 131.

In an embodiment, the second shaft 132 may have a shape that is the same as or similar to that of the first shaft 131. In an embodiment, the second shaft 132 may have a rod shape, in which a length thereof in the y-axis or −y-axis direction is larger than a length thereof in the x-axis or z-axis direction, for example. The second shaft 132 may include or consist of a metallic material having a strength that is greater than or equal to a specified magnitude to support the inserted components. In an embodiment, a portion of the third arm part 421 of the second arm member 420, the fourth arm part 422, the cam members 560 and 570, the second friction member 800 of the friction structure 801, the at least one washer ring, the second elastic member 112, the sixth elastic member 122, the shaft fixing part 270, and the coupling member 290 may be inserted into the second shaft 132.

In an embodiment, the third shaft 133 may have a shape that is the same as or similar to that of the first shaft 131. In an embodiment, the third shaft 133 may have a rod shape, in which a length thereof in the y-axis or −y-axis direction is larger than a length thereof in the x-axis or z-axis direction, for example. In an embodiment, a portion of the first interlocking gear 1731, the cam members 560 and 570, the support member 900 (or the third friction member) of the friction structure 801, the first friction member 700, the second friction member 800, at least one washer ring, the third elastic member 113, the seventh elastic member 123, the shaft fixing part 270, and the coupling member 290 may be inserted into the third shaft 133, for example.

In an embodiment, the fourth shaft 134 may have a shape that is the same as or similar to that of the third shaft 133. In an embodiment, the fourth shaft 134 may have a rod shape, in which a length thereof in the y-axis or −y-axis direction is larger than a length thereof in the x-axis or z-axis direction. The fourth shaft 134 may include or consist of a metallic material having a strength that is greater than or equal to a specified magnitude to support the inserted components. In an embodiment, a portion of the second interlocking gear 1732, the cam members 560 and 570, the support member 900 of the friction structure 801, the first friction member 700, the second friction member 800, at least one washer ring, the fourth elastic member 114, the eighth elastic member 124, the shaft fixing part 270, and the coupling member 290 may be inserted into the fourth shaft 134, for example.

The first cam member 560 may include a first cam body 565 and at least one first moving cam part 561. One surface (e.g., a surface that faces the +y axis) of the first cam body 565 may be formed to support the first elastic structure 110. At least one first moving cam part 561 may be formed on an opposite surface (e.g., a surface that faces the −y axis) of the first cam body 565. The first moving cam part 561 may be engaged with the first cam structure 450 formed in the first arm part 411 of the first arm member 410. In the first moving cam part 561, a mountain portion and a valley portion formed in a state of rising (or protruding) in the −y-axis direction may be repeatedly disposed. An apex portion of the mountain portion of the first moving cam part 561 may be higher than the surroundings (e.g., the valley portion) thereof, and the apex portion may be flat.

The second cam member 570 may include a second cam body 575 and at least one second moving cam part 571. The second cam member 570 may include a plurality of second cam holes, on which at least a portion of each of the first shaft 131, the second shaft 132, the third shaft 133, and the fourth shaft 134 is held. Each of the plurality of second cam holes may be formed to pass in the y-axis or −y-axis direction, and may be formed at a central portion of the second moving cam part 571. At least a portion of each of the first shaft 131, the second shaft 132, the third shaft 133, and the fourth shaft 134 may be inserted into the second cam hole of the second cam member 570, and at least a portion of each of the first shaft 131, the second shaft 132, the third shaft 133, and the fourth shaft 134 may be held in the second cam hole. The second cam body 575 may have a cylindrical shape that surrounds the second cam hole defined to pass in the y-axis or −y-axis direction at the center in volume. The second moving cam part 571 may be engaged with the third cam structure 440 formed in the first arm part 411 of the first arm member 410. In the second moving cam part 571, a mountain portion and a valley portion formed in a state of rising (or protruding) in the −y-axis direction may be repeatedly disposed. An apex portion of the mountain portion of the second moving cam part 571 may be higher than the surroundings (e.g., the valley portion) thereof, and the apex portion may be flat.

In an embodiment, the cam members 560 and 570 may retreat in one direction (e.g., the +y-axis direction) in response to cam operations of the cam structure and the cam members 560 and 570 of the first arm member 410 and the cam structure and the cam members 560 and 570 of the second arm member 420 while the first arm member 410 and the second arm member 420 are rotated within a predetermined angle range, and may be moved in an opposite direction (e.g., the y-axis direction) to the one direction by elasticity of the first elastic structure 110 and the second elastic structure 120 to return to an original position when the mountains and the valleys of the cams (e.g., the cam structures and the cam parts) are engaged with each other.

In an embodiment, the friction structure 801 may be disposed to contact the first arm part 411 and the second arm part 412 of the arm member while being disposed to pass through the first shaft 131, the second shaft 132, the third shaft 133, and the fourth shaft 134.

After the first shaft 131 is inserted into the first friction member 700 of the friction structure 801 and the first arm member 410, the second shaft 132 is inserted into the second friction member 800 of the friction structure 801 and the second arm member 420, and the third shaft 133 and the fourth shaft 134 are inserted into the support member 900 of the friction structure 801, the first arm member 410 and the second arm member 420 may be rotated.

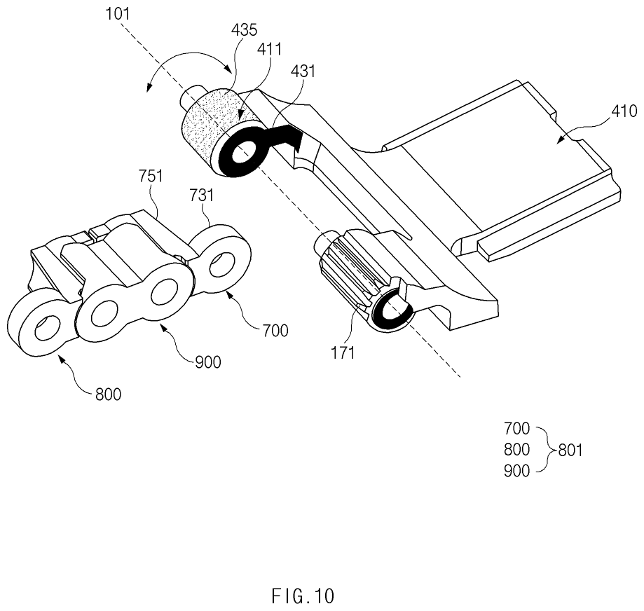

The first arm surface (e.g., the first arm structure 431 of FIG. 10) of the first arm member 410 may be rotated while contacting the first outer surface (e.g., the first outer surface 731 of FIG. 10) of the first friction member 700, and the first outer peripheral surface (or, first outer circumferential surface) 435 of the first arm member 410 may be rotated while contacting the first outer curved surface 751 of the first friction member 700. Because the first arm surface of the first arm member 410 is rotated while contacting the first outer surface of the first friction member 700 included in the friction structure 801 in response to provision of the elastic force of the first elastic structure 110 and/or the second elastic structure 120, a rotational friction may occur. Because the first outer peripheral surface of the first arm member 410 is rotated while contacting the first outer surface 731 of the first friction member 700 included in the friction structure 801 in response to provision of the elastic force of the first elastic structure 110 and/or the second elastic structure 120, a cylindrical friction may occur. While the foldable electronic device is changed from the unfolded state to the folded state or is changed from the folded state to the unfolded state, the first outer curved surface 751 of the first friction member 700 maintains a contact with the first outer peripheral surface 435 of the first arm member 410 in response to pressing of the support member 900, and the first outer surface 731 of the first friction member 700 may maintain a contact with the first arm surface of the first arm member 410.

A third arm surface (e.g., a surface that faces the −y axis) of the second arm member 420 may be rotated while contacting the third outer surface of the second friction member 800, and the second outer peripheral surface (or, second outer circumferential surface) 1435 of the second arm member 420 may be rotated while contacting the second outer curved surface 851 (or the second curved surface) of the second friction member 800. Because the third arm surface of the second arm member 420 is rotated while contacting the third outer surface of the second friction member 800 included in the friction structure in response to provision of the elastic force of the first elastic structure 110 and/or the second elastic structure 120, a rotational friction may occur. Because the second outer peripheral surface 1435 of the second arm member 420 is rotated while contacting the second outer surface 851 of the second friction member 800 included in the friction structure 801 in response to provision of the elastic force of the first elastic structure 110 and/or the second elastic structure 120, a cylindrical friction may occur. While the foldable electronic device is changed from the unfolded state to the folded state or is changed from the folded state to the unfolded state, the second outer curved surface 851 of the second friction member 800 maintains a contact with the second outer peripheral surface 1435 of the second arm member 420 in response to pressing of the support member 900, and the third outer surface of the second friction member 800 may maintain a contact with the third arm surface of the second arm member 420.

In an embodiment, the rotational frictional force and the cylindrical frictional force between the arm members 410 and 420 and the friction structure 801 may be used to allow the foldable electronic device 200 to maintain a predetermined angle or may be used to prevent the foldable electronic device 200 from being easily opened from the folded state. A size of surfaces, on which the cam members 560 and 570 and the cam structure contact each other, is smaller than a size of a surface, on which the arm members 410 and 420 and the friction structure 801 contact each other, the frictional force generated by the arm members 410 and 420 and the friction structure 801 may be greater than the frictional force generated by the cam members 560 and 570 and the cam structure. A frictional force that is desired to maintain an angle in a flex operation through a cylindrical frictional force and a rotational frictional force may be secured even when a size of a cam member is decreased in a process of implementing a slim foldable electronic device.

In an embodiment, the first elastic structure 110 may include a plurality of elastic members (or elastic bodies) having a hollow spring shape. In an embodiment, the first elastic structure 110 may include a first elastic member 111, a second elastic member 112, a third elastic member 113, and a fourth elastic member 114. Because the first elastic structure 110 is disposed between the first cam member 560 and the friction structure 801, it may act to push the first cam member 560 in one direction. In this case, the first elastic structure 110 may exert an elastic force to push the friction structure 801 in the direction of the arm members 410 and 420. Accordingly, the friction structure 801 contacts the arm members 410 and 420, and in response to the rotation of the arm members 410 and 420 and/or the shafts 131, 132, 133, and 134, the arm members 410 and 420 may be rotated while contacting with the friction structure 801 to generate a rotational frictional force and a cylindrical frictional force.

In an embodiment, the second elastic structure 120 may include a plurality of elastic members (or elastic bodies) having a hollow spring shape. In an embodiment, the second elastic structure 120 may include a fifth elastic member 121, a sixth elastic member 122, a seventh elastic member 123, and an eighth elastic member 124. Because the second elastic structure 120 is disposed between the second cam member 570 and the shaft fixing part 270, it may act to push the second cam member 570 in one direction.

In an embodiment, an elastic force generated by the second elastic structure 120 may be similar to an elastic force generated by the first elastic structure 110 within a predetermined range.

The shaft fixing part 270 may include a shaft hole, in which a plurality of shafts may be held to be fixed. The shaft fixing part 270 may include a plurality of shaft holes, in which each of the first shaft 131, the second shaft 132, the third shaft 133, and the fourth shaft 134 is held to be fixed. At least one of the plurality of shaft holes may be provided in a cylindrical shape that is the same as or similar to a z-axis cross section of the corresponding shafts 131, 132, 133, and 134.

In an embodiment, the first main gear 171 may be disposed on one side of the first shaft 131. The first main gear 171 may be disposed integrally with the second arm part 412 of the first arm member 410. The second main gear 172 may be disposed on one side of the second shaft 132. The second main gear 172 may be disposed integrally with the fourth arm part 422 of the second arm member 420. At least one interlocking gear (or an idle gear) 173 may be disposed between the first main gear 171 and the second main gear 172, and may be gear-coupled to the first main gear 171 and the second main gear 172. In an embodiment, the at least one interlocking gear 173 may include a first interlocking gear 1731 that is gear-coupled to the first main gear 171, and a second interlocking gear 1732 that is gear-coupled to the second main gear 172, for example. The interlocking gear 173 may be used to share a rotational force of the first shaft 131 and a rotational force of the second shaft 132. In an embodiment, the structures, in which the first main gear 171 and the second main gear 172 are formed in the arm members 410 and 420, have been described in an embodiment, but the first main gear 171 and the second main gear 172 may be separated from the arm members and may be disposed separately.

As described above, the foldable electronic device 200 of the disclosure may be slimmed by applying at least one friction structure 801 to the first type hinge structure 240. Even when the structures of the cam members 560 and 570 become smaller and the shapes of the cam parts become smaller, a cylindrical frictional force and a rotational frictional force may be provided through the friction structure 801, so that an operation of the flex mode may be operated more stably.

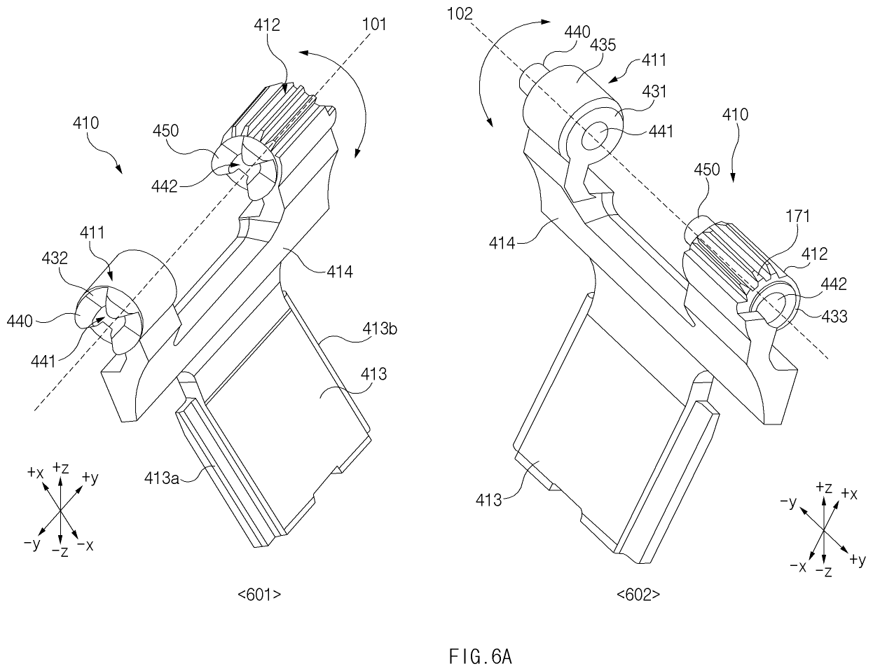

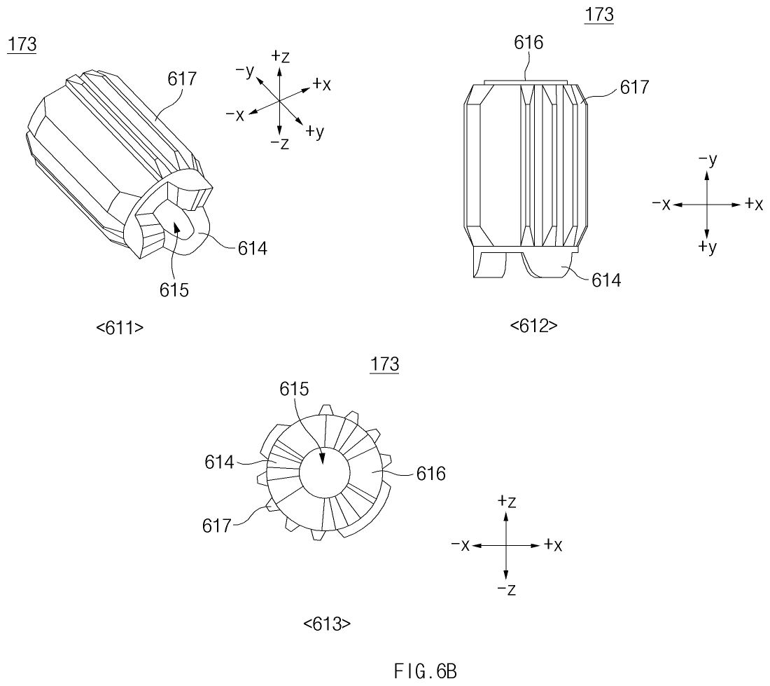

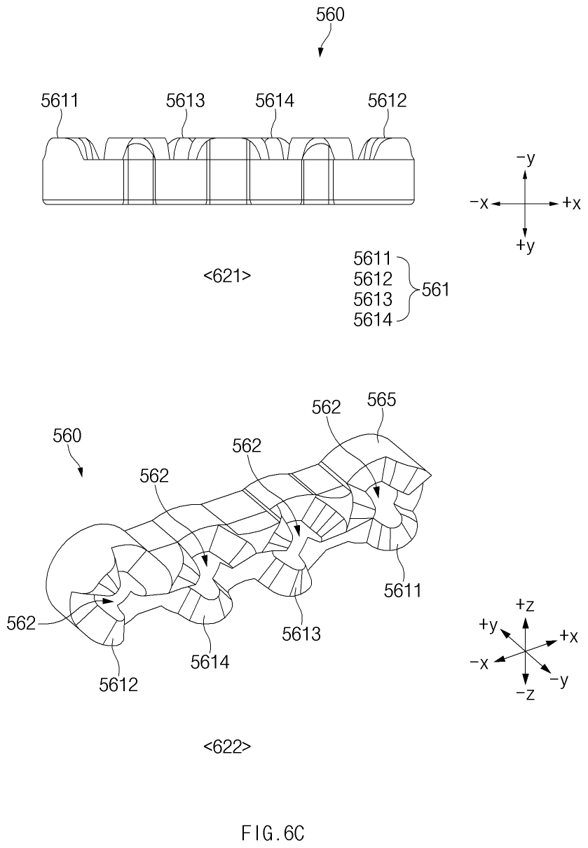

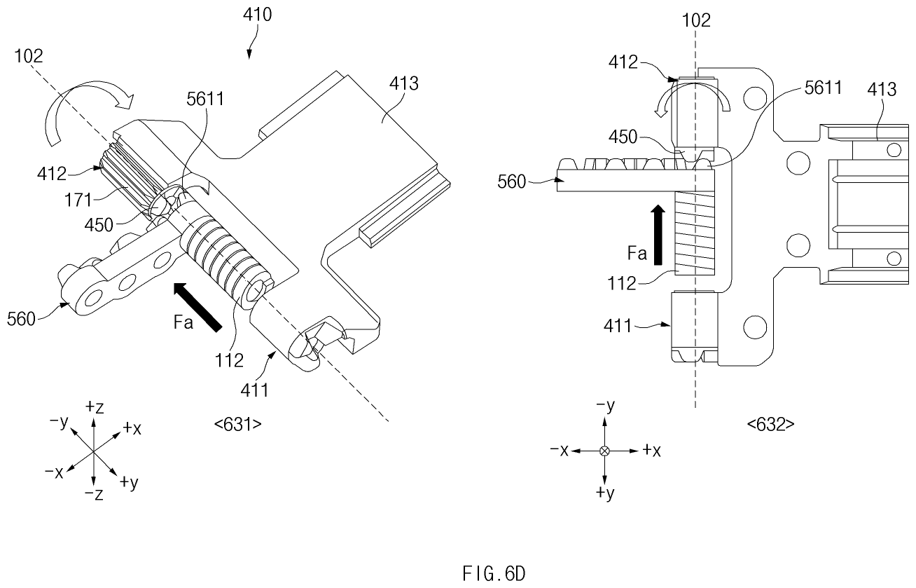

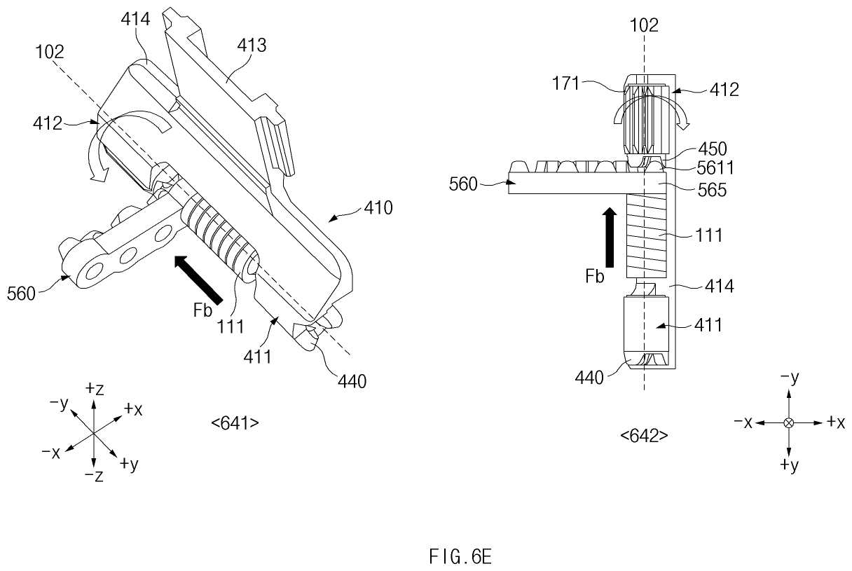

FIG. 6A is a view illustrating an embodiment of a first arm member. In FIG. 6A, <601> is a view of the first arm member viewed from the −y axis to the +y axis, and <602> is a view of the first arm member viewed from the +y axis to the −y axis.

Referring to FIGS. 3 to 6A, the first arm member 410 may include a first arm body 414, a first arm part 411, a second arm part 412, and a first slide part 413. The first arm body 414 may be disposed between each of the first arm part 411 and the second arm part 412 and the first slide part 413. The first arm body 414 may connect the first arm part 411 and the first slide part 413, and may connect the second arm part 412 and the first slide part 413.

The first arm body 414 may transmit a force, by which the first slide part 413 is slid (or an arc motion) in the first link member 310, to the first arm part 411 and the second arm part 412 while the foldable electronic device 200 is folded or unfolded. In an alternative embodiment, while the first arm part 411 and the second arm part 412 are rotated in response to the rotation of the first shaft 131, the first arm body 414 may transmit a rotational force of the first arm part 411 and the second arm part 412 to the first slide part 413.

The first arm part 411 may include a first arm surface 431 that faces one direction (e.g., the +y-axis direction), a second arm surface 432 that faces an opposite direction to the first arm surface 431, and a first outer peripheral surface 435 that is disposed between the first arm surface 431, and the second arm surface 432. In an embodiment, at least a portion of the first arm part 411 may be formed in a hollow cylindrical shape.

The first arm part 411 may include a first arm hole 441 that is formed to pass through the first arm surface 431 and the second arm surface 432. The first arm part 411 may be formed in a ring shape that surrounds the first arm hole 441. The first arm hole 441 may have a diameter that is similar to that of the first shaft 131 so that the first shaft 131 may be inserted thereinto. The first arm hole 441 may be formed in a shape corresponding to an outer diameter of the first shaft 131. The z-axis cross-sectional shape of the first arm hole 441 may correspond to the shape of the z-axis cross section of the first shaft 131. In an embodiment, when the z-axis cross-sectional shape of the first arm hole 441 is circular, the z-axis cross-sectional shape of the first shaft 131 may be circular.

The first arm surface 431 may be disposed to face the friction structure 801. The first arm surface 431 may be disposed to contact the first friction member 700 of the friction structure 801. The first arm surface 431 may generate friction while contacting one surface (e.g., a surface that faces the +y axis) of the first friction member that faces the first arm surface 431 by the elastic force of the elastic member. The first arm surface 431 may have a flat surface. At least a portion of the first arm surface 431 may contact one surface of the first friction member.

The second arm surface 432 may include a third cam structure 440 (or a first cam structure or a first rotating cam structure formed on the second arm surface) that is disposed to face the second cam member 570. The third cam structure 440 may be formed on a surface that faces the second cam member 570. In the third cam structure 440, mountains and valleys may be repeatedly disposed. The mountains of the third cam structure 440 may be formed in an embossed shape that protrudes toward the second cam member 570. The valleys of the third cam structure 440 may be formed in a concave engraved shape.

The first cam structure 450 may be disposed to face (or contact) the moving cam part of the first cam member 560, and may perform a cam operation in response to the rotation of the first arm member 410 in a state, in which it is pressed by the first elastic member 111 and/or the fifth elastic member 121. In an embodiment, while the foldable electronic device 200 is held at a predetermined angle (e.g., a predetermined angle between 0 degree to 180 degrees), a protruding portion (a ridge or a protrusion) of a shape (a cam profile) of the third cam structure 440 may be engaged with a protruding portion of the second cam member 570, and a protruding portion of the first cam structure 450 may be engaged with a protruding portion of the first cam member 560, for example. While an upper portion (or an apex portion of a mountain) of the third cam structure 440 and an upper portion (or an apex portion of a mountain) of the second cam member 570 contact each other and an upper portion (or an apex portion of a mountain) of the first cam structure 450 and an upper portion (or an apex portion of a mountain) of the first cam member 560 contact each other, a compression amount of the first elastic member 111 and/or the fifth elastic member 121 and a compression amount of the second elastic member 112 and/or the sixth elastic member 122 may be maintained at a predetermined level or more. Accordingly, the frictional force of the corresponding peripheral structure (e.g., friction plates) may contribute to maintaining the foldable electronic device 200 at a specified angle.

A first arm hole 441 that is formed to pass through the first arm surface 431 and the second arm surface 432 may be included. The first arm part 411 may be formed in a ring shape that surrounds the first arm hole 441. The first arm hole 441 may have a diameter that is similar to that of the first shaft 131 so that the first shaft 131 may be inserted thereinto. The first arm hole 441 may be formed in a shape corresponding to an outer diameter of the first shaft 131. The z-axis cross-sectional shape of the first arm hole 441 may correspond to the shape of the z-axis cross section of the first shaft 131. In an embodiment, when the z-axis cross-sectional shape of the first arm hole 441 is circular, the z-axis cross-sectional shape of the first shaft 131 may be circular.

The second arm part 412 may be spaced apart from the first arm part in the y-axis direction. A first main gear 171 formed in a gear pattern may be formed at at least a portion of the outer peripheral surface of the second arm part 412. The first main gear 171 may be formed in a shape, in which mountains and valleys are repeated along the circumference of the second circumferential surface 433. The first main gear 171 may be engaged with the first interlocking gear 1731.

The first slide part 413 may include a first rail boss 413a that protrudes from one side surface of the first slide part 413 in the −y-axis direction, and a second rail boss 413b that protrudes from an opposite side surface of the first slide part 413 in the +y-axis direction. The first rail boss 413a and the second rail boss 413b may be fastened to link steps that are formed on opposite inner walls of the first sliding holding part 312.

In an embodiment, the second arm member 420 includes a second arm body 424, a third arm part 421, a fourth arm part 422, a second cam structure 470, a fourth cam structure 460, and a second slide part 423, the second arm body 424 may correspond to the first arm body 414 of the first arm member 410, and the third arm part 421 may correspond to the first arm part 411 of the first arm member 410, the fourth arm part 422 may correspond to the second arm part 412 of the first arm member 410, the second cam structure 470 may correspond to the first cam structure 450 of the first arm member 410, the fourth cam structure 460 may correspond to the third cam structure 440 of the first arm member 410, and the second slide part 423 may correspond to the first slide part 413 of the first arm member 410. Accordingly, a description of the detailed structure of the second arm member 420 will be replaced with a description of the structure of the first arm member 410.

In the description of the first type hinge structure 240 described above, a rail boss (or a rail or a rail structure) that protrudes from one surface and a rail groove that is engraved (or recessed) from one surface may be formed opposite to each other. In an embodiment, the protruding rail structure (or the rail boss) formed in the first rotation member 510 may be changed to an engraved rail groove, and correspondingly, the first fixed rail groove (or the first rail groove or the first groove) of the fixing bracket 530 coupled to the first rotation member 510 may be changed to a protruding rail boss, for example. This structural change may be applied not only to the first rotation member 510, but also to the second rotation member 520, the first arm member 410, the second arm member 420, and the first link member 310 and the second link member 320, to which each of them is coupled, in the same way or similarly.

FIG. 6B is a view illustrating an embodiment of an interlocking gear that is coupled to a first arm member and/or a second arm member. In FIG. 6B, <611> is a perspective view of the interlocking gear, <602> is a view illustrating an embodiment of the front of the interlocking gear viewed from the z-axis direction, and <603> is a view illustrating an embodiment of the side of the interlocking gear viewed from the y-axis direction.

Referring to FIGS. 3 to 6B, in an embodiment, a pair of interlocking gears 173 may be provided to be gear-coupled to each of the first main gear 171 and the second main gear 172. In an embodiment, the pair of interlocking gears 173 may include a first interlocking gear 1731 that is gear-coupled to the first main gear 171, and a second interlocking gear 1732 that is gear-coupled to the second main gear 172, for example. At least any one of the pair of interlocking gears 173 may include a gear body 616, a gear part 617, and a gear cam structure 614.

The gear body 616 may be formed in a hollow cylindrical shape. The gear body 616 may be formed in a hollow shape having a gear hole 615. The gear body 616 may be formed to surround the gear hole 615 that is elongated in the y-axis direction. The third shaft 133 may be inserted into the gear hole 615 of the first interlocking gear 1731 that is gear-coupled to the first main gear 171. A fourth shaft 134 may be inserted into the gear hole 615 of the second interlocking gear 1732 that is gear-coupled to the second main gear 172.

A plurality of gear patterns may be formed on at least a portion of the outer peripheral surface of the gear body 616, in the gear part 617. The gear part 617 may be formed in a shape, in which mountains and valleys are repeated along the circumference of the outer peripheral surface of the gear body 616. Mountains and valleys of the gear part 617 may be elongated in the y-axis direction. The gear part 617 of the first interlocking gear 1731 may be engaged with the first main gear 171. The gear part 617 of the second interlocking gear 1732 may be engaged with the second main gear 172.

The gear cam structure 614 may be disposed to face (or contact) a fixed cam portion of the first cam member 560. The gear cam structure 614 may be formed on one side surface (e.g., a surface that facing the +y axis) of the gear body 616, which faces the first cam member 560. In the gear cam structure 614, a mountain that protrudes in the +y-axis direction and a valley that is recessed in the −y-axis direction may be repeatedly disposed. The mountains of the gear cam structure 614 may be formed in an embossed shape that protrudes toward the first cam member 560. The valleys of the gear cam structure 614 may be formed in a concave engraved shape.

The gear cam structure 614 of the first interlocking gear 1731 may perform a cam operation in response to the rotation of the first interlocking gear 1731 that is rotated while being engaged with the first main gear 171, while being pressed by the third elastic member 113. The gear cam structure 614 of the second interlocking gear 1732 may perform a cam operation in response to the rotation of the second interlocking gear 1732 that is rotated while being engaged with the second main gear 172, while being pressed by the fourth elastic member 114.

In an embodiment, while the foldable electronic device 200 is held at a specified angle (e.g., a predetermined angle between 0 degree and 180 degrees), the mountain portions of the gear cam structure 614 may engage with the protruding portions of the first cam member 560. While an upper portion (or an apex portion of the mountain) of the first cam member 560 is maintained in a contact state, an apex portion of a mountain of the gear cam structure 614 may be maintained such that the compression amount of the third elastic member 113 and/or the fourth elastic member 114 are a predetermined level or more. Accordingly, the frictional force of the corresponding peripheral structure (e.g., friction plates) may contribute to maintaining the foldable electronic device at a specified angle.

FIG. 6C is a view illustrating an embodiment of a first cam member. In FIG. 6C, <621> illustrates an embodiment of a front surface of a first cam member viewed from the z-axis direction, and <622> illustrates an embodiment of a perspective view of a first cam member.

Referring to FIGS. 3 to 6C, in an embodiment, the first cam member 560 may include a first cam body 565 having one side surface (e.g., a surface that faces the +y axis) that faces the first elastic structure 110, and a first moving cam part 561. The first moving cam part 561 may include a first cam portion 5611 (or a first outer cam portion), a second cam portion 5612 (or a second outer cam portion), a third cam portion 5613 (or a first inner cam portion), and a fourth cam portion 5614 (or a second inner cam portion).

Each of the first cam portion 5611, the second cam portion 5612, the third cam portion 5613, and the fourth cam portion 5614 may include a first cam hole 562. Each of the first cam holes 562 is formed to pass in the y-axis or-y-axis direction, and may be formed in a central portion of each of the first cam portion 5611, the second cam portion 5612, the third cam portion 5613, and the fourth cam portion 5614. Each of the first cam portion 5611, the second cam portion 5612, the third cam portion 5613, and the fourth cam portion 5614 may have a cylindrical shape that surrounds the first cam hole 562 that is formed to pass in the y-axis or −y-axis direction at the center in volume.

At least a portion of the first shaft 131 may be inserted into the first cam hole 562 of the first cam portion 5611. At least a portion of the first shaft 131 may be held in the first cam hole 562 of the first cam portion 5611. At least a portion of the second shaft 132 may be inserted into the first cam hole 562 of the second cam portion 5612. At least a portion of the second shaft 132 may be held in the first cam hole 562 of the second cam portion 5612. At least a portion of the third shaft 133 may be inserted into the first cam hole 562 of the third cam portion 5613. At least a portion of the third shaft 133 may be held in the first cam hole 562 of the third cam portion 5613. At least a portion of the fourth shaft 134 may be inserted into the first cam hole 562 of the fourth cam portion 5614. At least a portion of the fourth shaft 134 may be held in the first cam hole 562 of the fourth cam portion 5614.

In each of the first cam portion 5611, the second cam portion 5612, the third cam portion 5613, and the fourth cam portion 5614, mountain portions that protrude in the-y-axis direction and valley portions may be repeatedly disposed. The first cam portion 5611 may be engaged with the first cam structure 450 formed in the first arm part 411 of the first arm member 410. The second cam portion 5612 may be engaged with the first cam structure 450 formed in the third arm part 421 of the second arm member 420. The third cam portion 5613 may be engaged with the gear cam structure 614 of the first interlocking gear 1731. The fourth cam portion 5614 may be engaged with the gear cam structure 614 of the second interlocking gear 1732.

FIG. 6D is a view illustrating an embodiment of states of an arm structure and a cam member in an unfolded state of a foldable electronic device. FIG. 6E is a view illustrating an embodiment of states of an arm structure and a cam member in a folded state of a foldable electronic device. In FIG. 6D, <631> is a perspective view of the arm member and the second cam member in the unfolded state of the electronic device, and <632> is a rear view of the arm member and the second cam member in the unfolded state of the electronic device, viewed in the −z-axis direction. In FIG. 6E, <641> is a perspective view of the arm member and the second cam member in the folded state of the electronic device, and <642> is a rear view of the arm member and the second cam member in the folded state, viewed in the −z-axis direction.

Referring to FIGS. 1 to 6E, the first housing 210 and the second housing 220 may be rotated in a direction when the electronic device is unfolded, by an external pressure (e.g., a force applied to the electronic device by the user) applied from the outside. In an embodiment, during the unfolding operation of the electronic device, the first housing 210 may be rotated clockwise, and the second housing 220 may be rotated counterclockwise, for example. The first housing 210 and the second housing 220 may be rotated in a direction when the electronic device is folded, by an external pressure (e.g., a force applied to the electronic device by the user) applied from the outside. In an embodiment, the first housing 210 may be rotated counterclockwise, and the second housing 220 may be rotated clockwise.

When the first housing 210 and the second housing 220 are rotated, the first arm member 410 may be rotated in the same direction as the first housing, and the second arm member 420 may be rotated in the same direction as the second housing 220. As the first arm member 410 and the second arm member 420 are rotated, the first cam structure 450 of the first arm member 410, the second cam structure 470 of the second arm member 420, and the interlocking gear 173 may be rotated. As the first cam structure 450, the interlocking gear 173, and the second cam structure 470 are rotated, the first cam member 560 that contacts the first cam structure 450, the gear cam structure 614, and the second cam structure 470 may be moved in a direction that becomes closer to the friction structure 801. The first elastic member 111, the second elastic member 112, the third elastic member 113, and the fourth elastic member 114 may be compressed by the first cam member 560 that is moved in a direction that becomes closer to the friction structure 801. The first elastic member 111, the second elastic member 112, the third elastic member 113, and the fourth elastic member 114 may exert an elastic force Fa to push the first cam portion 5611, the second cam portion 5612, the third cam portion 5613, and the fourth cam portion 5614 of the first cam member 560 toward the first cam structure 450, the gear cam structure 614, and the second cam structure 470. A frictional force may be generated between the first cam member 560, the first cam structure 450, the gear cam structure 614, and the second cam structure 470 by the elastic force Fa of each of the first cam portion 5611, the second cam portion 5612, the third cam portion 5613, and the fourth cam portion 5614 while each of the first cam structure 450, the gear cam structure 614, and the second cam structure 470 and the first cam structure 450 contact each other. The frictional force generated between each of the first cam structure 450, the gear cam structure 614, and the second cam structure 470 and the first cam member 560 acts as a resistance force that interferes with the rotation of the first arm member 410 and the second arm member 420, and thus the electronic device may be maintained in a holding state (e.g., the unfolded state or the folded state).

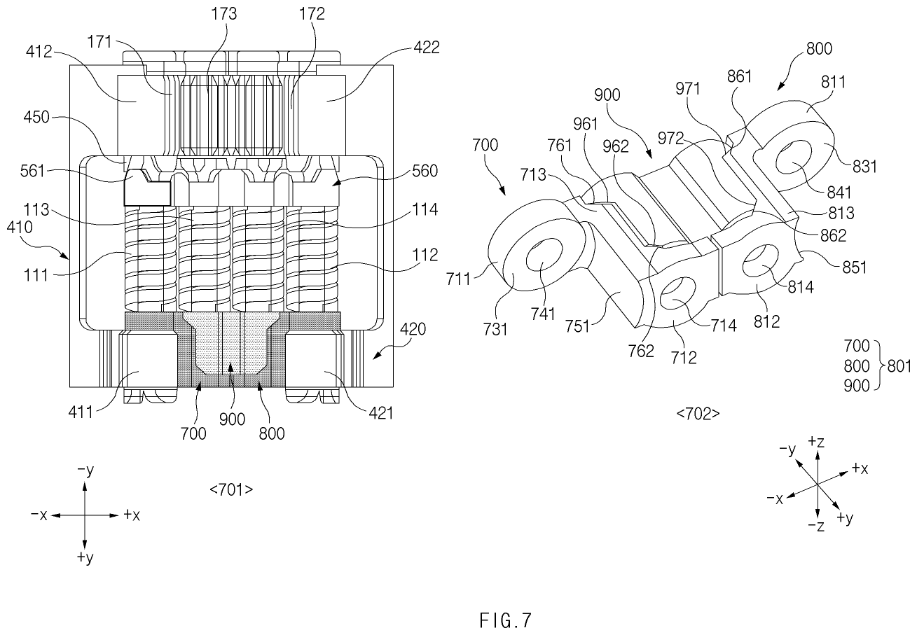

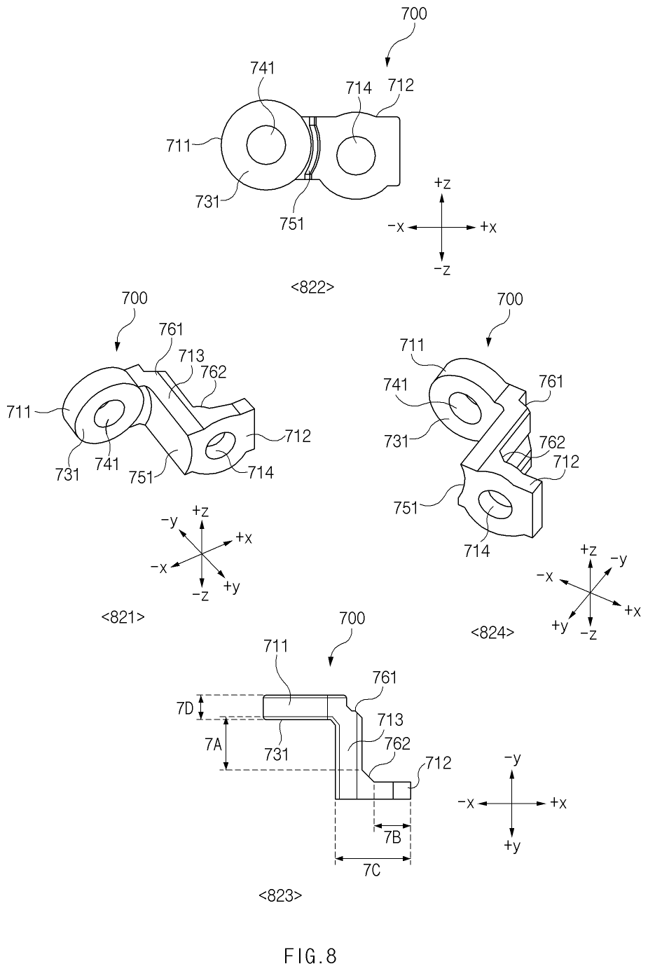

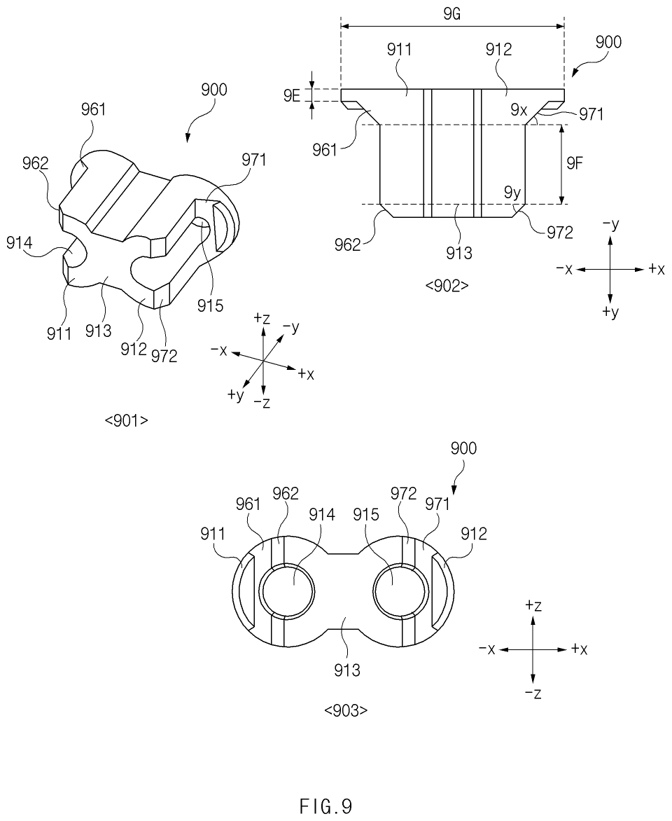

FIG. 7 is a view illustrating an embodiment of a portion of a hinge structure including a friction structure. In FIG. 7, <701> is a plan view illustrating an embodiment of a portion of a hinge structure coupled to a friction structure, and <702> is a perspective view illustrating an embodiment of a friction structure. FIG. 8 is a view illustrating an embodiment of a first friction member included in a friction structure. In FIG. 8, <821>, <822>, <823> and <824> are different views illustrating an embodiment of the first friction member. FIG. 9 is a view illustrating an embodiment of a support member included in a friction structure. In FIG. 9, <901>, <902>, and <903> are different views illustrating an embodiment of the support member.

Referring to FIGS. 1 to 9, in an embodiment, a friction structure (or, a friction member, a force transmission member, or a torque providing member) 500 may include a first friction member 700 (or, a first outer member or a first edge member), a second friction member 800 (or, a second outer member or a second edge member), and a support member 900 (or, an inner member, a center member, a third friction member).

The first friction member 700 may be disposed to pass through the first shaft 131 and the third shaft 133. The first friction member 700 may be disposed to contact at least a portion of each of the first arm part 411 of the first arm member 410 and the support member 900 between the first arm part 411 of the first arm member 410 and the support member 900. In an embodiment, the first friction member 700 may include a first outer body 713 (or a first body), a first outer part 711, and a second outer part 712, for example.

The first outer part 711 may protrude from the first outer body 713 in the-x-axis direction. The first outer part 711 may protrude from one end (e.g., an end that faces the-y axis) of the first outer body 713 toward the first arm member 410.

The first friction member 700 may have a hollow cylindrical shape with a first outer hole 741 in the y-axis direction. The first outer part 711 may be formed in a ring shape that surrounds the first outer hole 741. The first shaft 131 may be inserted into the first outer hole 741. The first outer hole 741 may have a diameter that is similar to that of the first shaft 131 so that the first shaft 131 may be inserted thereinto. The cross-sectional shape (or the z-axis cross-sectional shape) of the first outer hole 741, which is taken in the z-axis direction, may correspond to the cross-sectional shape of the first shaft 131 in the z-axis direction. In an embodiment, when the z-axis cross-sectional shape of the first outer hole 741 is circular, the z-axis cross-sectional shape of the first shaft 131 may be circular.

A first outer surface 731 (e.g., a surface that faces the +y axis) of the first outer part 711 may face (or contact) the first arm part 411 of the first arm member 410. The first outer surface 731 of the first outer part 711 may generate friction while contacting the first arm surface 431 of the first arm part 411 by an elastic force of the first elastic member 111.

The second outer part 712 may protrude from the first outer body 713 in an opposite direction to the first outer part 711. The second outer part 712 may protrude from the first outer body 713 in the +x-axis direction. The second outer part 712 may protrude from an opposite end of the first outer body 713 toward the support member 900 and/or the second friction member 800. The second outer part 712 may have a hollow cylindrical shape with a second outer hole 714 in the y-axis direction. The second outer part 712 may be formed in a ring shape that surrounds the second outer hole 714. The third shaft 133 may be inserted into the second outer hole 714. The second outer hole 714 may have a diameter that is similar to that of the third shaft 133 so that the third shaft 133 may be inserted thereinto. The cross-sectional shape (or the z-axis cross-sectional shape) of the second outer hole 714, which is taken in the z-axis direction, may correspond to the cross-sectional shape of the third shaft 133 in the z-axis direction. In an embodiment, when the z-axis cross-sectional shape of the second outer hole 714 is circular, the z-axis cross-sectional shape of the third shaft 133 may be circular.

The first outer body 713 may be disposed between the first outer part 711 and the second outer part 712. The first outer body 713 may connect the first outer part 711 and the second outer part 712. The y-axis length (or a length that is parallel to the depth direction of the first outer hole 741) of the first outer body 713 may be larger than the outer diameter of the first outer surface 731 of the first outer part 711. A contact area between the first outer body 713 and the first arm part 411 may be greater than a contact area between the first outer surface 731 and the first arm part 411 of the first outer part 711.

At least a portion of the first outer body 713 may be formed to surround a portion of the support member. In an embodiment, a portion of the first outer body 713 may include at least one outer inclined surface 761 and 762 that faces (or contacts) at least one inner inclined surface, for example. In an embodiment, the first outer body 713 may include a first outer inclined surface 761 and a second outer inclined surface 762. The first outer inclined surface 761 may be inclined with respect to each of the xz plane and the yz plane. In an embodiment, the first outer inclined surface 761 may be inclined at a predetermined angle with respect to each of the first outer part 711 and the first outer body 713, between the first outer part 711 and the first outer body 713. The second outer inclined surface 762 may be inclined at a predetermined angle with respect to each of the second outer part 712 and the first outer body 713, between the second outer part 712 and the first outer body 713. In an embodiment, the first outer inclined surface 761 and the second outer inclined surface 762 may be inclined at the same angle or different angles. The first outer inclined surface 761 and the second outer inclined surface 762 that may contact the inclined surfaces 961 and 962 of the support member 900 may transmit an elastic force of the first elastic member 111 to the first outer curved surface 751 (or a first curved surface) of the first friction member 700. The first outer inclined surface 761 and the second outer inclined surface 762 may convert the elastic force of the first elastic member 111 in a direction toward the first outer curved surface 751 and transmit it to the first outer curved surface 751.

At least a portion of the first outer body 713 may have a shape corresponding to that of the first arm part 411 of the first arm member 410. In an embodiment, a portion of the first outer body 713 may include a first outer curved surface 751 that surrounding a portion of the hollow cylindrical first arm part 411. The first outer curved surface 751 may be formed in an arc shape that is engraved in the +x-axis direction. The first outer curved surface 751 of the first outer part 711 may face (or contact) the first arm part 411 of the first arm member 410 in the x-axis direction. The first outer surface 731 of the first outer part 711 may generate friction while contacting the first outer peripheral surface 435 of the first arm part 411 by an elastic force of the first elastic member 111.

The second friction member 800 may be disposed to pass through the second shaft 132 and the fourth shaft 134. The second friction member 800 may be disposed to contact at least a portion of each of the third arm part 421 of the second arm member 420 and the support member 900, between the second arm part 421 of the second arm member 420 and the support member 900.

In an embodiment, the second friction member 800 may be symmetrical to the first friction member 700 with respect to the y axis (or with the support member 900 interposed therebetween). The second friction member 800 may include the same, corresponding, or similar configuration as the first friction member 700. In an embodiment, the second friction member 800 may include a second outer body 813 (or a second body), a third outer part 811, and a fourth outer part 812, for example. The second outer body 813 including the third outer inclined surface 861, the fourth outer inclined surface 862, and the second outer curved surface 851 may correspond to the first outer body 713 including the first outer inclined surface 761, the second outer inclined surface 762, and the first outer curved surface 751, and the third outer part 811 including the third outer hole 841 and the second outer surface 831 may correspond to the first outer part 711 including the first outer hole 741 and the first outer surface 731. The fourth outer part 812 including the fourth outer hole 814 may correspond to the second outer part 712 including the second outer hole 714. Accordingly, a description of the detailed structure of the second friction member 800 will be replaced with the description of the structure of the first friction member 700.

In an embodiment, the support member 900 may be surrounded by the first elastic structure 110, the first friction member 700, and the second friction member 800.

The support member 900 may be disposed to pass through the third shaft 133 and the fourth shaft 134. The support member 900 may be disposed to contact at least a portion of each of the first outer body 713, the second outer part 712, the second outer body 813, and the fourth outer part 812, between the first friction member 700 and the second friction member 800.

The support member 900 may include a support body 913, a first support part 911, and a second support part 912.

The support body 913 may be disposed between the first support part 911 and the second support part 912. The support body 913 may connect the first support part 911 and the second support part 912.

The first support part 911 may protrude from the support body 913 in the-x-axis direction. The first support part 911 may extend from one side (e.g., a side that faces the-x axis) of the support body 913 toward the first friction member 700 and/or the first arm member 410. The first support part 911 may have a hollow cylindrical shape with a first inner hole 914 in the y-axis direction. The first support part 911 may be formed in a ring shape that surrounds the first inner hole 914. The first inner hole 914 may communicate with the second outer hole 714. A third shaft 133 may be inserted into the first inner hole 914 that communicates with the second outer hole 714. The first inner hole 914 may have a diameter that is similar to that of the third shaft 133 so that the third shaft 133 may be inserted thereinto. The cross-sectional shape (or the z-axis cross-sectional shape) of the first inner hole 914, which is taken in the z-axis direction, may correspond to the cross-sectional shape of the third shaft 133 in the z-axis direction. In an embodiment, when the z-axis cross-sectional shape of the first inner hole 914 is circular, the z-axis cross-sectional shape of the third shaft 133 may be circular.

At least a portion of the first support part 911 may include at least one inner inclined surface 961 and 962 that faces (or contacts) the outer inclined surfaces 761 and 762 of the first friction member. In an embodiment, the first support part 911 may include at least one first inner inclined surface 961 that faces the first outer inclined surface 761 and at least one second inner inclined surface 962 that faces the second outer inclined surface 762. At least any one of the first inner inclined surface 961 and the second inner inclined surface 962 may be inclined with respect to each of the xz plane and the yz plane. In an embodiment, the first inner inclined surface 961 and the second inner inclined surface 962 may be inclined at the same angle or different angles. The first inner inclined surface 961 and the second inner inclined surface 962 may transmit an elastic force of the third elastic member 113 to the first outer curved surface 751 of the first friction member 700. The first inner inclined surface 961 and the second inner inclined surface 962 that contact the first outer inclined surface 761 and the second outer inclined surface 762 may convert an elastic force of the third elastic member 113 in a direction that faces the first outer curved surface 751 and transmit it to the first outer curved surface 751. The support member 900 may press the first friction member 700 in a first direction (e.g., the −x-axis direction) that faces the first arm member 410 based on the elastic force of the third elastic member 113.

The second support part 912 may protrude from the support body 913 in an opposite direction to the first support part 911. The second support part 912 may protrude from the support body 913 in the +x-axis direction. The second support part 912 may extend from an opposite end of the support body 913 toward the second friction member 800 and/or the second arm member 420. The second support part 912 may have a hollow cylindrical shape with a second inner hole 915 in the y-axis direction. The second support part 912 may be formed in a ring shape that surrounds the second inner hole 915. The second inner hole 915 may communicate with the fourth outer hole 814. A fourth shaft 134 may be inserted into the second inner hole 915 that communicates with the second inner hole 915. The second inner hole 915 may have a diameter that is similar to that of the fourth shaft 134 so that the fourth shaft 134 may be inserted thereinto. The cross-sectional shape (or the z-axis cross-sectional shape) of the second inner hole 915, which is taken in the z-axis direction, may correspond to the cross-sectional shape of the fourth shaft 134 in the z-axis direction. In an embodiment, when the z-axis cross-sectional shape of the second inner hole 915 is circular, the z-axis cross-sectional shape of the fourth shaft 134 may be circular.

At least a portion of the second support part 912 may include at least one inner inclined surface 971 and 972 that faces (or contacts) the outer inclined surfaces 861 and 862 of the second friction member 800. In an embodiment, the second support part 912 may include at least one third inner inclined surface 971 that faces the third outer inclined surface 861 and at least one fourth inner inclined surface 972 that faces the fourth outer inclined surface 862. At least any one of the third inner inclined surface 971 and the fourth inner inclined surface 972 may be inclined with respect to each of the xz plane and the yz plane. In an embodiment, the third inner inclined surface 971 and the fourth inner inclined surface 972 may be inclined at the same angle or different angles. The third inner inclined surface 971 and the fourth inner inclined surface 972 may transmit an elastic force of the fourth elastic member 114 to the second outer curved surface 851 of the second friction member 800. The third inner inclined surface 971 and the fourth inner inclined surface 972 that contact the third outer inclined surface 861 and the fourth outer inclined surface 862 may convert an elastic force of the fourth elastic member 114 in a direction that faces the second outer curved surface 851 and transmit it to the second outer curved surface 851. The support member 900 may press the second friction member 800 in a second direction (e.g., the +x-axis direction) that faces the second arm member 420 based on the elastic force of the fourth elastic member 114.

In an embodiment, the first friction member 700 may have an eleventh length 7A, a twelfth length 7B, a thirteenth length 7C, and a fourteenth length 7D. The eleventh length 7A may be a length of the first outer body 713 in the y-axis direction, or a length between the first outer inclined surface 761 and the second outer inclined surface 762. The eleventh length 7A may be formed in proportion to a target friction area between the first friction member 700 and the first arm member 410. In an embodiment, the eleventh length 7A of the first friction member 700 applied to the single-foldable electronic device may be longer than the twelfth length 7B. In an embodiment, the eleventh length 7A of the first friction member 700 applied to the multi-foldable electronic device may be shorter than the twelfth length 7B. The twelfth length 7B may be a length in the x-axis direction from the second outer inclined surface 762 to the end of the second outer part 712. The twelfth length 7B may be less than half of the thirteenth length 7C. The thirteenth length 7C may be a length of the second outer part 712 in the x-axis direction, or a maximum diameter of the second outer part 712. In an embodiment, the thirteenth length 7C may be similar to or the same as a diameter of at least one of the first elastic member 111, the second elastic member 112, the third elastic member 113, and the fourth elastic member 114. The fourteenth length 7D may be a thickness of the first outer part 711 or a length of the first outer part 711 in the y-axis direction. The fourteenth length 7D may be formed based on the rigidity of the first friction member 700. In an embodiment, the fourteenth length 7D may be formed to be thicker than the twenty-first length 9E corresponding to the thickness of the seating part 916 in which the third elastic member 113 and the fourth elastic member 114 are seated. When the first outer part 711 of the first friction member 700 is pressed by the support member 900, the damage to the first outer part 711 may be prevented or minimized.

In an embodiment, the support member 900 may have a twenty-first length 9E, a twenty-second length 9F, and a twenty-third length 9G. The twenty-first length 9E may be a thickness (or a length in the y-axis direction) of the seating part 916 in which the third elastic member 113 and the fourth elastic member 114 are seated. The twenty-second length 9F may be a length in the y-axis direction between the first inner inclined surface 961 and the second inner inclined surface 962 and/or a length in the y-axis direction between the third inner inclined surface 971 and the fourth inner inclined surface 972. The twenty-second length 9F may be similar to or the same as the eleventh length 7A. The twenty-third length 9G may be a length of the seating part 916 in the x-axis direction. The twenty-third length 9G may be formed to be greater than the twenty-first length 9E and the twenty-second length 9F. The twenty-third length 9G may be proportional to the number of elastic members seated on the seating part 916. For example, the twenty-third length may be a length corresponding to the sum of the diameters of the third elastic member 113 and the diameters of the fourth elastic member 114.

In an embodiment, the first outer inclined surface 761 may be formed to have the same or similar slope (or, inclination, gradient) as the second outer inclined surface 762. The first inner inclined surface 961 may be formed to have the same or similar slope as the second inner inclined surface 962. The third inner inclined surface 971 may be formed to have the same or similar slope as the fourth inner inclined surface 972. In an embodiment, at least one of the first outer inclined surface 761, the second outer inclined surface 762, the first inner inclined surface 961, the third inner inclined surface 962, the third inner inclined surface 971, and the fourth inner inclined surface 972 may be formed to form acute angles 9x and 9y with respect to the x-axis. In an embodiment, at least one of the first outer inclined surface 761, the second outer inclined surface 762, the first inner inclined surface 961, the second inner inclined surface 962, the third inner inclined surface 971, and the fourth inner inclined surface 972 may form 45 degrees with respect to the x-axis.

FIG. 10 is a perspective view illustrating an embodiment of a coupling relationship between a friction structure of a hinge structure and a first arm member.

Referring to FIGS. 1 to 10, a first type hinge structure in an embodiment may include a friction structure 801 and a first arm member 410. The components of the first type hinge structure in an embodiment may correspond to the components of the first type hinge structure described above, except for the friction structure 801 and the first arm member 410. Accordingly, a detailed description of remaining (the other) components, except for the structures related to the friction structure 801 and the first arm member 410, may be replaced with the descriptions of FIGS. 1 to 9.

A friction structure 801 included in the first type hinge structure in an embodiment may include a first friction member 700, a second friction member 800, and a support member 900. The first outer surface 731 of the first friction member 700 may have a shape corresponding to the first arm surface 431 of the first arm member. Each of the first outer surface 731 of the first friction member 700 and the first arm surface 431 of the first arm member 410 may be formed in a circular shape having a through-hole. Accordingly, because the first outer surface 731 of the first friction member 700 and the first arm surface 431 of the first arm member 410 are rotatable while contacting each other, a rotational frictional force may be generated between the first outer surface 731 of the first friction member 700 and the first arm surface 431 of the first arm member 410.

The first arm part 411 of the first arm member 410 included in the first type hinge structure in an embodiment may be formed in a cylindrical shape having a through-hole. The first outer curved surface 751 of the first friction member 700, which faces the first arm part 411 of the first arm member 410, may have a shape corresponding to that of the first outer peripheral surface 435 of the first arm member 410. The first outer curved surface 751 of the first friction member 700 may include an engraved curved surface to correspond to the first outer peripheral surface 435 of the first arm member 410 including the embossed curved surface. Because the first outer curved surface 751 of the first friction member 700 and the first outer peripheral surface 435 of the first arm member 410 are rotatable while contacting each other, a cylindrical frictional force may be generated between the first outer curved surface 751 of the first friction member 700 and the first outer peripheral surface 435 of the first arm member 410.

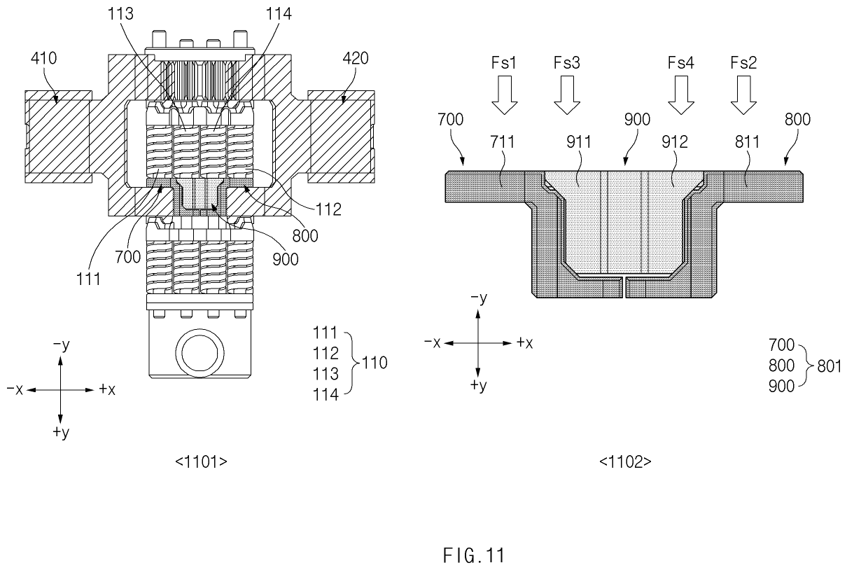

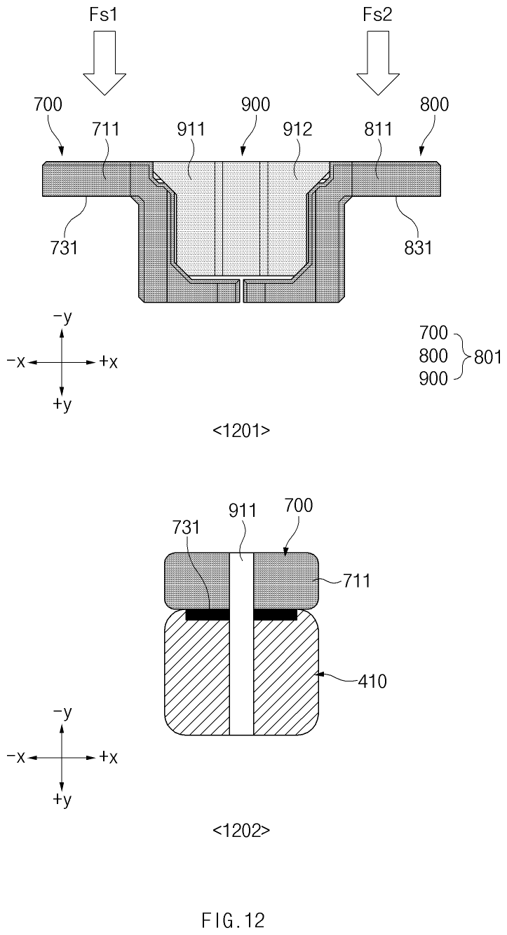

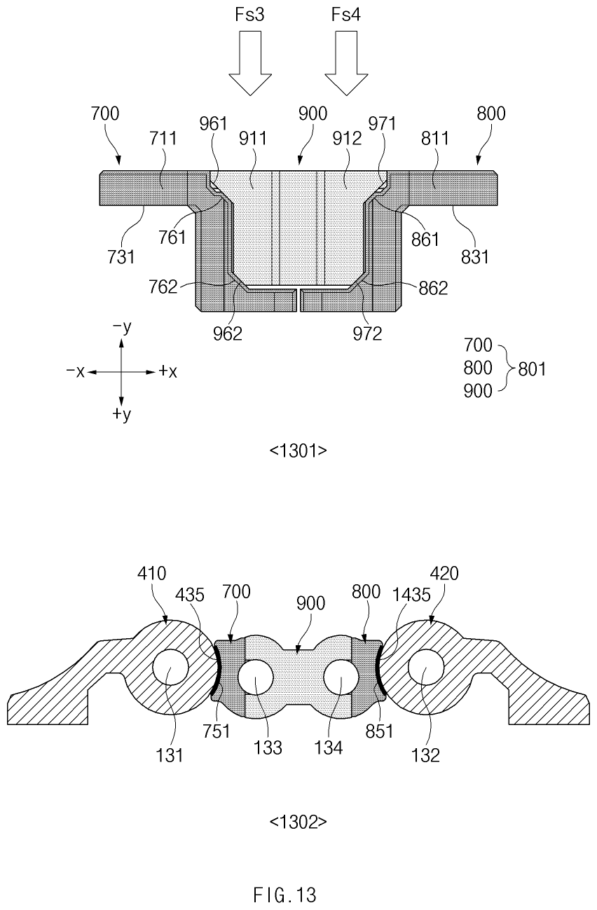

FIG. 11 is a plan view illustrating an embodiment of a hinge structure including a friction structure, FIG. 12 is a view illustrating an embodiment of force transmission states of a first friction member and a second friction member, and FIG. 13 is a view illustrating an embodiment of a force transmission state of a support member. In FIG. 11, <1101> and <1102> are views illustrating a first elastic force, a second elastic force, a third elastic force, and a fourth elastic force transmitted to a friction structure. In FIG. 12, <1201> is a view illustrating a first elastic force and a second elastic force transmitted to the friction member in an embodiment, and <1202> is a view illustrating a rotational friction generated between the arm surface of the arm member and the outer surface of the friction member. In FIG. 13, <1301> is a view illustrating a third elastic force and a fourth elastic force transmitted to the support member in an embodiment, and <1302> is a view illustrating cylindrical friction generated between the outer peripheral surface of the arm member and the outer curved surface of the support member.

Referring to FIGS. 1 to 13, a first elastic force Fs1 of the first elastic member 111, a second elastic force Fs2 of the second elastic member 112, a third elastic force Fs3 of the third elastic member 113, and/or a fourth elastic force Fs4 of the fourth elastic member 114 may be provided to the friction structure 801. The first elastic force Fs1 of the first elastic member 111 may be provided to the first friction member 700. The first elastic member 111 may press the first friction member 700 in a lengthwise direction (or the +y-axis direction) of the first shaft 131. The second elastic force Fs2 of the second elastic member 112 may be provided to the second friction member 800. The second elastic member 112 may press the second friction member 800 in a lengthwise direction (or the +y-axis direction) of the fourth shaft 134. The third elastic force Fs3 of the third elastic member 113 and the fourth elastic force Fs4 of the fourth elastic member 114 may be provided to the support member 900.

In response to the first elastic force Fs1 transmitted to the first outer part 711 of the first friction member 700, the first outer surface 731 of the first friction member 700 may contact (or be closely attached to) the first arm surface 431 of the first arm member 410. The elastic force of the first elastic member 111 may act as a repulsive force (e.g., a vertical stress) between the first outer surface 731 of the first outer part 711 of the first friction member 700 and the first arm surface 431 of the first arm part 411 of the first arm member 410. Because the first outer surface 731 of the first friction member 700 and the first arm surface 431 of the first arm member 410 are formed substantially perpendicular to the first shaft 131 (or the y-axis direction), a repulsive force between the first outer surface 731 of the first friction member 700 and the first arm surface 431 of the first arm member 410 may be formed in a direction (e.g., the y-axis direction) of the first shaft 131. A rotational frictional force may be generated between the first outer surface 731 of the first friction member 700 and the first arm surface 431 of the first arm member 410 by a repulsive force between the first outer surface 731 and the first arm surface 431.

In response to the second elastic force Fs2 transmitted to the third outer part 811 of the second friction member 800, the second outer surface 831 of the second friction member 800 may contact (or be closely attached to) the second arm surface of the second arm member 420. The elastic force of the second elastic member 112 may act as a repulsive force (e.g., a vertical stress) between the second outer surface 831 of the third outer part 811 of the second friction member 800 and the second arm surface of the third arm part 421 of the second arm member 420. Because the second outer surface 831 of the second friction member 800 and the second arm surface of the second arm member 420 are formed substantially perpendicular to the second shaft 132 (or the y-axis direction), a repulsive force between the second outer surface 831 of the second friction member 800 and the second arm surface of the second arm member 420 may be formed in a direction (e.g., the y-axis direction) of the second shaft 132. By a repulsive force between the second outer surface 831 of the second friction member 800 and the second arm surface of the second arm member 420, a rotational frictional force may be generated between the second outer surface 831 and the second arm surface.

The third elastic force Fs3 transmitted to the first support part 911 of the support member 900 may be transmitted to the first outer inclined surface 761 of the first friction member 700 through the first inner inclined surface 961 of the first support part 911. The third elastic force Fs3 transmitted to the first support part 911 of the support member 900 may be transmitted to the second outer inclined surface 762 of the first friction member 700 through the second inner inclined surface 962 of the first support part 911. The third elastic force Fs3 transmitted to the first outer inclined surface 761 and the second outer inclined surface 762 may be converted in a direction that is perpendicular to the third shaft 133 and may be transmitted to the first outer curved surface 751 of the first friction member 700. Based on the third elastic force Fs3, the support member 900 may press the first friction member 700 in a direction (or the −x-axis direction) that faces the first arm member 410. By the third elastic force Fs3 transmitted to the first outer curved surface 751 of the first friction member 700, the first outer curved surface 751 of the first friction member 700 may contact (or be closely attached to) the first outer peripheral surface 435 of the first arm member 410. The third elastic force Fs3 transmitted to the first friction member 700 may act as a repulsive force (e.g., a vertical stress) between the first outer peripheral surface 435 of the first arm member 410 and the first outer curved surface 751 of the first friction member 700. Due to the repulsive force (e.g., a vertical stress) between the first outer peripheral surface 435 of the first arm member 410 and the first outer curved surface 751 of the first friction member 700, a cylindrical frictional force may be generated between the first outer peripheral surface 435 of the first arm member 410 and the first outer curved surface 751 of the first friction member 700.

A fourth elastic force Fs4 transmitted to the second support part 912 of the support member 900 may be transmitted to the third outer inclined surface 861 of the second friction member 800 through the third inner inclined surface 971 of the second support part 912. The fourth elastic force Fs4 transmitted to the second support part 912 of the support member 900 may be transmitted to the fourth outer inclined surface 862 of the second friction member 800 through the fourth inner inclined surface 972 of the second support part 912. The fourth elastic force Fs4 transmitted to the third outer inclined surface 861 and the fourth outer inclined surface 862 may be converted in a direction that is perpendicular to the fourth shaft 134 and may be transmitted to the second outer curved surface 851 of the second friction member 800. Based on the fourth elastic force Fs4, the support member 900 may press the second friction member 800 in a direction (or, in the +x-axis direction) that faces the second arm member 420. By the fourth elastic force Fs4 transmitted to the second outer curved surface 851 of the second friction member 800, the second outer curved surface 851 of the second friction member 800 may contact (or, be closely attached to) the second outer peripheral surface 1435 of the second arm member 420. The fourth elastic force Fs4 transmitted to the second friction member 800 may act as a repulsive force (e.g., a vertical stress) between the second outer peripheral surface 1435 of the second arm member 420 and the second outer curved surface 851 of the second friction member 800. A cylindrical frictional force may be generated between the second outer peripheral surface 1435 of the second arm member 420 and the second outer curved surface 851 of the second friction member 800 due to a repulsive force (e.g., a vertical stress) between the second outer peripheral surface 1435 of the second arm member 420 and the second outer curved surface 851 of the second friction member 800.

In an embodiment, in a flex mode, in which the foldable electronic device may be maintained in a predetermined state (e.g., a state, in which it is widened at an angle between 60° and 120°, and the angle may be changed), the angle may be maintained with a greater force by utilizing not only the cam friction, but also the rotational friction and the cylindrical friction.

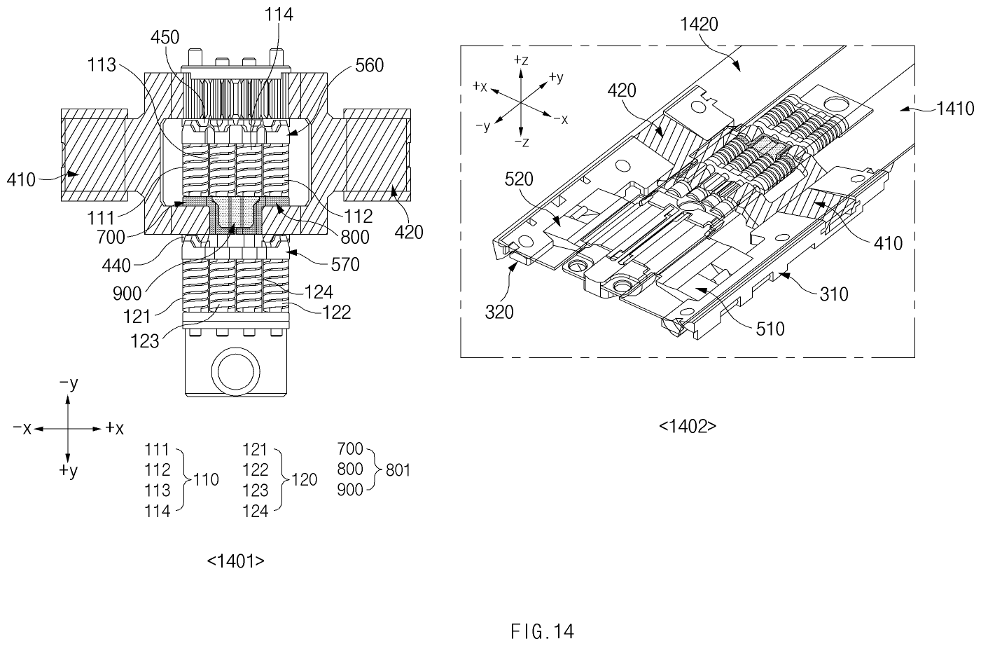

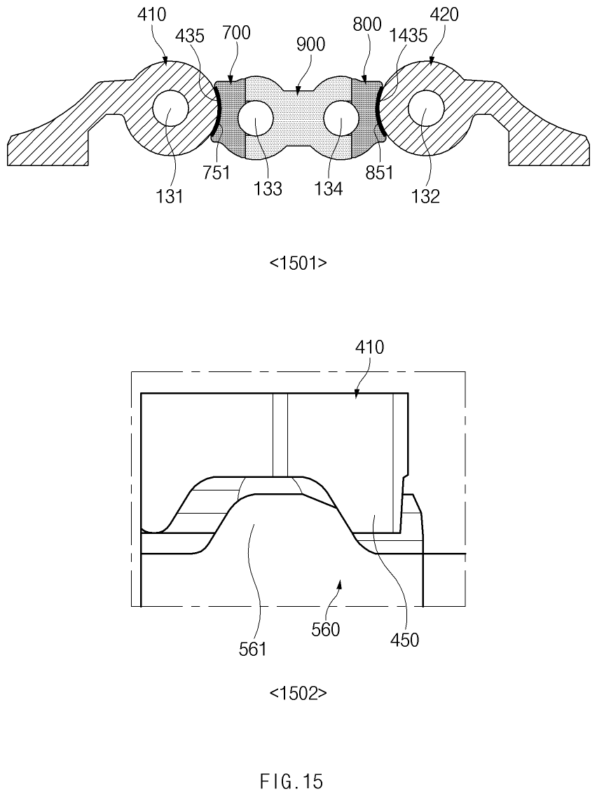

FIG. 14 is a view illustrating an embodiment of a state of a hinge structure in an unfolded state (or, a first state) of a foldable electronic device, and FIG. 15 is a view illustrating an embodiment of states of a friction structure and a cam member in an unfolded state of a foldable electronic device. In FIG. 14, <1402> is an enlarged view of a portion of <1401> illustrating the hinge structure. In FIG. 15, <1502> is an enlarged view of a portion of <1501> illustrating the friction structure and the cam member.

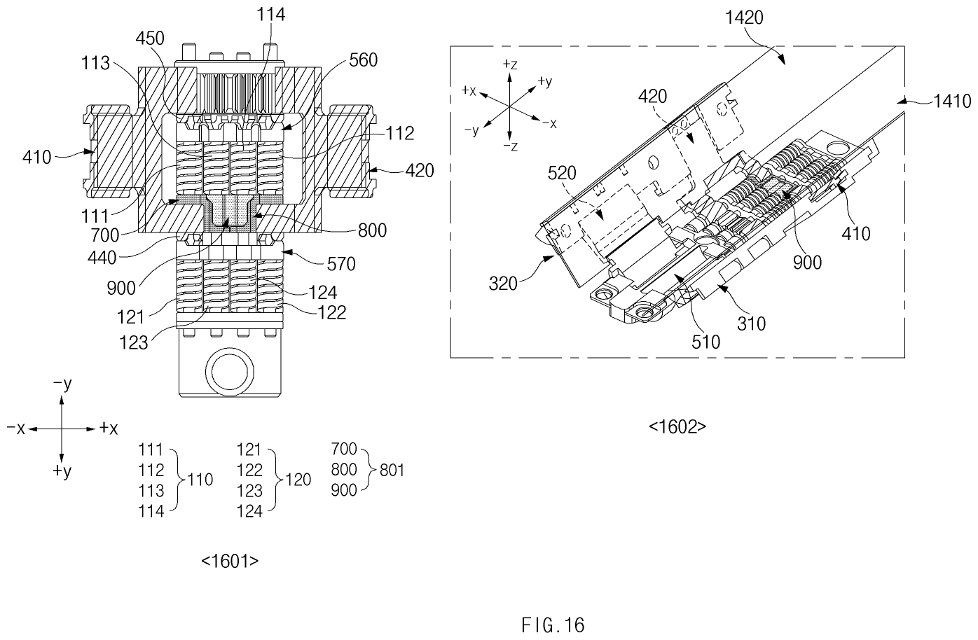

Referring to FIGS. 1 to 15, a foldable electronic device in an embodiment may be in a fully unfolded state. When the electronic device is in the unfolded state (or, when the first display 230 is in the unfolded state, when the first housing 210 and the second housing 220 are in the unfolded state), the first arm member 410 coupled to the first wing plate 1410 (refer to FIG. 16) may be symmetrical to the second arm member 420 coupled to the second wing plate 1420 (refer to FIG. 16) with respect to a central portion of the foldable electronic device. An end of the first arm member 410 in the −x-axis direction and an end of the second arm member 420 in the +x-axis direction may be spaced apart from each other by a first distance (or, a maximum distance).

In an embodiment, when the foldable electronic device is in the unfolded state, a portion of an inclined surface of the arm cam portion of the first cam structure 450 of the first arm member 410 and a portion of an inclined surface of the moving cam part of the first cam member 560 may contact each other. An apex portion (e.g., a portion that faces the +y axis or a portion that faces the moving cam part of the first cam member 560) of the arm cam portion of the first cam structure 450 and an apex portion of the moving cam part of the first cam member 560 (e.g., a portion that faces the −y axis or a portion that faces the arm cam portion of the first cam structure 450) may be spaced apart from each other. An empty space (or a gap) may be formed between the apex portion of the arm cam portion of the first cam structure 450 and the apex portion of the moving cam part of the first cam member 560.

In an embodiment, when the foldable electronic device is in the unfolded state, a portion of an inclined surface of the arm cam portion of the third cam structure 440 of the first arm member 410 and a portion of an inclined surface of the moving cam part of the second cam member 570 may contact each other. An apex portion (e.g., a portion that faces the +y axis or a portion that faces the moving cam part of the second cam member 570) of the arm cam portion of the third cam structure 440 and an apex portion of the moving cam part of the second cam member 570 (e.g., a portion that faces the-y axis or a portion that faces the arm cam portion of the third cam structure 440) may be spaced apart from each other. An empty space (or a gap) may be formed between the apex portion of the arm cam portion of the third cam structure 440 and the apex portion of the moving cam part of the second cam member 570.

In an embodiment, in at least a partial section, in which the foldable electronic device (or the hinge structure) is converted from the folded state or the intermediate state to the unfolded state, the foldable electronic device may be moved (or rotated) in at least in a partial rotation range (or a second rotation range or a second partial rotation range). The first arm member 410 and the second arm member 420 may be rotated in a rotation range corresponding to at least the partial the rotation range. In response to the rotation of the first arm member 410, the arm cam portion of the first cam structure 450 of the first arm member 410 may be moved toward the valley portion of the first cam member 560 along the inclined surface of the moving cam part of the first cam member 560. In response to the rotation of the first arm member 410, the arm cam portion of the third cam structure 440 of the first arm member 410 may be moved toward the valley portion of the second cam member 570 along the inclined surface of the moving cam part of the second cam member 570. A portion of the inclined surface of the moving cam part of the first cam member 560 may generate a first cam frictional force while contacting portions of the inclined surfaces of the arm cam portions of the first cam structure 450 and the second cam structure 470. In response to the rotation of the second arm member 420, the arm cam portion of the second cam structure 470 of the second arm member 420 may be moved toward the valley portion of the first cam member 560 along the inclined surface of the moving cam part of the first cam member 560. In response to the rotation of the second arm member 420, the arm cam portion of the fourth cam structure 460 of the second arm member 420 may be moved toward the valley portion of the second cam member 570 along the inclined surface of the moving cam part of the second cam member 570. A portion of the inclined surface of the moving cam part of the second cam member 570 may generate a second cam frictional force while contacting portions of the inclined surfaces of the arm cam portions of the third cam structure 440 and the fourth cam structure 460.

When the electronic device is moved into the unfolded state, a gap between each of the first cam structure 450 and the second cam structure 470 and the first cam member 560 may become relatively smaller, and an interval between each of the third cam structure 440 and the fourth cam structure 460 and the second cam member 570 may become relatively smaller. The first elastic member 111, the second elastic member 112, the third elastic member 113, and the fourth elastic member 114 may be gradually tensioned (or relatively weakly compressed), so that the first elastic structure 110 may have a relatively tensioned state. The fifth elastic member 121, the sixth elastic member 122, the seventh elastic member 123, and the eighth elastic member 124 may be gradually tensioned, so that the second elastic structure 120 may have a relatively tensioned state (or a weakly compressed state). The first cam frictional force that acts between each of the first cam structure 450 and the second cam structure 470 and the first cam member 560 due to the gradually tensioned first elastic structure 110 may be decreased compared to that in the intermediate state. The second cam frictional force that acts between each of the third cam structure 440 and the fourth cam structure 460 and the second cam member 570 due to the gradually tensioned second elastic structure 120 may be decreased compared to that in the intermediate state.

In an embodiment, when the foldable electronic device is converted into the unfolded state, the elastic force of each of the first elastic member 111, the second elastic member 112, the third elastic member 113, and the fourth elastic member 114 may be relatively decreased by the gradually tensioned first elastic structure 110. The relatively decreased elastic force of each of the first elastic member 111, the second elastic member 112, the third elastic member 113, and the fourth elastic member 114 may be transmitted to the friction structure 801 including the first friction member 700, the second friction member 800, and the support member 900. Due to the relatively decreased elastic force of the first elastic member 111, the first friction member 700 may be pressed in a direction (e.g., the +y-axis direction) that faces the second cam member 570. Due to the relatively decreased elastic force of the second elastic member 112, the second friction member 800 may be pressed in a direction that is parallel to the first elastic member 111. Due to the elastic forces of the third elastic member 113 and the fourth elastic member 114, the support member 900 may be pressed in a direction that is parallel to the second elastic member 112. The support member 900 may press the second friction member 800 in a direction that faces the second arm member 420 while pressing the first friction member 700 in a direction that faces the first arm member 410 based on the relatively decreased elastic force of the third elastic member 113 and the fourth elastic member 114. Due to the relatively decreased pressing force (or pressure) of the support member 900, the frictional contact between the first curved surface 751 of the first friction member 700 and the first outer peripheral surface 435 of the first arm member 410 may be relatively decreased. When the first arm member 410 is rotated in the rotation range during the conversion from the intermediate state to the unfolded state, a relatively weak frictional contact may be formed between the first outer curved surface 751 of the first friction member 700 and the first outer peripheral surface 435 of the first arm member 410. Due to the relatively decreased pressing force (or pressure) of the support member 900, the frictional contact between the second outer curved surface 851 of the second friction member 800 and the second outer peripheral surface 1435 of the second arm member 420 may be relatively decreased. When the second arm member 420 is rotated in the rotation range during the conversion from the intermediate state to the unfolded state, a relatively weak frictional contact may be formed between the second outer curved surface 851 of the second friction member 800 and the second outer peripheral surface 1435 of the second arm member 420.

In an embodiment, the foldable electronic device may perform an operation of opening the foldable electronic device with a less force by not only the first cam frictional force and the second cam frictional force, but also the rotational frictional force and the cylindrical frictional force. In an embodiment, even when the size of the cam member is decreased and the first cam frictional force and/or the second cam frictional force is decreased, the operation of opening the electronic device may be performed by the rotational frictional force and the cylindrical frictional force. The foldable electronic device in an embodiment may implement a reduction in the sizes of the cam members 560 and 570 and a slimness of the electronic device.

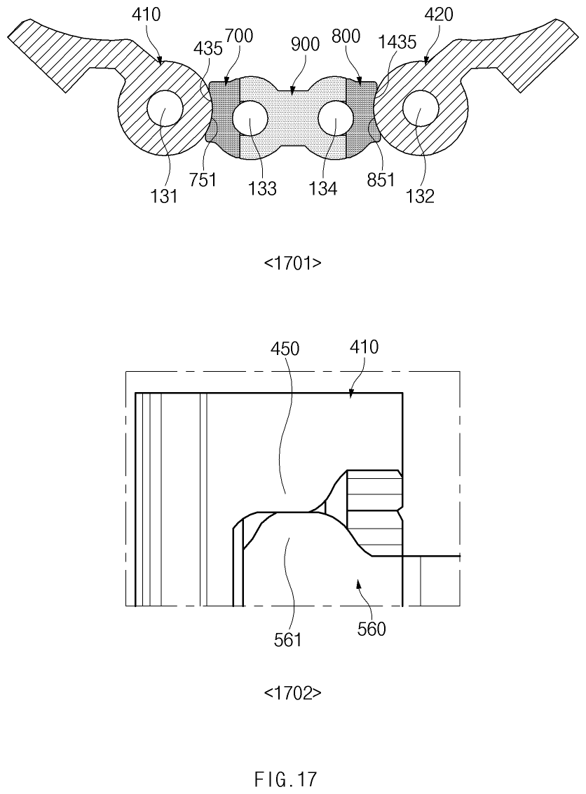

FIG. 16 is a view illustrating an embodiment of a state of a hinge structure in an intermediate state (or, a third state) of the first angle of a foldable electronic device, and FIG. 17 is a view illustrating an embodiment of states of friction structure and a cam member in an intermediate state of a first angle of a foldable electronic device. In FIG. 16, <1602> is an enlarged view of a portion of <1601> illustrating the hinge structure. In FIG. 17, <1702> is an enlarged view of a portion of <1701> illustrating the friction structure and the cam member.

Referring to FIGS. 1 to 17, in an embodiment, when an external pressure is applied to the foldable electronic device in the unfolded state or the fully folded state, the electronic device may be converted to the intermediate state of the first angle. In an embodiment, the first angle may include any one of angles between 60 degrees and 120 degrees. In the intermediate state of the first angle, an end of the first arm member 410 in the −x-axis direction and an end of the second arm member 420 in the +x-axis direction may be spaced apart from each other by a second distance that is smaller than the first distance (or the maximum distance). In an embodiment, in at least at least a partial section, in which the foldable electronic device (or the hinge structure) is converted from the unfolded state or the folded state to the intermediate state, the foldable electronic device may be moved (or rotated) in at least in a partial rotation range (or a first rotation range or a first partial rotation range). The first arm member 410 and the second arm member 420 may be rotated in at least a partial rotation range (or, a second rotation range or a second partial rotation range) corresponding to the first angle.

When the electronic device is in the intermediate state of the first angle, the apex portion (e.g., the portion that faces the +y axis) of the cam structure 440 and 450 of the first arm member 410 and the apex portions (e.g., the portions that faces the −y axis) of the cam members 560 and 570 may contact each other. While the electronic device is changed from the unfolded state (or the fully folded state) to the intermediate state of the first angle, the contact area between the apex portions (e.g., the portion that faces the y axis) of the arm cam portions of the cam structures 440 and 450 of the first arm member 410 and the apex portions of the moving cam parts of the cam members 560 and 570 may be gradually increased. In an embodiment, when the electronic device is in the intermediate state of the first angle, the contact area between the apex portions of the cam structures 440 and 450 of the first arm member 410 and the apex portions (e.g., the apex portions of the mountains) of the cam members 560 and 570 may be maximized.

In an embodiment, when the foldable electronic device is in the intermediate state of the first angle, at least a portion of the apex portion of the moving cam part of the second cam member 570 may contact at least a portion of the apex portion of the arm cam portion of the third cam structure 440. A first cam frictional force may be generated between at least a portion of the apex portion of the moving cam part of the second cam member 570 and at least a portion of the apex portion of the arm cam portion of the third cam structure 440. As a contact area between the arm cam portion of the third cam structure 440 and the moving cam part of the second cam member 570 is increased in the intermediate state of the first angle, the first cam frictional force may be increased. The first cam frictional force in the intermediate state of the first angle may have a greater magnitude than that of the first cam frictional force in the unfolded state and/or the fully folded state.

In an embodiment, when the foldable electronic device is in the intermediate state of the first angle, at least a portion of the apex portion of the moving cam part of the first cam member 560 may contact at least a portion of the apex portion of the arm cam portion of the first cam structure 450. A second cam frictional force may be generated between at least a portion of the apex portion of the moving cam part of the first cam member 560 and at least a portion of the apex portion of the arm cam portion of the first cam structure 450. As a contact area between the arm cam portion of the third cam structure 440 and the moving cam part of the first cam member 560 is increased in the intermediate state of the first angle, the second cam frictional force may be increased. The second cam frictional force in the intermediate state of the first angle may have a greater magnitude than that of the second cam frictional force in the unfolded state and/or the fully folded state.

In an embodiment, when the foldable electronic device is converted from the unfolded state or the folded state to an intermediate state of the first angle, the interval between each of the third cam structure 440 and the fourth cam structure 460 and the second cam member 570 may become relatively larger while the interval between each of the first cam structure 450 and the second cam structure 470 and the first cam member 560 may become relatively larger. The first elastic member 111, the second elastic member 112, the third elastic member 113, and the fourth elastic member 114 may be gradually compressed (or relatively strongly compressed), so that the first elastic structure 110 may have a relatively compressed state. The fifth elastic member 121, the sixth elastic member 122, the seventh elastic member 123, and the eighth elastic member 124 may be gradually compressed, so that the second elastic structure 120 may have a relatively compressed state.

The elastic force of each of the first elastic member 111, the second elastic member 112, the third elastic member 113, and the fourth elastic member 114 included in the first elastic structure 110 that is gradually compressed may be relatively increased. The relatively increased elastic force of each of the first elastic member 111, the second elastic member 112, the third elastic member 113, and the fourth elastic member 114 may be transmitted to the friction structure 801. The first elastic structure 110 may relatively strongly press the friction structure 801 with a relatively large elastic force. The first elastic member 111 may relatively strongly press the first friction member 700, the second elastic member 112 may relatively strongly press the second friction member 800, and the third elastic member 113 and the fourth elastic member 114 may relatively strongly press the support member 900. The support member 900 may press the second friction member 800 in a direction that faces the second arm member 420 while pressing the first friction member 700 in a direction that faces the first arm member 410 based on the relatively increased elastic force of the third elastic member 113 and the fourth elastic member 114. Due to the relatively increased pressing force (or pressure) of the support member 900, the frictional contact between the first curved surface 751 of the first friction member 700 and the first outer peripheral surface 435 of the first arm member 410 may be relatively increased. When the first arm member 410 is rotated in the rotation range during the conversion from the unfolded state or the folded state to the intermediate state, a relatively strong frictional contact may be formed between the first outer curved surface 751 of the first friction member 700 and the first outer peripheral surface 435 of the first arm member 410. Due to the relatively increased pressing force (or pressure) of the support member 900, the frictional contact between the second outer curved surface 851 of the second friction member 800 and the second outer peripheral surface 1435 of the second arm member 420 may be relatively increased. When the second arm member 420 is rotated in a rotation range during the conversion from the unfolded state or the folded state to the intermediate state, a relatively strong frictional contact may be formed between the second outer curved surface 851 of the second friction member 800 and the second outer peripheral surface 1435 of the second arm member 420. In an embodiment, the foldable electronic device in the intermediate state of the first angle may maintain the holding angle with a greater force by utilizing not only the increased first cam frictional force and/or the increased second cam frictional force, but also the increased rotational frictional force and the increased cylindrical frictional force, compared to those in the unfolded state and/or the folded state. The foldable electronic device in the intermediate state of the first angle may provide a stable holding angle by utilizing a higher frictional force than that in the unfolded state and/or the folded state.

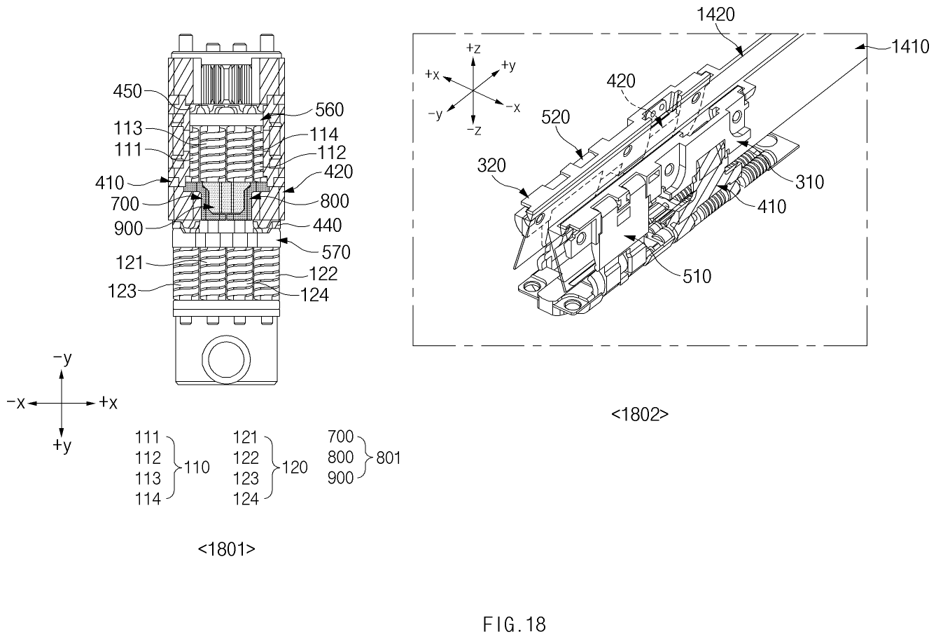

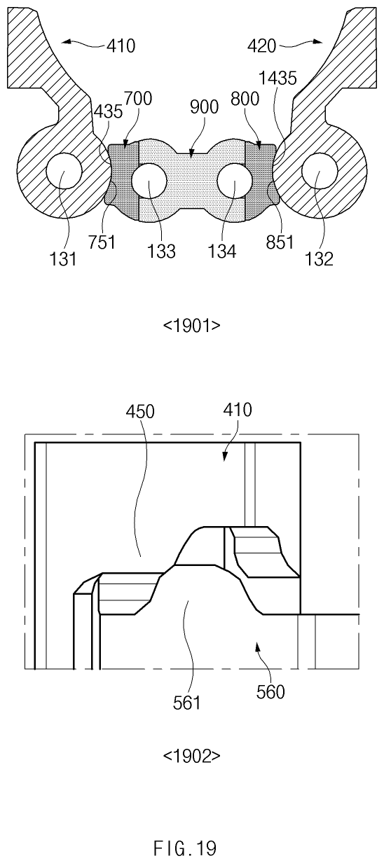

FIG. 18 is a view illustrating an embodiment of a state of a hinge structure in a folded state of a foldable electronic device in an embodiment, and FIG. 19 is a view illustrating an embodiment of states of a friction structure and a cam member in a folded state of a foldable electronic device. In FIG. 18, <1802> is an enlarged view of a portion of <1801> illustrating the hinge structure. In FIG. 19, <1902> is an enlarged view of a portion of <1901> illustrating the friction structure and the cam member.

Referring to FIGS. 1 to 19, when an external pressure is applied to the foldable electronic device in the intermediate state of the first angle or the unfolded state, the electronic device may be converted to a fully folded state. In the fully folded state, an end of the first arm member 410 in the −x-axis direction and an end of the second arm member 420 in the +x-axis direction may be spaced apart from each other by a third distance (or, a minimum distance) that is smaller than the second distance. In an embodiment, in at least at least a partial section, in which the foldable electronic device (or the hinge structure) is converted from the unfolded state or the intermediate state to the folded state, the foldable electronic device may be moved (or rotated) in at least in a partial rotation range (or a second rotation range or a second partial rotation range). The first arm member 410 and the second arm member 420 may be rotated in a rotation range corresponding to at least the partial rotation range (or the second rotation range or the second partial rotation range).

When the electronic device is in the folded state, a portion of an inclined surface of the arm cam portion of the third cam structure 440 of the first arm member 410 and a portion of an inclined surface of the moving cam part of the second cam member 570 may contact each other. While the electronic device is changed from the intermediate state to the folded state of the first angle, the contact area between the apex portions (e.g., the portion that faces the y axis) of the arm cam portions of the cam structures 440 and 450 of the first arm member 410 and the apex portions of the moving cam parts of the cam members 560 and 570 may be gradually decreased.

In an embodiment, when the foldable electronic device is in the folded state, at least a portion of the inclined surface of the moving cam part of the second cam member 570 may contact at least a portion of the inclined surface of the arm cam portion of the third cam structure 440. A first cam frictional force may be generated between at least a portion of the inclined surface of the moving cam part of the second cam member 570 and at least a portion of the inclined surface of the arm cam portion of the third cam structure 440. As a contact area between the arm cam portion of the third cam structure 440 and the moving cam part of the second cam member 570 is decreased in the intermediate state of the first angle, the first cam frictional force may be decreased. The first cam frictional force in the folded state may have a smaller magnitude than the first cam frictional force in the intermediate state of the first angle.

In an embodiment, when the foldable electronic device is in the folded state, at least a portion of the inclined surface of the moving cam part of the first cam member 560 may contact at least a portion of the inclined surface of the arm cam portion of the first cam structure 450. A second cam frictional force may be generated between at least a portion of the inclined surface of the moving cam part of the first cam member 560 and at least a portion of the inclined surface of the arm cam portion of the first cam structure 450. As the contact area between the arm cam portion of the first cam structure 450 and the moving cam part of the first cam member 560 is decreased in the folded state, the second cam frictional force may be decreased. The second cam frictional force in the folded state may have a smaller magnitude than the second cam frictional force in the intermediate state of the first angle.

In an embodiment, in at least a partial section, in which the foldable electronic device is converted from the unfolded state or an intermediate state to the folded state (or a second state), an interval between each of the third cam structure 440 and the fourth cam structure 460 and the second cam member 570 may become relatively smaller while an interval between each of the first cam structure 450 and the second cam structure 470 and the first cam member 560 may become relatively smaller. The first elastic member 111, the second elastic member 112, the third elastic member 113, and the fourth elastic member 114 may be gradually tensioned, so that the first elastic structure 110 may have a relatively tensioned state. The fifth elastic member 121, the sixth elastic member 122, the seventh elastic member 123, and the eighth elastic member 124 may be gradually tensioned, so that the second elastic structure 120 may have a relatively tensioned state.

The elastic force of each of the first elastic member 111, the second elastic member 112, the third elastic member 113, and the fourth elastic member 114 that is gradually tensioned may be relatively decreased. The relatively decreased elastic force of each of the first elastic member 111, the second elastic member 112, the third elastic member 113, and the fourth elastic member 114 may be transmitted to the friction structure 801. The first elastic structure 110 may relatively weakly press the friction structure 801 with a relatively small elastic force. The first elastic member 111 may relatively weakly press the first friction member 700, the second elastic member 112 may relatively weakly press the second friction member 800, and the third elastic member 113 and the fourth elastic member 114 may relatively weakly press the support member 900. The support member 900 may press the second friction member 800 in a direction that faces the second arm member 420 while pressing the first friction member 700 in a direction that faces the first arm member 410 based on the relatively decreased elastic force of the third elastic member 113 and the fourth elastic member 114. Due to the relatively decreased pressing force (or pressure) of the support member 900, the frictional contact between the first curved surface 751 of the first friction member 700 and the first outer peripheral surface 435 of the first arm member 410 may be relatively decreased. When the first arm member 410 is rotated in the rotation range during the conversion from the unfolded state or the intermediate state to the folded state, a relatively weak frictional contact may be formed between the first outer curved surface 751 of the first friction member 700 and the first outer peripheral surface 435 of the first arm member 410. Due to the relatively decreased pressing force (or pressure) of the support member 900, the frictional contact between the second outer curved surface 851 of the second friction member 800 and the second outer peripheral surface 1435 of the second arm member 420 may be relatively decreased. When the second arm member 420 is rotated in the rotation range during the conversion from the unfolded state or the intermediate state to the folded state, a relatively weak frictional contact may be formed between the second outer curved surface 851 of the second friction member 800 and the second outer peripheral surface 1435 of the second arm member 420.

In an embodiment, the foldable electronic device during the conversion to the folded state or the foldable electronic device in the folded state may maintain the holding angle with a greater force by the first cam frictional force and/or the second cam frictional force that are decreased compared to that in the intermediate state, but also by the rotational frictional force and the cylindrical frictional force. The foldable electronic device in the folded state may provide a stable holding angle by a relatively lower frictional force than that in the intermediate state.

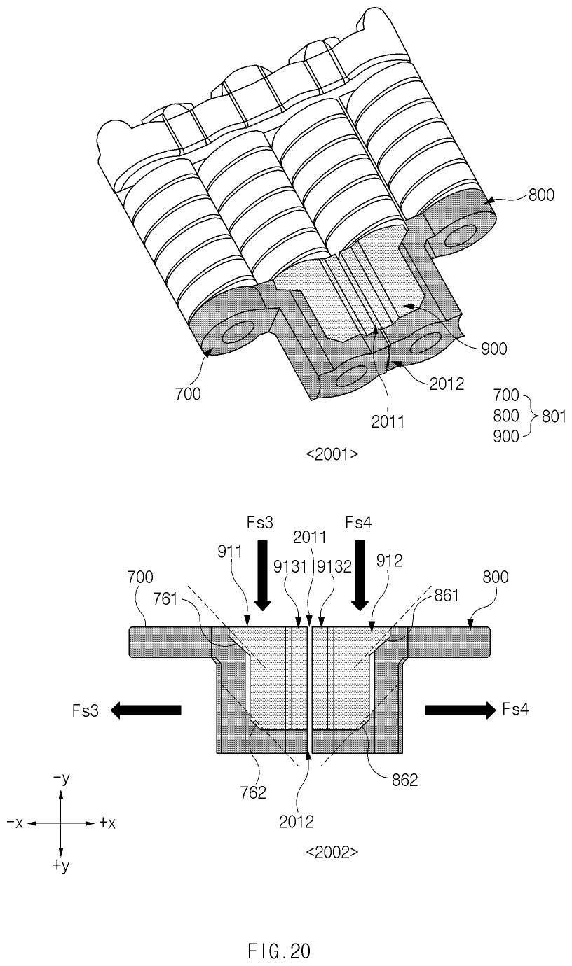

FIG. 20 is a view illustrating a portion of a second type hinge structure.

Referring to FIGS. 1 to 20, the components of the second type hinge structure in an embodiment may correspond to the components of the first type hinge structure described above, except for the friction structure. Accordingly, a detailed description of remaining (the other) components, except for the structures related to the friction structure may be replaced with the descriptions of FIGS. 1 to 19. In FIG. 20, <2001> is a perspective view illustrating a portion of the second type hinge structure including the friction structure in an embodiment, and <2002> is a view illustrating the friction structure.

A friction structure 801 included in the second type hinge structure in an embodiment may include a first friction member 700, a second friction member 800, and a support member 900.

The first friction member 700 and the second friction member 800 be spaced apart from each other with the first opening 2012 interposed therebetween.

The support member 900 may include a support body 913, a first support part 911, and a second support part 912.

The support body 913 may be disposed between the first support part 911 and the second support part 912. The support body 913 may include a first support body 9131 and a second support body 9132 that are spaced apart from each other with a second opening 2011 interposed therebetween. The second opening 2011 may be elongated in a direction (or, in the y-axis direction) that is parallel to the first shaft 131 (e.g., the first shaft 131 of FIG. 19). The second opening 2011 may be formed to communicate the first opening 2012.

The support member 900 is divided into a first support part 911 and a second support part 912 independently through the opening 2011 of the support body 913, so that the first support part 911 and the second support part 912 may be operated independently.

The first support part 911 may transmit the third elastic force Fs3 of the third elastic member 113 to the first friction member 700. The third elastic force Fs3 may be converted into a force in a direction that faces the first friction member 700 through the inclined surface of the first support part 911 and the outer inclined surfaces 761 and 762 of the first friction member 700, and may be transmitted to the first friction member 700.

The second support part 912 that is operated independently of the first support part 911 may transmit the fourth elastic force of the fourth elastic member 114 to the second friction member 800. The fourth elastic force Fs4 may be converted into a force in a direction that faces the second friction member 800 through the inclined surface of the second support part 912 and the outer inclined surfaces 861 and 862 of the second friction member 800, and may be transmitted to the second friction member 800.

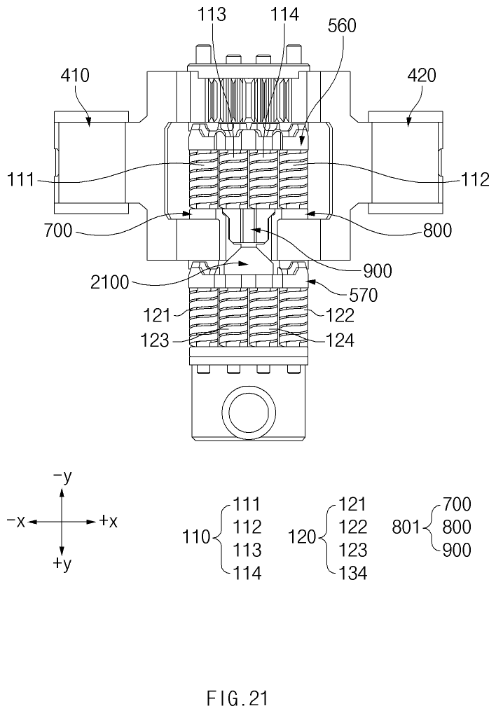

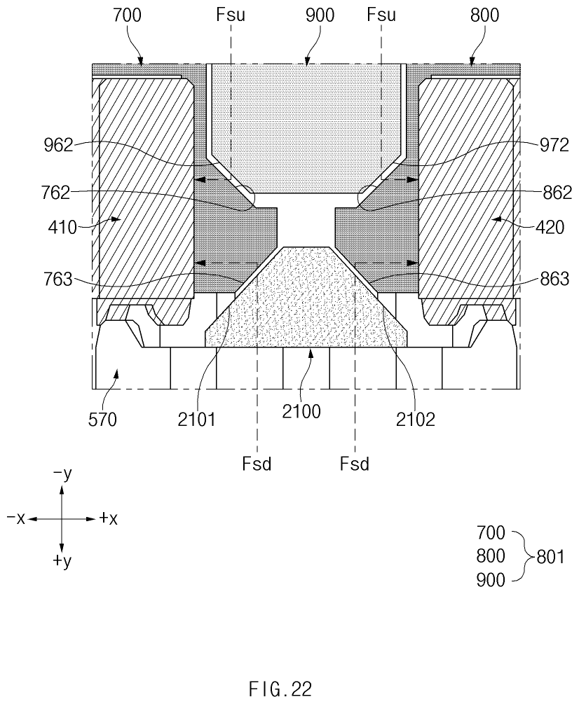

FIG. 21 is a view illustrating an embodiment of a portion of a third type hinge structure, and FIG. 22 is a view illustrating in detail an embodiment of a friction structure of the third type hinge structure.

Referring to FIGS. 1 to 22, the components of the third type hinge structure in an embodiment may correspond to the components of the first type hinge structure and/or the second hinge structure described above, except for the friction structure. Accordingly, a detailed description of remaining (the other) components, except for the structures related to the friction structure may be replaced with the descriptions of FIGS. 1 to 20.

The third type hinge structure in an embodiment may include a friction structure 801 and a second friction structure 2100.

The friction structure 801 may include a first friction member 700, a second friction member 800, and a support member 900. The first friction member 700 may include a first outer inclined surface 761, a second outer inclined surface 762, and a first upper inclined surface 763. The second friction member 800 may include a third outer inclined surface 861, a fourth outer inclined surface 862, and a second upper inclined surface 863.

The first elastic structure 110 may act to push the friction structure 801 in a direction that faces the second friction structure 2100. The upper elastic force Fsu exerted by the first elastic structure 110 may be transmitted to the first arm surface 431 and the first outer peripheral surface 435 of the arm member 410 and 420 through the friction structure 801. The arm surfaces 431 and 432 of the arm members 410 and 420 are rotated while contacting the outer surfaces 731 and 831 of the friction members 700 and 800 due to the upper elastic force Fsu, so that a rotational frictional force may be generated between the arm surfaces 431 and 432 of the arm members and the outer surfaces 731 and 831 of the friction members 700 and 800. The outer peripheral surfaces 435 of the arm members 410 and 420 are rotated while contacting the outer curved surfaces 751 and 851 of the friction members 700 and 800 due to the upper elastic force Fsu, so that a cylindrical frictional force may be generated between the outer peripheral surfaces 435 of the arm members 410 and 420 and the outer curved surfaces 751 and 851 of the friction members 700 and 800.

The second friction structure 2100 may be disposed to face the friction structure 801 in the y-axis direction. The second friction structure 2100 may be disposed between the friction structure 801 and the second cam member 570. The second friction structure 2100 may include a first lower inclined surface 2101 that faces the first upper inclined surface 763 and a second lower inclined surface 2102 that faces the second upper inclined surface 863. The second elastic structure 120 may act to push the second friction structure 2100 toward the friction structure 801. The lower elastic force Fsu exerted by the second elastic structure 120 may be transmitted to the first arm surface 431 and the first outer peripheral surface 435 of the arm member 410 and 420 through the second friction structure 2100. The arm surfaces 431 and 432 of the arm members 410 and 420 are rotated while contacting the outer surfaces 731 and 831 of the friction members 700 and 800 due to the lower elastic force Fsd, so that a rotational frictional force may be generated between the arm surfaces 431 and 432 of the arm members and the outer surfaces 731 and 831 of the friction members 700 and 800. The outer peripheral surfaces 435 of the arm members 410 and 420 are rotated while contacting the outer curved surfaces 751 and 851 of the friction members 700 and 800 due to the lower elastic force Fsd, so that a cylindrical frictional force may be generated between the outer peripheral surfaces 435 of the arm members 410 and 420 and the outer curved surfaces 751 and 851 of the friction members 700 and 800.

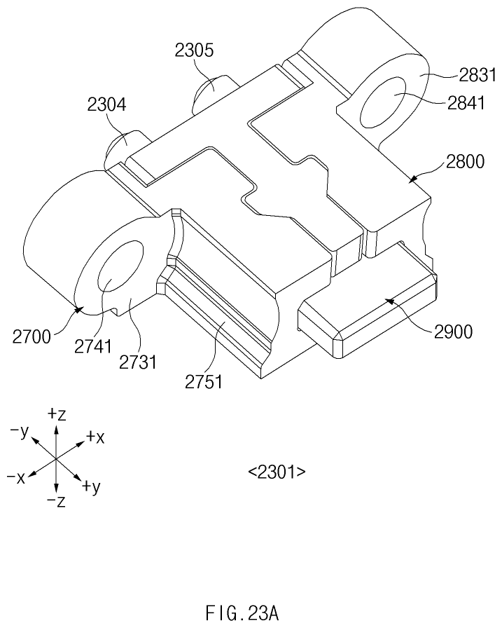

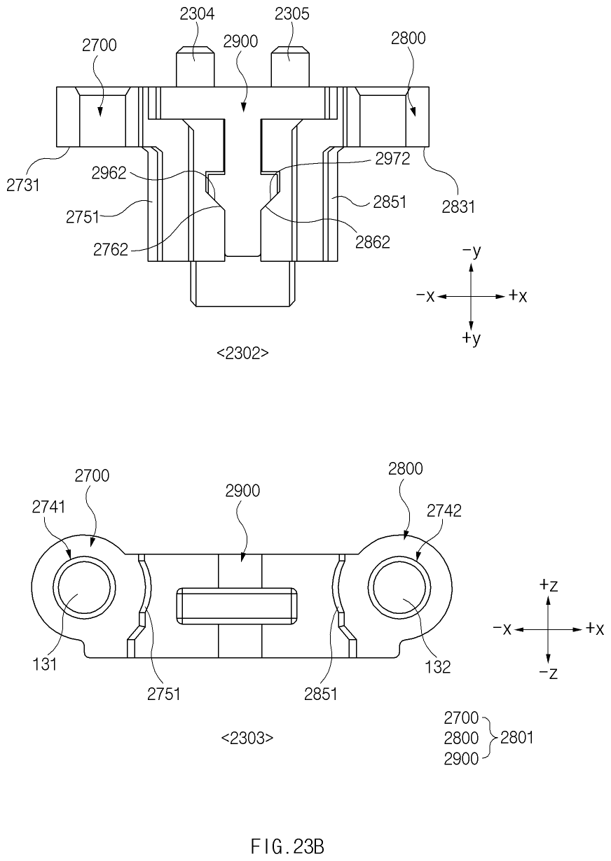

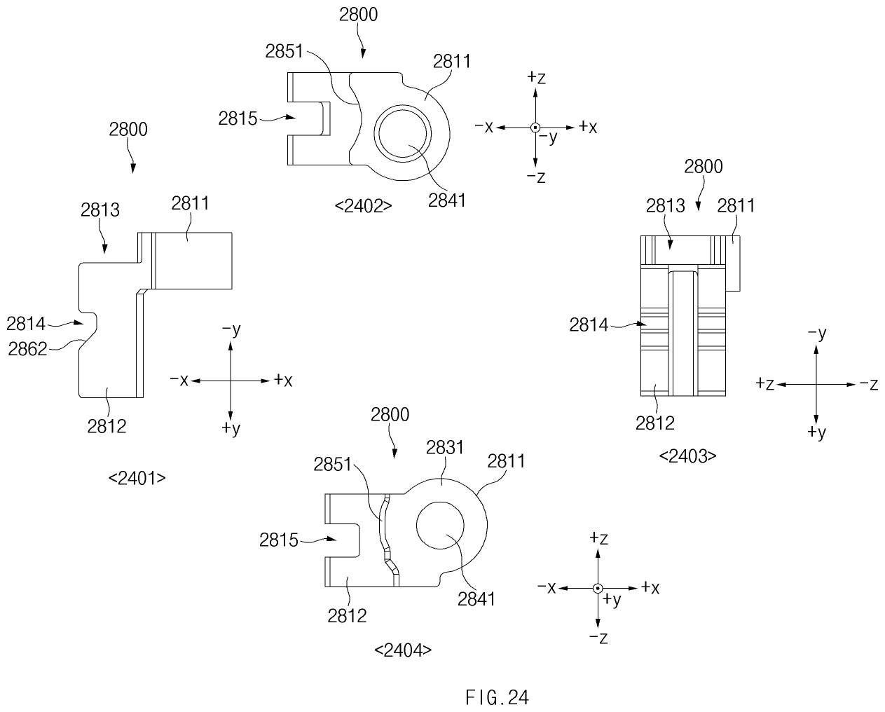

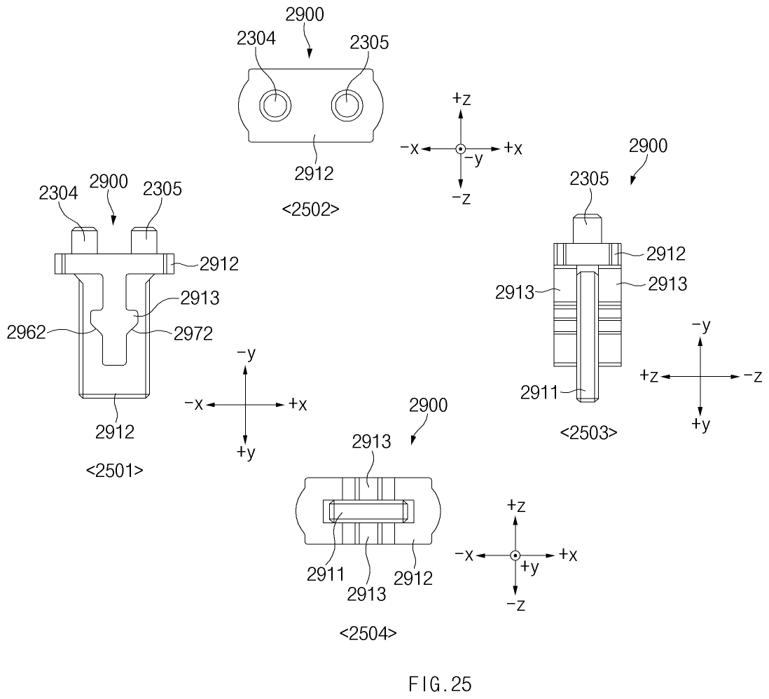

FIGS. 23A and 23B are views illustrating an embodiment of a portion of a fourth type hinge structure. In FIG. 23A, <2301> is a perspective view illustrating an embodiment of a portion of a fourth type hinge structure, <2302> in FIG. 23B is a front view of an embodiment of a portion of a fourth type hinge structure, when viewed in the z-axis direction, and <2303> is a side view of an embodiment of a portion of a fourth type hinge structure, when viewed in the y-axis direction. FIG. 24 is a view illustrating a friction member included in a friction structure of a fourth type hinge structure. In FIG. 24, <2401> is a front view of the friction member, when viewed in the z-axis direction, <2402> is a top view of the friction member, when viewed in the y-axis direction, <2403> is a left side view of the friction member, when viewed in the x-axis direction, and <2404> is a bottom view of the friction member, when viewed in the y-axis direction. FIG. 25 is a view illustrating an embodiment of a support member included in a friction structure. In FIG. 25, <2501> is a front view of the support member, when viewed in the z-axis direction, <2502> is a top view of the support member, when viewed in the y-axis direction, <2503> is a left side view of the support member, when viewed in the x-axis direction, and <2504> is a bottom view of the support member, when viewed in the y-axis direction.

Referring to FIGS. 1 to 25, the components of the fourth type hinge structure in an embodiment may correspond to the components of the first type hinge structure, the second type hinge structure, and/or the third type hinge structure described above, except for the friction structure. Accordingly, a detailed description of remaining (the other) components, except for the structures related to the friction structure may be replaced with the descriptions of FIGS. 1 to 22. The fourth type hinge structure in an embodiment may not include the third shaft 133 and the fourth shaft 134 described above, and may include the first shaft 131 and the second shaft 132.

A friction structure 2801 included in the fourth type hinge structure in an embodiment may include a first friction member 2700, a second friction member 2800, and a support member 2900.

The first friction member 2700 may include a first outer surface 2731 that faces (contacts) the first arm surface 431 of the first arm part 411. The first friction member 2700 may include a first outer hole 2741, into which the first shaft 131 may be inserted. The first friction member 2700 may generate a rotational frictional force while contacting the first arm surface 431 of the first arm part 411 due to the elastic force of the first elastic member 111 fastened to the first shaft 131. The first friction member 2700 may include a first outer curved surface 2751 that faces the first outer peripheral surface 435 of the first arm part 411. At least a portion of the first outer curved surface 2751 may be formed in an arc shape that is concavely curved in the +x-axis direction. At least a portion of the first outer peripheral surface 435 of the cylindrical first arm part 411 may be accommodated at at least a portion of the first outer curved surface 2751.

The second friction member 2800 may include a first part 2811 and a second part 2812.

The first part 2811 may protrude from the second part 2812 in the +x-axis direction and/or the-y-axis direction. The first part 2811 may protrude from the second part 2812 toward the second arm member 420. The first part 2811 may include a second outer hole 2841, into which the second shaft 132 may be inserted. The second outer hole 741 may have a diameter that is similar to that of the second shaft 132 so that the second shaft 132 may be inserted thereinto. The first part 2811 may be formed in a ring shape that surrounds the second outer hole 2841. The first part 2811 may include a second outer surface 2831 that faces (contact) the third arm surface of the second arm member 420. The second outer surface 2831 may generate a rotational frictional force while contacting the third arm surface of the second arm member 420 due to the elastic force of the second elastic member 112 connected to the second shaft 132.

The second part 2812 may protrude from the first part 2811 in an opposite direction to the first part 2811. The second part 2812 may extend from the first part 2811 toward the support member 2900. The second part 2812 may include a second outer curved surface 2851 that faces the outer peripheral surface of the third arm part 421. At least a portion of the second outer curved surface 2851 may be formed in an arc shape that is concavely curved in the −x-axis direction. At least a portion of the outer peripheral surface of the cylindrical third arm part 421 may be accommodated at at least a portion of the second outer curved surface 2851. The second part 2812 may include a first accommodation part 2813, a second accommodation part 2814, and a third accommodation part 2815 that are formed on an opposite surface of the second outer curved surface 2851. The first accommodation part 2813 may be formed in a shape of an opening, a hole, or a recess so that at least a portion of a second central portion 2912 of the support member 2900 may be accommodated. The second accommodation part 2814 may be formed in a shape of an opening, a hole, or a recess so that at least a portion of a third central portion 2913 of the support member 2900 may be accommodated. The third accommodation part 2815 may be formed in a shape of an opening, a hole, or a recess so that at least a portion of a first central portion 2911 of the support member 2900 may be accommodated.

In an embodiment, the first friction member 2700 may include configurations corresponding to the first part 2811 and the second part 2812 of the second friction member 2800. The first friction member 2700 may be symmetrical to the support member 2900 or the second friction member 2800 with respect to the y-axis direction. The first friction member 2700 may include a third part that is symmetrical to the first part 2811 of the second friction member 2800, and a fourth part that is disposed to be symmetrical to the second part 2812 of the second friction member 2800.

The support member 2900 may include a first central portion 2911, a second central portion 2912, and a third central portion 2913. The first central portion 2911 may be accommodated in a third accommodation part 2815 of each of the first friction member 2700 and the second friction member 2800. The second central portion 2912 may protrude from the first central portion 2911 in the-x-axis direction and the +x-axis direction. The second central portion 2912 may include a first seating member (e.g., a pole) 2304 that protrudes in the-y-axis direction and a second seating member (e.g., a pole) 2305, on which a second inner elastic member 2114 is seated.

The third central portion 2913 may protrude from the first central portion 2911 in the −z-axis direction and the +z-axis direction. The third central portion 2913 may include a first inner inclined surface 2962 that faces the first outer inclined surface 2762 of the first friction member 2700 and a second inner inclined surface 2972 that faces the second outer inclined surface 2862 of the second friction member 2800.

In an embodiment, the elastic force of the first inner elastic member 2113 may act to cause the first friction member 2700 to push (or press) the first arm member 410 through the first inner inclined surface 2962 of the support member 2900 and the first outer inclined surface 2762. Accordingly, the first outer curved surface 2751 of the first friction member 2700 may contact the first outer peripheral surface 435 of the cylindrical first arm part 411 to generate a cylindrical frictional force. The elastic force of the second inner elastic member 2114 may act to cause the second friction member 2800 to push (or press) the second arm member 420 through the second inner inclined surface 2972 of the support member 2900 and the second outer inclined surface 2862. Accordingly, the second outer curved surface 2851 of the second friction member 2800 may generate a cylindrical frictional force while contacting the outer peripheral surface of the cylindrical second arm member 420.

The foldable electronic device in an embodiment may secure a frictional force that is desired to maintain an angle in a flex operation through a cylindrical frictional force and a rotational frictional force even when a size of a cam member is decreased even when the frictional force due to the cam operation is decreased in a process of implementing a slim foldable electronic device.

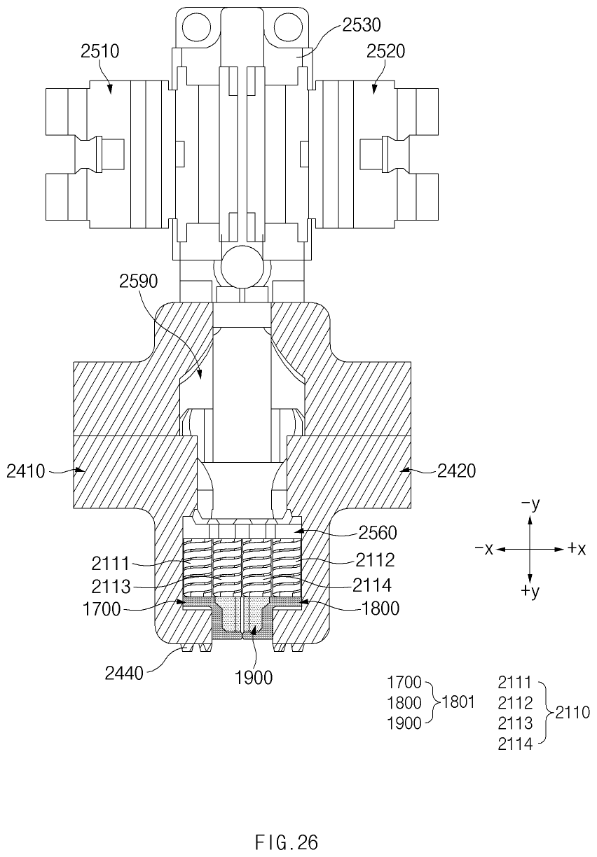

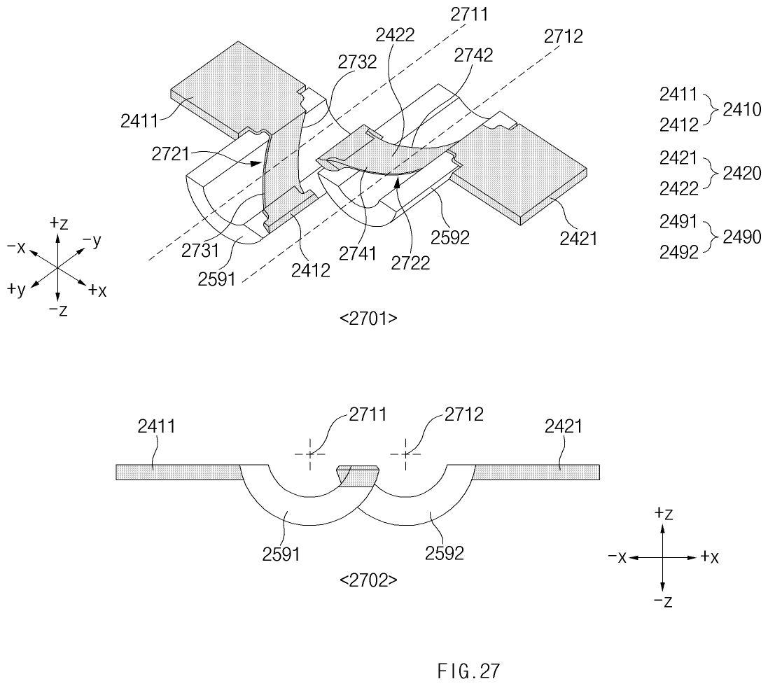

FIG. 26 is a view illustrating an embodiment of a portion of a fifth type hinge structure, and FIG. 27 is a view illustrating a spiral structure and an interlocking member illustrated in FIG. 26. In FIG. 27, <2701> is a perspective view illustrating an embodiment of an arm member and an interlocking member of the hinge structure, and <2702> is a cross-sectional view illustrating an embodiment of a portion of the arm member and the interlocking member of the hinge structure, taken along the x-axis direction.

Referring to FIGS. 26 and 27, the fifth type hinge structure in an embodiment may include a fixing bracket 2530, a first rotation member 2510, a second rotation member 2520, a first arm member 2410, a second arm member 2420, a shaft fixing part (not illustrated), a friction structure 1801, a cam member (not illustrated), a first elastic structure 2110, and an interlocking member 2590. The fixing bracket 2530, the first rotation member 2510, the second rotation member 2520, the shaft fixing part (not illustrated), the cam member, the first elastic structure 2110, and the second elastic structure disposed in the fifth type hinge structure may have the same or similar operation and structure as those of the fixing bracket 530, the first rotation member 510, the second rotation member 520, the shaft fixing part (not illustrated), the cam members 560 and 570, and the first elastic structure 110 described above with reference to FIGS. 3 to 22. The first elastic member 2111, the second elastic member 2112, the third elastic member 2113, and the fourth elastic member 2114 included in the first elastic structure 2110 may have the same or similar operation and structure as those of the first elastic member 111, the second elastic member 112, the third elastic member 113, and the fourth elastic member 114 described above with reference to FIGS. 3 to 22.

A first spiral structure 2412 (or a first spiral pattern, a first spiral protrusion, or a first spiral gear) may be disposed in a first spiral rotation member 2411 included in the first arm member 2410 of the fifth type hinge structure. The first spiral structure 2412 may be fastened to a first spiral hole 2721 that is formed in an interlocking member 2590. The first spiral structure 2412 is rotated in response to the rotation of the first spiral rotation member 2411 included in the first arm member 2410, and the interlocking member 2590, in which the first spiral hole 2721 is formed, may be moved linearly in the y-axis direction (or in a direction that parallel to a direction, in which the first display 230 is folded) in response to the rotation of the first spiral structure 2412.

A second spiral structure 2422 (or a second spiral pattern, a second spiral boss, or a second spiral gear) may be disposed in a second spiral rotation member 2421 included in the second arm member 2420. The second spiral structure 2422 may be fastened to a second spiral hole 2722 that is formed in the interlocking member 2590. The second spiral structure 2422 is rotated in response to the rotation of the second arm member 2420, and the interlocking member 2590, in which the second spiral hole 2722 is formed, may be moved linearly in the y-axis direction (or in a direction that parallel to a direction, in which the first display 230 is folded) in response to the rotation of the second spiral structure 2422.

The friction structure 1801 may include a first friction member 1700, a second friction member 1800, and a support member 1900. The first friction member 1700 included in the friction structure 1801 may correspond to the first friction member 700 described in FIGS. 3 to 22, the second friction member 1800 may correspond to the second friction member 800 described in FIGS. 3 to 22, and the support member 1900 may correspond to the support member 900 described in FIGS. 3 to 22. Accordingly, a description of a detailed structure of the friction structure 1801 including the first friction member 1700, the second friction member 1800, and the support member 1900 will be replaced with the description of the structure of the friction structure 801 described in FIGS. 3 to 22.

The foldable electronic device in an embodiment may secure a frictional force that is desired to maintain an angle in a flex operation through a cylindrical frictional force and a rotational frictional force even when a size of a cam member is decreased in a process of implementing a slim foldable electronic device. Furthermore, the foldable electronic device in an embodiment may implement a reduction in the number of parts and slimness by coupling the interlocking member to the spiral structure included in the arm member.

Although the spiral rotation members 2411 and 2421 of the foldable electronic device in an embodiment has been described as having a structure included in the arm member 2410 and 2420, the spiral rotation member 2411 and 2421 may also be formed as a structure that is separated from the arm members 2410 and 2420.

In an embodiment, the first spiral rotation member 2411 may be connected or coupled to a first housing (e.g., the first housing 210 of FIGS. 1A and 1B), and the second spiral rotation member 2421 may be connected (or coupled) to a second housing (e.g., the second housing 220 of FIGS. 1A and 1B). In an embodiment, the first spiral rotation member 2411 may be rotated around a first rotation axis 2711 together with the first housing, and the second spiral rotation member 2421 may be rotated around a second rotation axis 2712 together with the second housing. The first spiral rotation member 2411 and/or the second spiral rotation member 2421 may be rotated while surface-contacting the interlocking member 2590. In an embodiment, the interlocking member 2590 may not be directly coupled to the first housing and/or the second housing.

In an embodiment, the interlocking member 2590 may include a first interlocking member 2591 that accommodates the first spiral structure 2412 of the first spiral rotation member 2411 and a second interlocking member 2592 that accommodates the second spiral structure 2422 of the second spiral rotation member 2421.

In an embodiment, the first interlocking member 2591 may include a first spiral hole 2721 for accommodating at least a portion of the first spiral structure 2412. The first spiral hole 2721 may be a spiral-shaped hole that is formed around the first rotational axis 2711. The first interlocking member 2591 may include a first interlocking surface 2731 that defines at least a portion of the first spiral hole 2721, and a second interlocking surface 2732 that defines at least a portion of the first spiral hole 2721 and is substantially parallel to the first interlocking surface 2731.

In an embodiment, the second interlocking member 2592 may include a second spiral hole 2722 for accommodating at least a portion of the second spiral structure 2422. The second spiral hole 2722 may be a spiral-shaped hole that is formed around the second rotational axis 2712. The second interlocking member 2592 may include a third interlocking surface 2741 that defines at least a portion of the second spiral hole 2722, and a fourth interlocking surface 2742 that defines at least a portion of the second spiral hole 2722 and is substantially parallel to the third interlocking surface 2741.

In an embodiment, in the unfolded state of the hinge structure, the first spiral structure 2412 may be disposed within the first spiral hole 2721, and the second spiral structure 2422 may be disposed within the second spiral hole 2722. In the folded state of the hinge structure, a portion of the first spiral structure 2412 may be disposed in the first spiral hole 2721, and the remaining portions of the first spiral structure 2412 may be exposed to (or disposed on) the outside of the first spiral hole 2721. In the folded state of the hinge structure, a portion of the second spiral structure 2422 may be disposed in the second spiral hole 2722, and the remaining portions of the second spiral structure 2422 may be exposed to (or disposed on) the outside of the second spiral hole 2722.

In an embodiment, the hinge structure may be interlocked without a gear structure by the first spiral rotation member 2411, the second spiral rotation member 2421, and the interlocking member 2590. In an embodiment, because the hinge structure does not include a gear structure, the hinge structure may be slimmed.

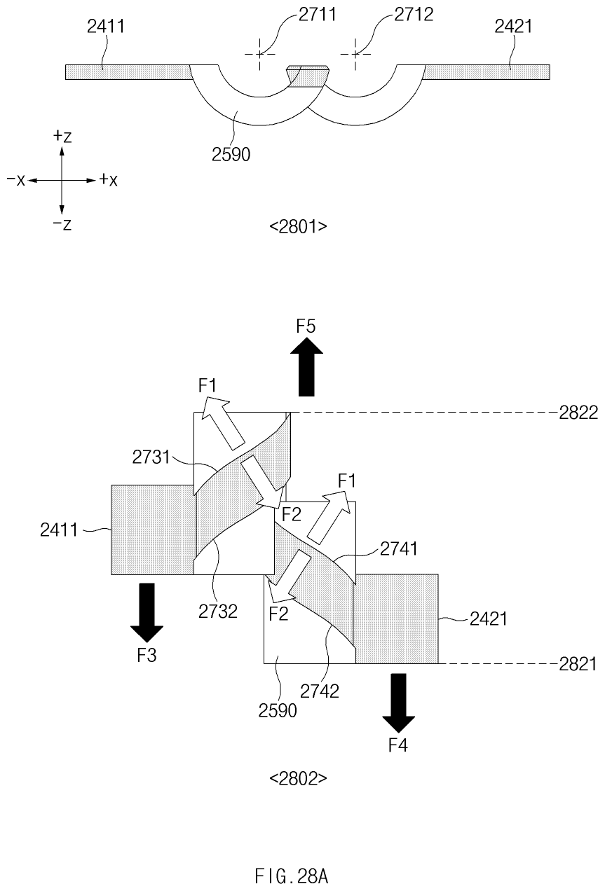

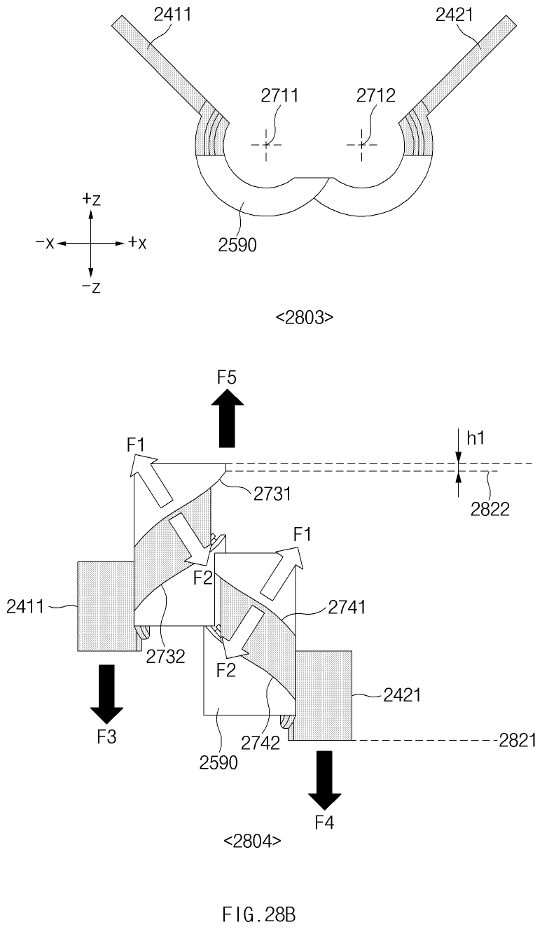

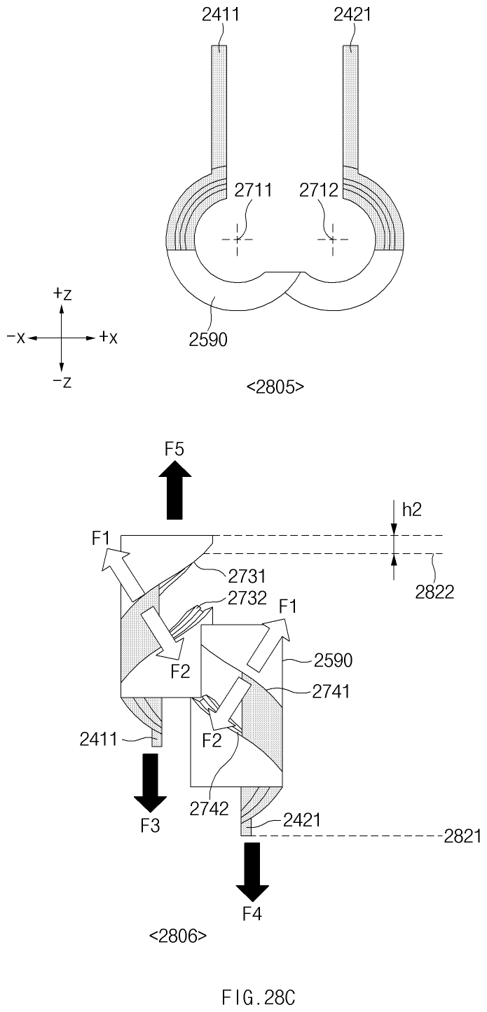

FIGS. 28A, 28B, and 28C are views illustrating a slide motion of an interlocking member. In FIG. 28A, <2801> is a cross-sectional view illustrating a hinge structure of a foldable electronic device in the unfolded state in an embodiment, and <2802> is a front view illustrating the hinge structure of the foldable electronic device in the unfolded state. In FIG. 28B, <2803> is a cross-sectional view illustrating a hinge structure of a foldable electronic device in the intermediate state of the first angle in an embodiment, and <2804> is a front view illustrating the hinge structure of the foldable electronic device in the intermediate state of the first angle. In FIG. 28C, <2805> is a cross-sectional view illustrating a hinge structure of a foldable electronic device in the folded state in an embodiment, and <2806> is a front view illustrating the hinge structure of the foldable electronic device in the folded state.

Referring to FIGS. 26 to 28C, in an embodiment, the hinge structure may include an unfolded state illustrated in FIG. 28A, an intermediate state illustrated in FIG. 28B (or the intermediate state of the first angle), and the folded state illustrated in FIG. 28C as the first spiral rotation member 2411 and the second spiral rotation member 2421 are rotated around the first rotation axis 2711 and the second rotation axis 2712, respectively.

In an embodiment, the first spiral rotation member 2411, the second spiral rotation member 2421, and/or the interlocking member 2590 may perform a spiral interlocking motion. The spiral interlocking motion may be interpreted as a motion, in which a rotation and a linear (sliding) motion are mutually converted. In an embodiment, when the first spiral rotation member 2411 and/or the second spiral rotation member 2421 is rotated, the first spiral rotation member 2411 and/or the second spiral rotation member 2421 may transmit a first force F1 to the first interlocking surface 2731, the second interlocking surface 2732, the third interlocking surface 2741, and/or the fourth interlocking surface 2742 of the interlocking member 2590, and may transmit a second force F2 to the first interlocking surface 2731, the second interlocking surface 2732, the third interlocking surface 2741, and/or the fourth interlocking surface 2742 of the interlocking member 2590. The second force F2 may be a repulsive force of the first force F1. The first force F1 and the second force F2 may be added together, and may be changed into a third force F3 that acts on the first spiral rotation member 2411, a fourth force F4 that acts on the second spiral rotation member 2421, and a fifth force F5 that acts on the interlocking member 2590. A magnitude of the sum of the third force F3 and the fourth force F4 may be substantially the same as a magnitude of the fifth force F5.

In an embodiment, the interlocking member 2590 may be slid in a lengthwise direction (e.g., the Y-axis direction) of the interlocking member 2590. In an embodiment, the interlocking member 2590 may be slid by a force (e.g., a fifth force F5 applied to the interlocking member 2590 as the first spiral rotation member 2411 connected to the first housing and/or the second spiral rotation member 2421 connected to the second housing is rotated, for example. The interlocking member 2590 may be slid relative to the first housing and/or the second housing.

In an embodiment, as illustrated in FIG. 28A, in the unfolded state of the hinge structure, one end of the interlocking member 2590 may be disposed at an imaginary first reference line 2821, and an opposite end of the interlocking member 2590 may be disposed at an imaginary second reference line 2822 that is spaced apart from the first reference line 2821 in the y-axis direction.

In an embodiment, as illustrated in FIG. 28B, when the hinge structure is converted from the unfolded state to the intermediate state, the interlocking member 2590 may be moved linearly in the y-axis direction by a first length h1. In an embodiment, in the intermediate state of the hinge structure, one end of the interlocking member 2590 may be disposed at the imaginary first reference line 2821, and an opposite end of the interlocking member 2590 may be disposed at a point that is displaced from an imaginary second reference line 2822 by a specified length h1.

In an embodiment, as illustrated in FIG. 28C, when the hinge structure is converted from the unfolded state to the folded state, the interlocking member 2590 may be moved linearly in the y-axis direction by a second length h2 (h2>h1). In an embodiment, in the folded state of the hinge structure, one end of the interlocking member 2590 may be disposed at the imaginary first reference line 2821, and an opposite end of the interlocking member 2590 may be disposed at a point that is displaced from an imaginary second reference line 2822 by a specified second length h2.

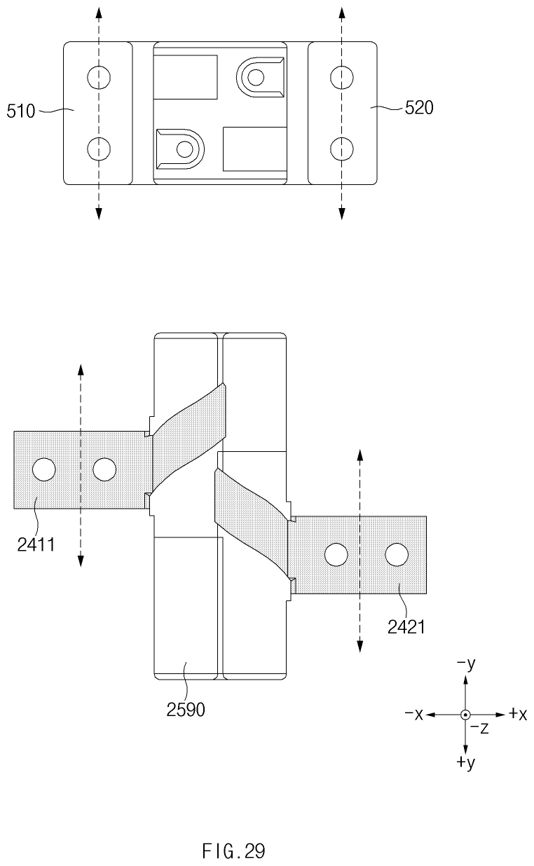

FIG. 29 is a view illustrating an embodiment of a rotation member and a spiral rotation member included in a hinge structure.

Referring to FIG. 29, in an embodiment, the first spiral rotation member 2411 and the second spiral rotation member 2421 may not have any rotational constraints. Unlike the sliding interlocking member 2590, the sliding motion of the first spiral rotation member 2411 and the second spiral rotation member 2421 may be decreased or limited. Because the first spiral rotation member 2411 is coupled to the first housing (e.g., the first housing 210 of FIGS. 1A and 1B), the movement of the first spiral rotation member 2411 in a linear direction (e.g., the Y-axis direction) may be limited or decreased. The second spiral rotation member 2421 is coupled to the second housing (e.g., the second housing 220 of FIGS. 1A and 1B), so that the movement of the second spiral rotation member 2421 in a linear direction (e.g., in the Y-axis direction) may be limited or decreased.

In an embodiment, the first spiral rotation member 2411 and the first rotation member 510 may be connected to each other. The first rotation member 510 may be rotated while being fixed to the first housing that is being rotated, so that there may be a degree of freedom of rotation. The first spiral rotation member 2411 may be rotated in response to the rotation of the first rotation member 510, so that there may be a degree of freedom of rotation. Because the first rotation member 510 and the first spiral rotation member 2411 are fixed to the first housing, there may be no degree of freedom for movement in a linear direction (e.g., in the y-axis direction).

In an embodiment, the second spiral rotation member 2421 and the second rotation member 520 may be connected to each other. The second rotation member 520 may be rotated while being fixed to the second housing that is being rotated, so that there may be a degree of freedom of rotation. The second spiral rotation member 2421 may be rotated in response to the rotation of the second rotation member 520, so that there may be a degree of freedom of rotation. Because the second rotation member 520 and the first spiral rotation member 2411 are fixed to the first housing, there may be no degree of freedom for movement in a linear direction (e.g., in the y-axis direction).

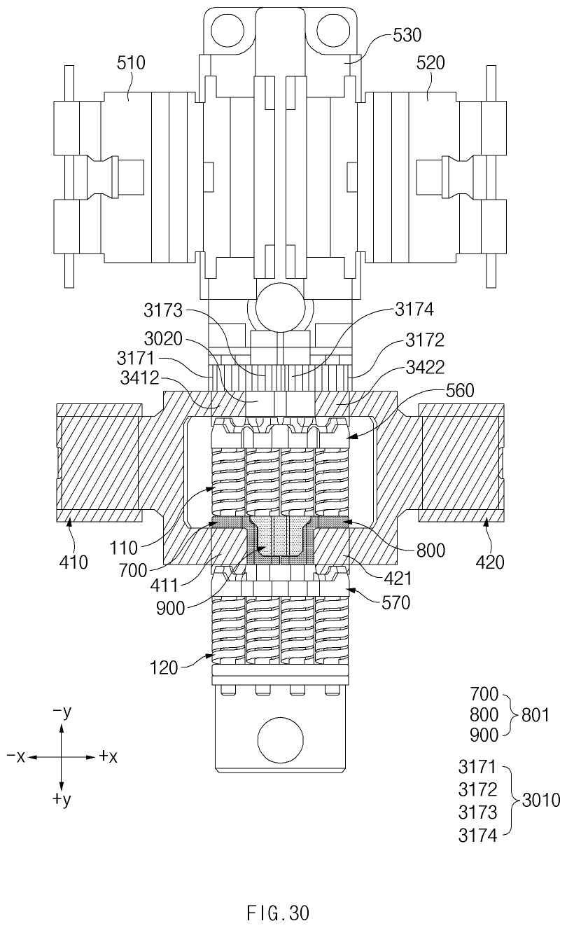

FIG. 30 is a view illustrating an embodiment of a portion of a sixth type hinge structure.

Referring to FIG. 30, the sixth type hinge structure in an embodiment may include a fixing bracket 530, a first rotation member 510, a second rotation member 520, a first arm member 410, a second arm member 420, a shaft fixing part 270, a friction structure 801, cam members 560 and 570, a first elastic structure 110, and a second elastic structure 120. The fixing bracket 530, the first rotation member 510, the second rotation member 520, the shaft fixing part 270, the cam member 560 and 570, the first elastic structure 110, and the second elastic structure 120 disposed in the seventh type hinge structure may have the same or similar operation and structure as those of the fixing bracket 530, the first rotation member 510, the second rotation member 520, the shaft fixing part 270, the cam member 560 and 570, the first elastic structure 110, and the second elastic structure 120 described above with reference to FIGS. 3 to 22.

The sixth type hinge structure in an embodiment may include a gear member 3010 that is separated from the first arm member 410 and the second arm member 420. The gear member 3010 may include a first main gear (or a first gear) 3171, a second main gear (or a second gear) 3172, a first interlocking gear (or a third gear) 3173, and a second interlocking gear (or a fourth gear) 3174.

The first main gear 3171 and the second main gear 3172 may be disposed separately from the arm members 410 and 420. The first main gear 3171, the first interlocking gear 3173, the second interlocking gear 3174, and the second main gear 3172 may be gear-connected to each other. The first interlocking gear 3173 and the second interlocking gear 3174 may be gear-coupled to each other. A gear bracket 3020 may be disposed between each of the first interlocking gear 3173 and the second interlocking gear 3174 and the first cam member 560. The gear bracket 3020 may include holes, through which a third shaft (e.g., the third shaft 133 of FIG. 5) and a fourth shaft (e.g., the fourth shaft 134 of FIG. 5) pass to be held, and holding holes, through which one side of at least one interlocking gear 3173 and 3174 is held.

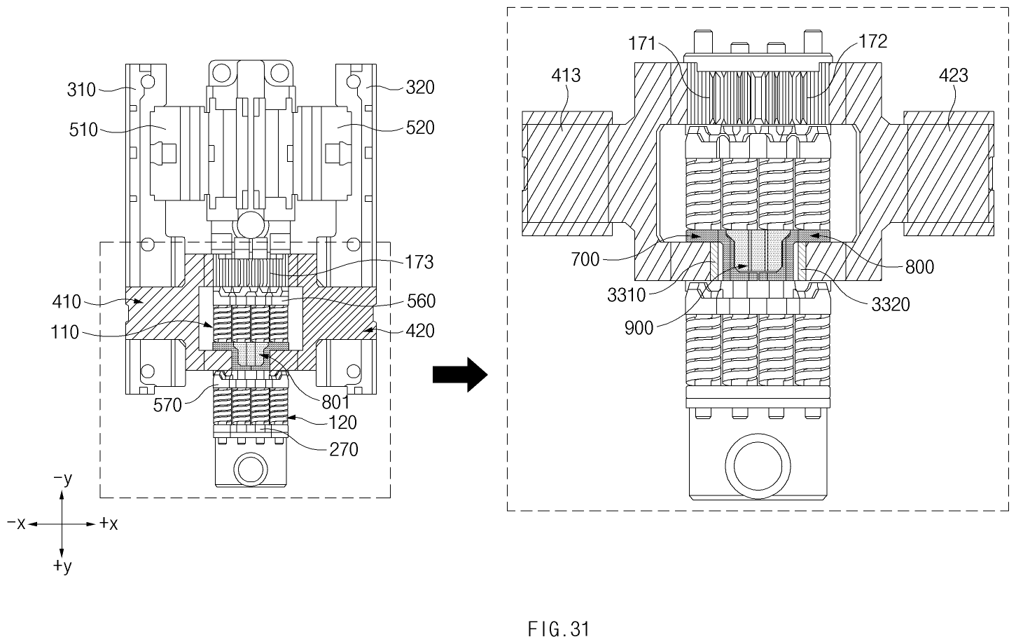

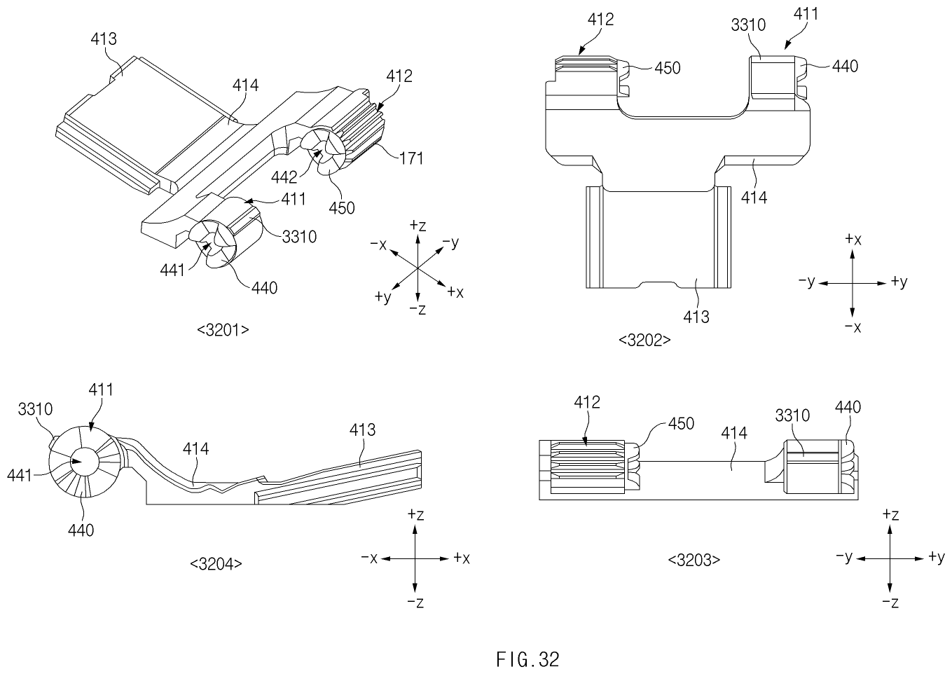

FIG. 31 is a view illustrating an embodiment of a portion of a seventh type hinge structure. FIG. 32 is a view illustrating an embodiment of an arm member included in a seventh type hinge structure. In FIG. 32, <3201> is a perspective view illustrating an arm member included in the seventh type hinge structure, <3202> is a cross-sectional view of the arm member included in the seventh type hinge structure, when viewed in the z axis, <3203> is a cross-sectional view of the arm member included in the seventh type hinge structure, when viewed in the x axis, and <3204> is a cross-sectional view of the arm member included in the seventh type hinge structure, when viewed in the y axis.

Referring to FIGS. 31 and 32, the seventh type hinge structure in an embodiment may include a fixing bracket 530, a first rotation member 510, a second rotation member 520, a first arm member 410, a second arm member 420, a shaft fixing part 270, a friction structure 801, cam members 560 and 570, a first elastic structure 110, and a second elastic structure 120. The fixing bracket 530, the first rotation member 510, the second rotation member 520, the shaft fixing part 270, the cam member 560 and 570, the first elastic structure 110, and the second elastic structure 120 disposed in the seventh type hinge structure may have the same or similar operation and structure as those of the fixing bracket 530, the first rotation member 510, the second rotation member 520, the shaft fixing part 270, the cam member 560 and 570, the first elastic structure 110, and the second elastic structure 120 described above with reference to FIGS. 3 to 22.

The first arm member 410 included in the seventh type hinge structure may include a first arm body 414, a first arm part 411, a second arm part 412, a first slide part 413, and a first arm boss 3310. The second arm member 420 included in the seventh type hinge structure may include a second arm body 424, a third arm part 421, a fourth arm part 422, a second slide part 423, and a second arm boss 3320. The first arm body 414, the first arm part 411, the second arm part 412, the first slide part 413, the second arm body 424, the third arm part 421, the fourth arm part 422, and the second slide part 423 included in the seventh type hinge structure may have the same or similar operations and structures as those of the first arm body 414, the first arm part 411, the second arm part 412, the first slide part 413, the second arm body 424, the third arm part 421, the fourth arm part 422, and the second slide part 423 described above with reference to FIGS. 3 to 22.

In an embodiment, a first arm boss 3310 included in the seventh type hinge structure may be formed on a first outer peripheral surface of a first arm part 411. The first arm boss 3310 may be elongated in the first arm part 411 to be parallel to the first main gear 171. The first arm boss 3310 may protrude from a portion of the first outer peripheral surface 435 of the first arm part 411 toward the first friction member 700. The first arm boss 3310 may protrude in an opposite direction to an extension direction of the first slide part 413. Because the second arm boss 3320 may correspond to the first arm boss 3310, a description of a detailed structure of the second arm boss 3320 will be replaced with the description of the structure of the first arm boss 3310.

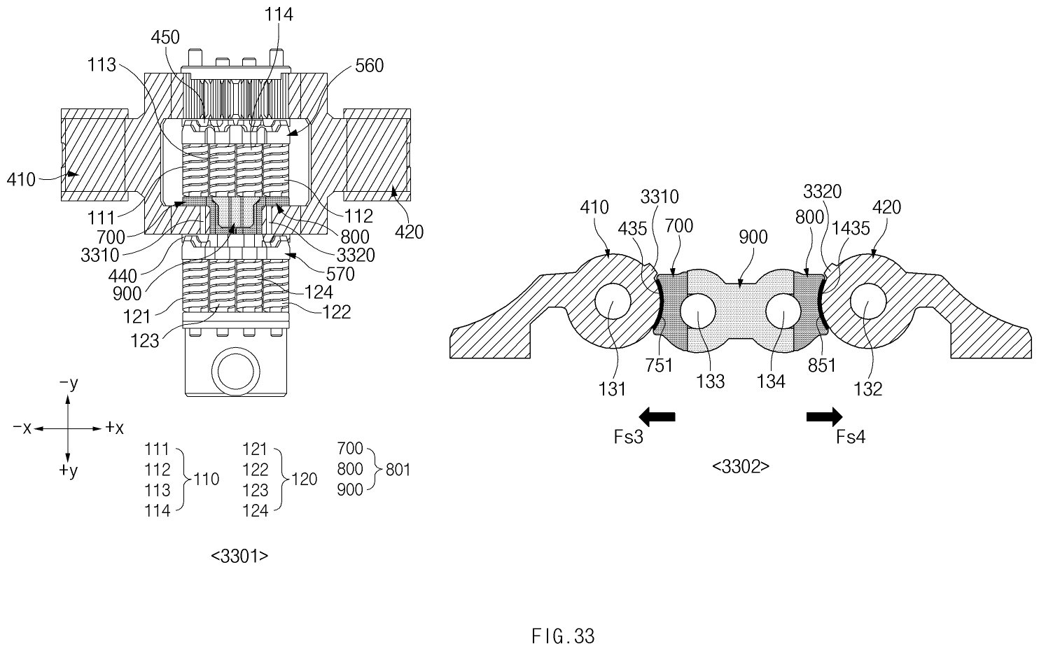

FIG. 33 is a view illustrating an embodiment of a disposition of an arm member and a friction member in an unfolded state of a seventh type hinge structure. In FIG. 33, <3301> is a perspective view illustrating a disposition of the arm member and the friction member in the unfolded state of the hinge structure, and <3302> is a cross-sectional view illustrating a disposition of the arm member and the friction member in the unfolded state of the hinge structure.

Referring to FIGS. 31, 32, and 33, in the unfolded state of the hinge structure, the first arm boss 3310 contacts one end (e.g., a corner that contacts one end of the first outer curved surface 751) of the first friction member 700, and the second arm boss 3320 contacts one end (e.g., a corner that contacts one end of the second outer curved surface 851) of the second friction member 800, so that the hinge structure may be suppressed from being folded. In an embodiment, when the first arm boss 3310 contacts one end of the first friction member 700 and the second arm boss 3320 contacts one end of the second friction member 800, a portion of the first outer peripheral surface 435 of the first arm member 410 may contact the first outer curved surface 751 of the first friction member, and a portion of the second outer peripheral surface 1435 of the second arm member 420 may contact the second outer curved surface 851 of the second friction member.

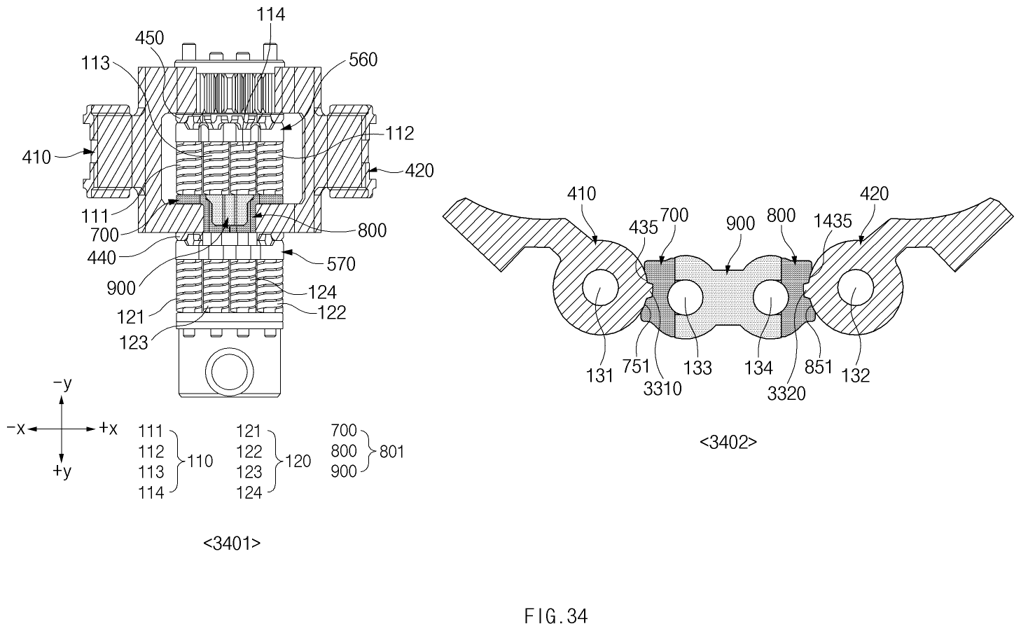

FIG. 34 is a view illustrating a disposition of an arm member and a friction member in an intermediate state of a seventh type hinge structure. In FIG. 34, <3401> is a perspective view illustrating a disposition of the arm member and the friction member in the intermediate state of the hinge structure, and <3402> is a cross-sectional view illustrating a disposition of the arm member and the friction member in the intermediate state of the hinge structure.

Referring to FIGS. 31, 32, and 34, in an operation of converting the unfolded state of the hinge structure to the intermediate state, the first arm boss 3310 may be moved along the first outer curved surface 751 on the first outer curved surface 751 of the first friction member 700. The second arm boss 3320 may be moved along the second outer surface 851 on the second outer surface 851 of the second friction member 800. In an embodiment, a maximum static frictional force may be generated due to a contact between the first arm boss 3310 and the first outer curved surface 751 and a contact between the second arm boss 3320 and the second outer surface 851. By not only the maximum static frictional force but also the rotational frictional force and the cylindrical frictional force, the hinge structure including the first arm member 410 and the second arm member 420 may be maintained in a state, in which the hinge structure is folded by the first angle from the intermediate state.

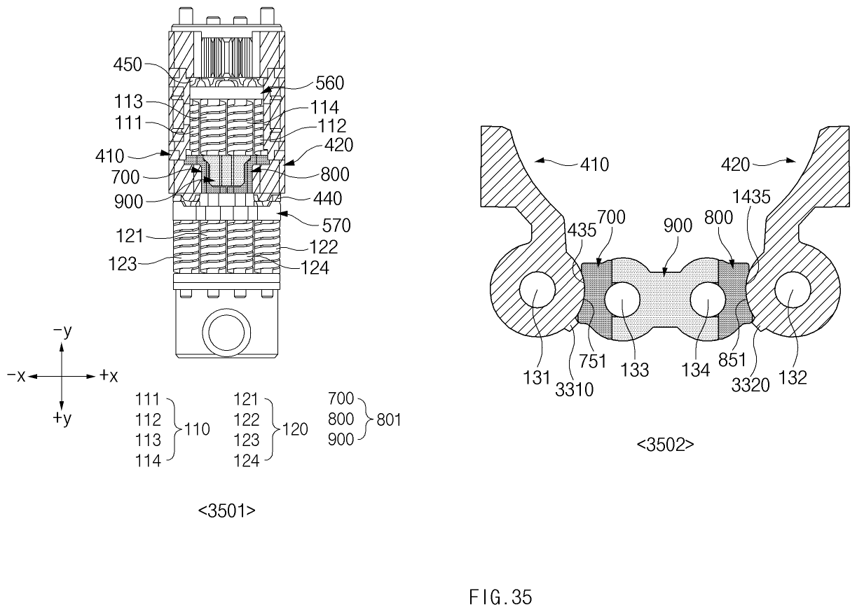

FIG. 35 is a view illustrating an embodiment of a disposition of an arm member and a friction member in a folded state of a seventh type hinge structure. In FIG. 35, <3501> is a perspective view illustrating a disposition of the arm member and the friction member in the folded state of the hinge structure, and <3502> is a cross-sectional view illustrating a disposition of the arm member and the friction member in the folded state of the hinge structure.

Referring to FIGS. 31, 32, and 33, in the folded state of the hinge structure, the first arm boss 3310 contacts an opposite end (e.g., a corner that contacts an opposite end of the first outer curved surface 751) of the first friction member 700, and the second arm boss 3320 contacts an opposite end (e.g., a corner that contacts an opposite end of the second outer curved surface 851) of the second friction member 800, so that the hinge structure may be suppressed from being unfolded. In an embodiment, when the first arm boss 3310 contacts an opposite end of the first friction member 700 and the second arm boss 3320 contacts an opposite end of the second friction member 800, a portion of the first outer peripheral surface 435 of the first arm member 410 may contact the first outer curved surface 751 of the first friction member 700, and a portion of the second outer peripheral surface 1435 of the second arm member 420 may contact the second outer curved surface 851 of the second friction member 800, so that a cylindrical frictional force may be generated. By the cylindrical frictional force and the rotational frictional force of the arm members 410 and 420, the hinge structure including the first arm member 410 and the second arm member 420 may be maintained in the folded state.

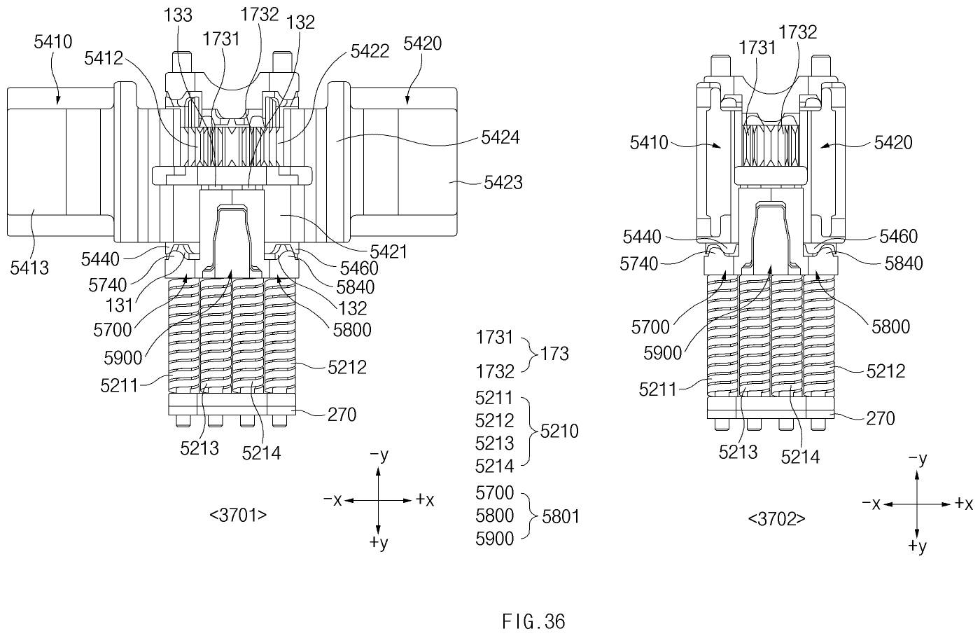

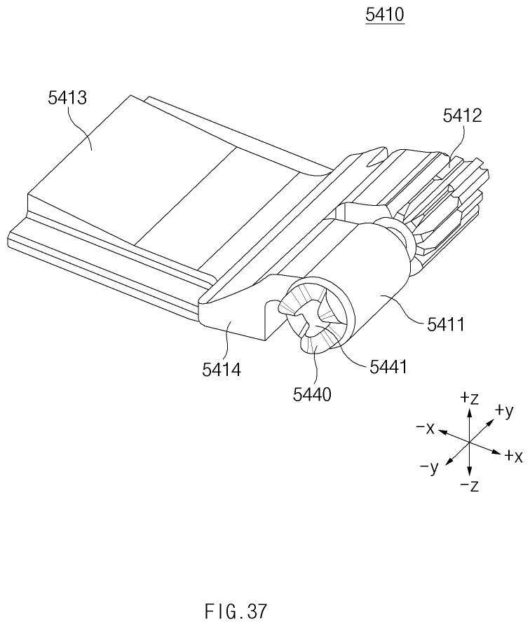

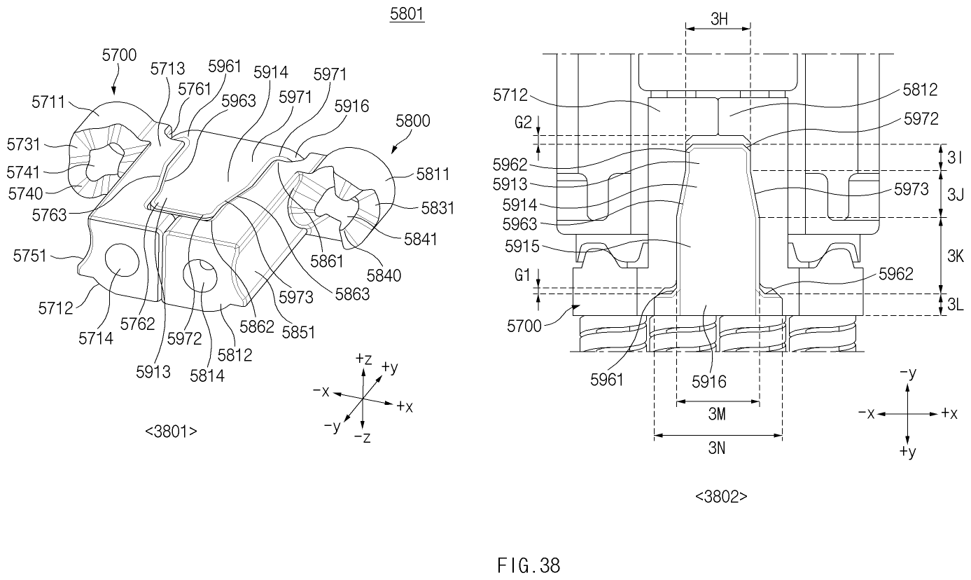

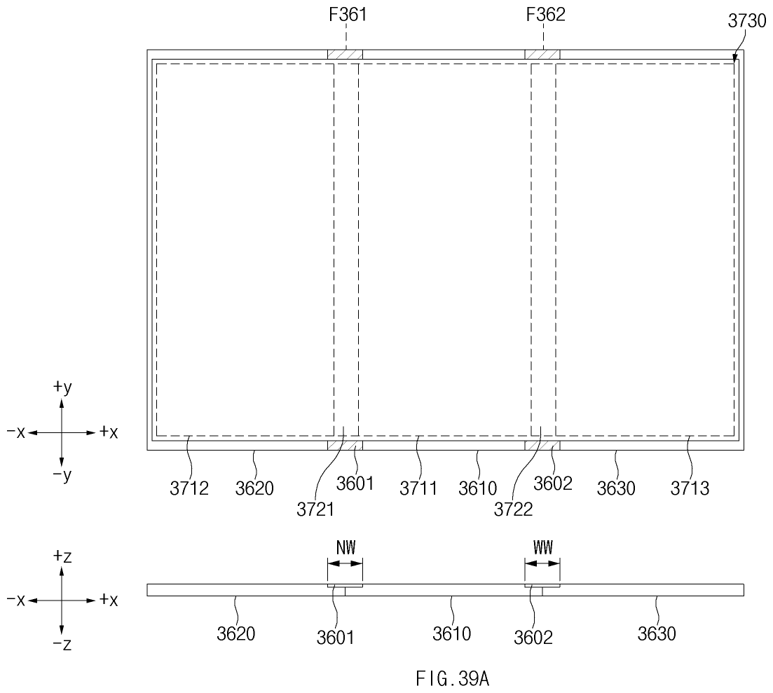

FIG. 36 is a view illustrating an embodiment of a portion of an eighth type hinge structure. In FIG. 36, <3701> is a view illustrating an embodiment of the eighth type hinge structure in an unfolded state, and <3702> is a view illustrating an embodiment of the eighth type hinge structure in a folded state. FIG. 37 is a view illustrating an embodiment of an arm member included in the eighth type hinge structure, and FIG. 38 is a view illustrating a friction structure included in the eighth type hinge structure. In FIG. 38, <3801> is a perspective view illustrating a friction structure included in the eighth type hinge structure, and <3802> is a plan view illustrating the arm member included in the eighth type hinge structure, when viewed in the z axis.

Referring to FIGS. 36, 37, and 38, the components of the eighth type hinge structure in an embodiment may correspond to the components of the first to seventh type hinge structures described above, except for the friction structures 5801 and the arm members 5410 and 5420. Accordingly, a detailed description of remaining (the other) components, except for the structure related to the friction structure 5801 and the arm members 5410 and 5420, may be replaced with the descriptions of FIGS. 1 to 22.

In an embodiment, the eighth type hinge structure may include a friction structure 5801, a first arm member 5410, and a second arm member 5420. The first arm member 5410 may include a first arm body 5414, a first arm portion 5411, a second arm portion 5412, and a first slide portion 5413. The second arm member 5420 included in the eighth type hinge structure may include a second arm body 5424, a third arm portion 5421, a fourth arm portion 5422, and a second slide portion 5423. The first arm body 5414, the first arm portion 5411, the second arm portion 5412, the first slide portion 5413, the second arm body 5424, the third arm portion 5421, the fourth arm portion 5422, and the second slide portion 5423 may have the same or similar operations and structures as those of the first arm body 414, the first arm part 411, the second arm part 412, the first slide part 413, the second arm body 424, the third arm part 421, the fourth arm part 422, and the second slide part 423 described above with reference to FIGS. 3 to 22.

In an embodiment, the friction structure 5801 included in the eighth type hinge structure may include a first friction member 5700, a second friction member 5800, and a support member 5900.

The first friction member 5700 may include a first outer body 5713 (or a first body), a first outer part 5711, and a second outer part 5712.

The first outer part 5711 may protrude from the first outer body 5713 toward the first arm member 5410 in the-x-axis direction. The first outer part 5711 may be formed in a ring shape that surrounds the first outer hole 5741. The first shaft 131 may be inserted into the first outer hole 5741. The first outer surface 5731 (e.g., a surface that faces the −y-axis) of the first outer part 5711 may be in contact with the first arm portion 5411 of the first arm member 5410. One surface (e.g., a surface facing the +y-axis) of the first outer part 5711 in a direction opposite to the first outer surface 5731 of the first outer part 5711 may be formed to support the first elastic member 5211. At least one first friction cam part 5740 may be formed on the first outer surface 5731. The first friction cam part 5740 may have a mountain portion and a valley portion repeatedly disposed in a state of rising (or protruding) in the-y-axis direction. The apex portion of the mountain portion of the first friction cam part 5740 may be formed to be higher than the surroundings (e.g., valley portion) thereof and the apex portion may be flat. The first friction cam part 5740 may be engaged with the first cam structure 5440 formed in the first arm part 5411 of the first arm member 5410. The first friction cam part 5740 formed in the first outer part 5711 is in contact with the first cam structure 5440 formed in the first arm part 5411 by the elastic force of the first elastic member 5211 and thus a frictional force may be generated between the first friction cam part 5740 and the first cam structure 5440.

The second outer part 5712 may protrude from the first outer body 5713 in a direction opposite to the first outer part 5711. The second outer part 5712 may protrude from the first outer body 5713 toward the support member 5900 and/or the second friction member 5800 in the +x-axis direction. The second outer part 5712 may be formed in a ring shape surrounding the second outer hole 5714 into which the third shaft 133 is inserted.

The first outer body 5713 may be disposed between the first outer part 5711 and the second outer part 5712. A contact area between the first outer body 5713 and the first arm part 5411 may be formed to be greater than a contact area between the first outer surface 5731 and the first arm part 5411 of the first outer part 5711.

At least a portion of the first outer body 5713 may be formed to surround a portion of the support member 5900. In an embodiment, a portion of the first outer body 5713 may include at least one outer inclined surface 5761 and 5762 that faces (or contacts) the at least one inner inclined surface. In an embodiment, the first outer body 5713 may include a first outer inclined surface 5761, a second outer inclined surface 5762, and a fifth outer inclined surface 5763. In an embodiment, the first outer inclined surface 5761 and the second outer inclined surface 5762 may be formed to be inclined at the same angle or different angles from each other. In an embodiment, the first outer body 5713 may include a fifth outer inclined surface 5763 without the first outer inclined surface 5761 and the second outer inclined surface 5762. The fifth outer inclined surface 5763 that may be in contact with the fifth inner inclined surface 5963 of the support member 5900 may transmit the elastic force of the elastic member 5210 to the first outer curved surface 5751 (or the first curved surface) of the first friction member 5700. The fifth outer inclined surface 5763 may convert the elastic force of the elastic member 5210 into a direction toward the first outer curved surface 5751 and transmit the same to the first outer curved surface 5751.

At least a portion of the first outer body 5713 may have a shape corresponding to that of the first arm portion 5411 of the first arm member 5410. In an embodiment, a portion of the first outer body 5713 may include a first outer curved surface 5751 surrounding a portion of the first arm portion 5411 having an empty center portion. The first outer curved surface 5751 of the first outer part 5711 may come into contact with the first arm part 5411 by the elastic force of the elastic member 5210 to generate friction.

In an embodiment, the second friction member 5800 may be disposed to pass through the second shaft 132 and the fourth shaft 134. The second friction member 5800 may be disposed between the third arm part 5421 of the second arm member 5420 and the support member 5900 to be in contact with at least a portion of each of the third arm part 5421 and the support member 5900.

In an embodiment, the second friction member 5800 may be formed to be symmetrical to the first friction member 5700 with respect to the y-axis (or with the support member 5900 interposed therebetween). The second friction member 5800 may include the same, corresponding, or similar configuration as the first friction member 5700. In an embodiment, the second friction member 5800 may include a second outer body 5813 (or a second body), a third outer part 5811 and a fourth outer part 5812. The second outer body 5813 including the third outer inclined surface 5861, the fourth outer inclined surface 5862, the sixth outer inclined surface 5863, and the second outer curved surface 5851 may correspond to a first outer body 5713 including a first outer inclined surface 5761, a second outer inclined surface 5762, and a first outer curved surface 5751, and the third outer part 5811 including a second friction cam part 5840, a third outer hole 5841, and a second outer surface 5831 may correspond to a first outer part 5711 including a first friction cam part 5740, a first outer hole 5741, and a first outer surface 5731. The fourth outer part 5812 including the fourth outer hole 5814 may correspond to the second outer part 5712 including the second outer hole 5714. Accordingly, a description of the detailed structure of the second friction member 5800 will be replaced with the description of the structure of the first friction member 5700.

In an embodiment, the support member 5900 may be surrounded by the elastic structure 5210, the first friction member 5700, and the second friction member 5800. The support member 5900 may be disposed to pass through the third shaft 133 and the fourth shaft 134. The support member 5900 may include a seating part 5916, a first inner part 5915, a second inner part 5914, and a third inner part 5913.

The seating part 5916 may be formed to face (or contact or seat) the third elastic member 5213 and the fourth elastic member 5214. The seating part 5916 may have a 37th length 3N in the x-axis direction and a 35th length 3L in the y-axis direction. The 37th length 3N may have a length corresponding to the number of elastic members 5210 disposed at the seating part 5916. For example, the 37th length 3N may be a length corresponding to the sum of the diameters of the third elastic member 5213 and the fourth elastic member 5214. The 35th length 3L may be formed with a minimum thickness corresponding to the minimum rigidity of the support member 5900. The 35th length 3L may be formed to be thinner than the first outer part 5711 of the first friction member 5700 and the third outer part 5811 of the second friction member 5800.

The first inner part 5915 may extend in the −y-axis direction from the seating part 5916, and may be formed to have a shorter length in the x-axis direction than the seating part 5916. The first inner part 5915 may face (or contact) a portion of the first outer body 5713 of the first friction member 5700 in the −x-axis direction, and may face (or contact) a portion of the second outer body 5813 of the second friction member 5800 in the +x-axis direction. The first inner inclined surface 5961 and a third inner inclined surface 5971 may be formed between the first inner part 591 and the seating part 5916. In an embodiment, the first inner inclined surface 5961 and the third inner inclined surface 5971 may be formed symmetrically with respect to the y-axis. The first inner inclined surface 5961 may face the first outer inclined surface 5761 of the first friction member 5700, and the third inner inclined surface 5971 may face the third outer inclined surface 5861 of the second friction member 5800. The first inner part 5915 may have a 36th length 3M in the x-axis direction and a 34th length 3K in the y-axis direction. The 36th length 3M may be formed to be smaller than the 37th length 3N and larger than the 31st length 3H. The 36th length 3M may correspond to a distance between the central axis of the third elastic member 5213 and the central axis of the fourth elastic member 5214. The 36th length 3M may be the same as or similar to the diameter of any one of the third elastic member 5213 and the fourth elastic member 5214. The 34th length 3K may be formed to be greater than the height (or y-axis length) of the first friction cam part 5740 and/or the second friction cam part 5840. In an embodiment, the 34th length 3K may be formed to have a length corresponding to the sum of the minimum thickness corresponding to the height (or y-axis length) of the first friction cam part 5740 and/or the minimum rigidity of the support member 5900.

The second inner part 5914 may extend in the-y-axis direction from the first inner part 5915. The second inner part 5914 may be disposed between the first inner part 5915 and the third inner part 5913. The second inner part 5914 may have a length in the x-axis direction that gradually decreases toward the third inner part 5913. The second inner part 5914 may include a fifth inner inclined surface 5963 that faces (or contacts) the fifth outer inclined surface 5763 of the first friction member 5700, and a sixth inner inclined surface 5973 that faces (or contacts) the sixth outer inclined surface 5863 of the second friction member 5800. An inclined length (or area) of the fifth inner inclined surface 5963 may be formed to be greater than those of the first inner inclined surface 5961 and the second inner inclined surface 5962. An angle formed by the fifth inner inclined surface 5963 and the virtual surface extending in the y-axis direction may be formed to be smaller than an angle formed by each of the first inner inclined surface 5961 and the second inner inclined surface 5962 and the virtual surface extending in the y-axis direction. An inclined length (or an area) of the sixth inner inclined surface 5973 may be formed to be greater than those of the third inner inclined surface 5971 and the fourth inner inclined surface 5972. An angle formed by the sixth inner inclined surface 5973 and the virtual surface extending in the y-axis direction may be formed to be smaller than an angle formed by each of the third inner inclined surface 5971 and the fourth inner inclined surface 5972 and the virtual surface extending in the y-axis direction. A separation distance between the fifth inner inclined surface 5963 and the fifth outer inclined surface 5763 may be shorter than a separation distance between the first inner inclined surface 5961 and the first outer inclined surface 5761 and/or a separation distance between the second inner inclined surface 5962 and the second outer inclined surface 5762. A separation distance between the fifth inner inclined surface 5963 and the fifth outer inclined surface 5763 may be zero. When the support member 5900 presses the first friction member 5700 based on an elastic force of the third elastic member 5213, a contact between the fifth inner inclined surface 5963 and the fifth outer inclined surface 5763 may take precedence over a contact between the first inner inclined surface 5961 and the first outer inclined surface 5761 and/or a contact between the second inner inclined surface 5962 and the second outer inclined surface 5762. A separation distance between the sixth inner inclined surface 5973 and the sixth outer inclined surface 5863 may be shorter than a separation distance between the third inner inclined surface 5971 and the third outer inclined surface 5861 and/or a separation distance between the fourth inner inclined surface 5972 and the fourth outer inclined surface 5862. A separation distance between the sixth inner inclined surface 5973 and the sixth outer inclined surface 5863 may be zero. When the support member 5900 presses the second friction member 5800 based on an elastic force of the elastic member 5210, for example, the contact between the sixth inner inclined surface 5973 and the sixth outer inclined surface 5863 may take precedence over a contact between the third inner inclined surface 5971 and the third outer inclined surface 5861 and/or a contact between the first inner inclined surface 5961 and the first outer inclined surface 5761 of the fourth inner inclined surface 5862. In an embodiment, the second inner part 5914 may have a 33rd length 3J in the y-axis direction. The 33rd length 3J may be formed based on the inclined lengths of the fifth inner inclined surface 5963 and the sixth inner inclined surface 5973. The 33rd length 3J may be formed in proportion to a target friction area between the first friction member 5700 and the first arm member 5410 and/or a target friction area between the second friction member 5800 and the second arm member 5420. Since the 33rd length 3J is formed to be greater than the 32nd length 3I and/or the 35th length 3L, a large contact area (or friction area) may be secured between the support member 5900 and each of the first friction member 5700 and the second friction member 5800.

The third inner part 5913 may extend from the second inner part 5914, in the −y-axis direction, and may be formed to have a shorter length in the x-axis direction than the first inner part 5915. The third inner part 5913 may face (or be separated or contacted) a portion of the second outer part 5712 of the first friction member 5700 in the y-axis direction, and may face (or be separated or contacted) a portion of the fourth outer part 5812 of the second friction member 5800 in the y-axis direction. A second inner inclined surface 5962 and a fourth inner inclined surface 5972 may be formed on the third inner part 5913. For example, the second inner inclined surface 5962 and the fourth inner inclined surface 5972 may be formed symmetrically with respect to the y-axis. The second inner inclined surface 5962 may face the second outer inclined surface 5762 of the first friction member 5700, and the fourth inner inclined surface 5972 may face the fourth outer inclined surface 5862 of the second friction member 5800. In an embodiment, the third inner part 5913 may have a 31st length 3H in the x-axis direction and a 32nd length 3I in the y-axis direction. The 31st length 3H may be formed to be greater than the 32nd length 3I. The 31st length 3H may be less than the 36th length 3M and the 37th length 3N, based on a gradient of each of the fifth inner inclined surface 5963 and the sixth inner inclined surface 5973. In an embodiment, the 31st length 3H may correspond to a value obtained by subtracting each of an x-axis length corresponding to a gradient of the fifth inner inclined surface 5963 and an x-axis length corresponding to a gradient of the sixth inner inclined surface 5973. The 32nd length 3I may be formed to be less than the 31st length 3H. The 32nd length 3I may be formed to be the same as or similar to the 35th length 3L of the seating part 5916.

In an embodiment, the seating part 5916 of the support member 5900 may be spaced apart from each of the first friction member 5700 and the second friction member 5800 at a first interval G1, before, during, and/or after the first friction member 5700 and/or the second friction member 5800 are pressed by the support member 5900. The third inner part 5913 of the support member 5900 may be spaced apart from the first friction member 5700 (e.g., the second outer part 5712) and/or the second friction member 5800 (e.g., the fourth outer part 5812) at a second interval G2, before, during, and/or after the first friction member 5700 and/or the second friction member 5800 are pressed by the support member 5900. The second interval G2 may be equal to or different from the first interval G1. In an embodiment, when the support member 5900 may press the first friction member 5700 and the second friction member 5800 based on the elastic force of the elastic member 5210 (e.g., the third elastic member 5213 and the fourth elastic member 5214), a contact between the fifth inner inclined surface 5963 and the fifth outer inclined surface 5763 and/or a contact between the sixth inner inclined surface 5973 and the sixth outer inclined surface 5863 may take precedence over a contact between each of the first friction member 5700 and the second friction member 5800 and a seating part 5916 and/or a contact between each of the first friction member 5700 and the second friction member 5800 and the third inner part 5913.

The electronic device in an embodiment includes a plurality of hinge structures so that the display may be folded at least once. An embodiment, in which the display may be folded a plurality of times, will be described below as one of the embodiments.

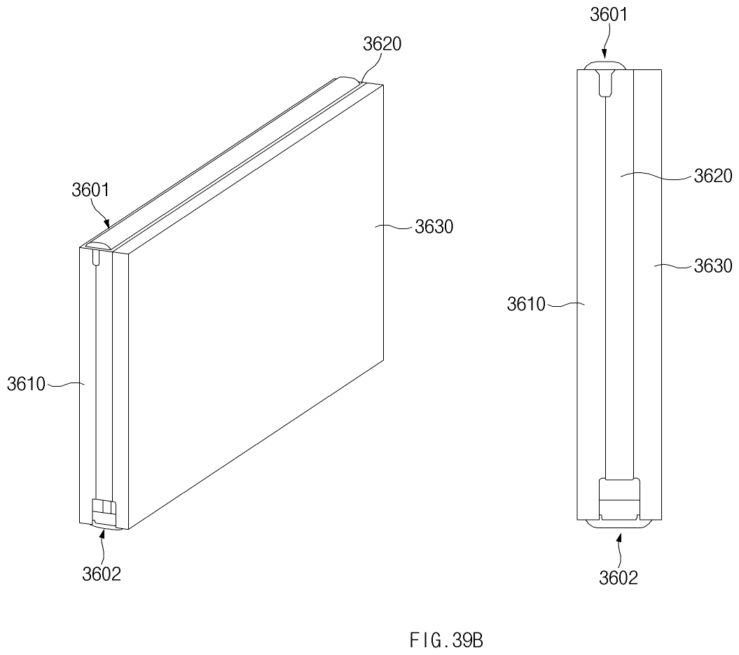

FIG. 39A is a view illustrating an embodiment of an unfolded state (or a first state) of an electronic device, and FIG. 39B is a view illustrating an embodiment of a folded state (or a second state) of an electronic device.

Referring to FIGS. 39A and 39B, an electronic device in an embodiment may include a first housing 3610, a second housing 3620, and a third housing 3630. In an embodiment, the first housing 3610, the second housing 3620, and the third housing 3630 may be configured as a foldable housing (e.g., a housing structure).

In an embodiment, the foldable housing may include a first hinge 3601 and a second hinge 3602 that foldably interconnect the first housing 3610, the second housing 3620, and the third housing 3630. The first hinge 3601 may be disposed between the first housing 3610 and the second housing 3620 to foldably interconnect the first housing 3610 and the second housing 3620. The second hinge 3602 may be disposed between the first housing 3610 and the third housing 3630 to foldably interconnect the first housing 3610 and the third housing 3630.

In an embodiment, the first hinge 3601 and the second hinge 3602 may be folded in the same or different manners. In an embodiment, each of the first hinge 3601 and the second hinge 3602 may be folded in an in-folding manner (e.g., an inward-fold type) or an out-folding manner. In an embodiment, one of the first hinge 3601 and the second hinge 3602 may be folded in an in-folding manner (e.g., an inward-fold type), and a remaining (the other) one of the first hinge 3601 and the second hinge 3602 may be folded in an out-folding manner.

In an embodiment, the electronic device may be operated such that the first housing 3610, the second housing 3620, and the third housing 3630 face substantially the same direction in a fully unfolded state (e.g., the unfolded state or the first state). In an embodiment, in the electronic device, the first housing 3610, the second housing 3620, and the third housing 3630 are stacked in the z-axis direction when in the fully folded state (e.g., the folded state or the first state).

In an embodiment, the electronic device may include a display 3730 (e.g., a flexible display, a foldable display, or a main display) that is disposed to be supported by the first housing 3610, the second housing 3620, and the third housing 3630. The display 3730 may include a first area 3711, a second area 3712, and a third area 3713 that are divided with respect to folding axes F361 and F362. In an embodiment, the first area 3711 and the second area 3712 may be divided with respect to the first folding axis (or, a central axis of the first hinge 3601) F361. The first area 3711 and the third area 3713 may be divided with respect to the second folding axis (or a central axis of the second hinge 3602) F362. The first area 3711 may be an area that is disposed in the first housing 3610 and is not deformed. The second area 3712 may be an area that is disposed in the second housing 3620 and is not deformed. The third area 3713 may be an area that is disposed in the third housing 3630 and is not deformed.

In an embodiment, the display 3730 may include a first folding area 3721 that is disposed between the first area 3711 and the second area 3712, and a second folding area 3722 that is disposed between the first area 3711 and the third area 3713. The first folding area 3721 and/or the second folding area 3722 may be deformed when the electronic device is converted into the folded state (or the second state). The first folding area 3721 may be disposed at a position that at least partially overlaps the first hinge 3601. The first folding area 3721 may be deformed as the second housing 3620 is rotated around the first folding axis F361 with respect to the first housing 3610. The second folding area 3722 may be disposed at a position that at least partially overlaps the second hinge 3602. The second folding area 3722 may be deformed as the third housing 3630 is rotated around the second folding axis F362 with respect to the first housing 3610.

The first folding area 3721 may be formed to have the same or different areas as the second folding area 3722. In an embodiment, when the curvature radii of the first folding area 3721 and the second folding area 3722 are the same or similar when the electronic device is converted into the folded state, the first folding area 3721 and the second folding area 3722 may be formed to have the same or similar areas. In an embodiment, when the curvature radii of the first folding area 3721 and the second folding area 3722 are different when the electronic device is converted into the folded state, the first folding area 3721 and the second folding area 3722 may be formed to have different areas. In an embodiment, when the radius of curvature of the first folding area 3721 is smaller than that of the second folding area 3722, in a case that the electronic device is converted into the folded state, the first folding area 3721 may be formed to have a smaller area than that of the second folding area 3722. When the radius of curvature of the first folding area 3721 is smaller than that of the second folding area 3722 when the electronic device is converted into the folded state, the width (e.g., an x-axis length) of the second folding area 3722 may be larger than the width (e.g., an x-axis length) of the first folding area 3721. When the radius of curvature of the first folding area 3721 is smaller than that of the second folding area 3722, a second width WW of the second hinge 3602 corresponding to the second folding area 3722 may be formed larger than a first width NW of the first hinge 3601 corresponding to the first folding area 3721.

In an embodiment, while the electronic device is changed from the unfolded state to the folded state, the second housing 3620 may be rotated with respect to the first housing 3610 around a first folding axis F361 through the first hinge 3601, and the third housing 3630 may be rotated with respect to the first housing 3610 around a second folding axis F362 through the second hinge 3602. In an embodiment, when the first width NW of the first hinge 3601 is different from the second width WW of the second hinge 3602, the housing 3620 and 3630 coupled to the hinges 3601 and 3602 having a smaller width may be rotated first. In an embodiment, because the first width NW of the first hinge 3601 is smaller than the second width WW of the second hinge 3602, the second housing 3620 may be rotated around the first folding axis F361 with respect to the first housing 3610 prior to the third housing 3630. The third housing 3630 may be rotated around the second folding axis F362 with respect to the first housing 3610 after the second housing 3620 has been rotated.

In an embodiment, in the electronic device, the display 3730 may be folded a plurality of times through a plurality of hinges 3601 and 3602 having different widths. The folding areas 3721 and 3722 of the display having different radii of curvature corresponding to the plurality of hinges 3601 and 3602 having different widths may be folded.

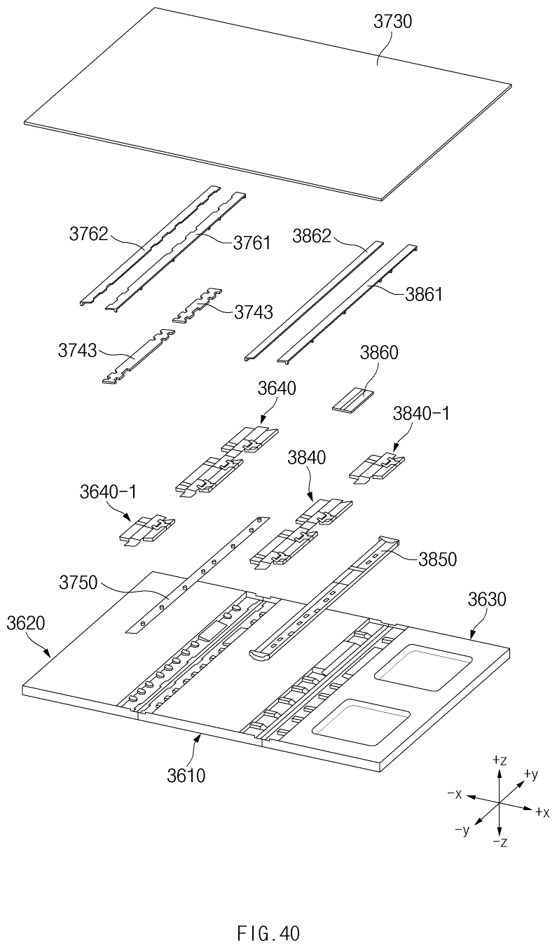

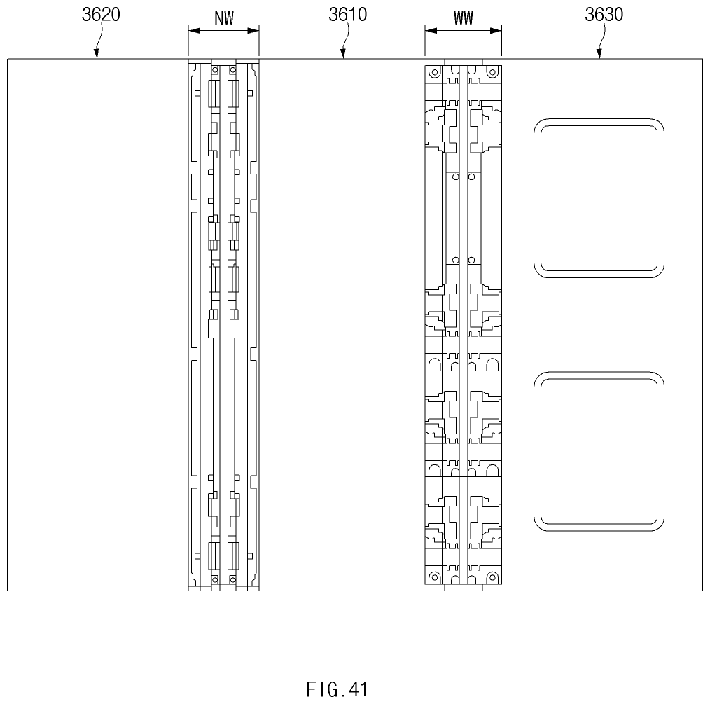

FIG. 40 is an exploded perspective view of an embodiment of at least a portion of an electronic device including a hinge, and FIG. 41 is a view illustrating an embodiment of a plurality of housings, on which hinges are disposed (e.g., mounted).

Referring to FIGS. 39A, 39B, 40, and 41, the electronic device may include a plurality of hinges 3601 and 3602 that are seated on the plurality of housings 3610, 3620, and 3630. The electronic device may include a first hinge 3601 that is disposed between the first housing 3610 and the second housing 3620, and a second hinge 3602 that is disposed between the first housing 3610 and the third housing 3630. Each of the first hinge 3601 and the second hinge 3602 may include at least one of a hinge housing 3750 and 3850, a hinge structure 3640, 3640-1, 3840, and 3840-1, a center bar 3743 and 3860, and a wing plate 3761, 3762, 3861, and 3862. In an embodiment, at least any one of the components of the hinges 3601 and 3602 may be omitted, or one or more other components may be added. In an embodiment, some of the components may be integrated into one component.

In an embodiment, the first hinge 3601 may include a first hinge housing 3750, a first hinge structure 3640 and a second hinge structure 3640-1, a first center bar 3743, a first wing plate 3761 and a second wing plate 3762. The second hinge 3602 may include a second hinge housing 3850, a third hinge structure 3840, a fourth hinge structure 3840-1, a second center bar 3860, a third wing plate 3861, and a fourth wing plate 3862.

In an embodiment, the first hinge structure 3640 and the second hinge structure 3640-1 may be spaced apart from each other along a direction (e.g., the y-axis direction) that is parallel to the first folding axis F361. The first hinge structure 3640 and the second hinge structure 3640-1 may be disposed not to be visible from the outside through the first hinge housing 3750 (e.g., the hinge cover), between the first housing 3610 and the second housing 3620. The third hinge structure 3840 and the fourth hinge structure 3840-1 may be spaced apart from each other along a direction (e.g., the y-axis direction) that is parallel to the second folding axis F362. The third hinge structure 3840 and the fourth hinge structure 3840-1 may be disposed not to be visible from the outside through the second hinge housing 3850 (e.g., the hinge cover), between the first housing 3610 and the third housing 3630.

In an embodiment, a plurality of center bars 3743 and 3860 (e.g., the center bar 243 of FIG. 2) may be disposed between the display 3730 and the hinge structures 3640, 3640-1, 3840, and 3840-1. The first center bar 3743 may be disposed to cover at least a portion of a central area of at least one of the first hinge structure 3640 and the second hinge structure 3640-1. The second center bar 3860 may be disposed to cover at least a portion of a central area of at least one of the third hinge structure 3840 and the fourth hinge structure 3840-1. In an embodiment, the first center bar 3743 may be disposed to cover at least a portion of a central area of each of the first hinge structure 3640 and the second hinge structure 3640-1. The second center bar 3860 may be disposed to cover at least a portion of the central area of the fourth hinge structure 3840-1. The first center bar 3743 may be fastened and fixed to at least one of the hinge housing 3750 and the hinge structures 3640 and 3540-1. The second center bar 3860 may be fastened and fixed to at least one of the second hinge housing 3850 and the fourth hinge structure 3840-1.

In an embodiment, a plurality of wing plates 3761, 3762, 3861, and 3862 (e.g., the wing plates 261 and 262 of FIG. 2) may be disposed between the display 3730 and the plurality of center bars 3743 and 3860. The first wing plate 3761 and the second wing plate 3762 are disposed to cover at least a portion of the surfaces of the first hinge structure 3640 and the second hinge structure 3640-1 in the z-axis direction when the electronic device is in the unfolded state. The third wing plate 3861 and the fourth wing plate 3862 are disposed to cover at least a portion of the surfaces of the third hinge structure 3840 and the fourth hinge structure 3840-1 in the z-axis direction when the electronic device is in the unfolded state.

In an embodiment, the first wing plate 3761 and the second wing plate 3762 may be disposed on opposite sides with the first center bar 3743 interposed therebetween. The first wing plate 3761 and the second wing plate 3762 may support a flat surface of the first folding area 3721 of the display 3730, in the folded state of the electronic device. The third wing plate 3861 and the fourth wing plate 3862 may be disposed on opposite sides with the second center bar 3860 interposed therebetween. The third wing plate 3861 and the fourth wing plate 3862 may support a flat surface of the second folding area 3722 of the display 3730 in the folded state of the electronic device.

In an embodiment, the first hinge 3601 may be formed to have a different size from that of the second hinge 3602. The first hinge 3601 may be formed to have a first width NW (e.g., an x-axis length), and the second hinge 3602 may be formed to have a second width WW (e.g., an x-axis length) that is greater than the first width NW. In an embodiment, the width of at least any one of the hinge housing 3750, the hinge structure 3640 and 3640-1, and the center bar 3743 included in the second hinge 3602 may be greater than the width of at least any one of the hinge housing 3850, the hinge structure 3840 and 3840-1, and the center bar 3860 included in the first hinge 3601. In an embodiment, the spacing distance (e.g., an x-axis length) between the first wing plate 3761 and the second wing plate 3762 included in the second hinge 3602 may be greater than the spacing distance (e.g., an x-axis length) between the third wing plate 3861 and the fourth wing plate 3862 included in the first hinge 3601.

In an embodiment, in the folded state of the electronic device, the display 3730 may be folded a plurality of times through the first hinge 3601 and the second hinge 3602. In the folded state, a second folding area 3722 of the display 3730 corresponding to the second hinge 3602 may be folded to have a larger radius of curvature than that of the first folding area 3721 of the display 3730 corresponding to the first hinge 3601.

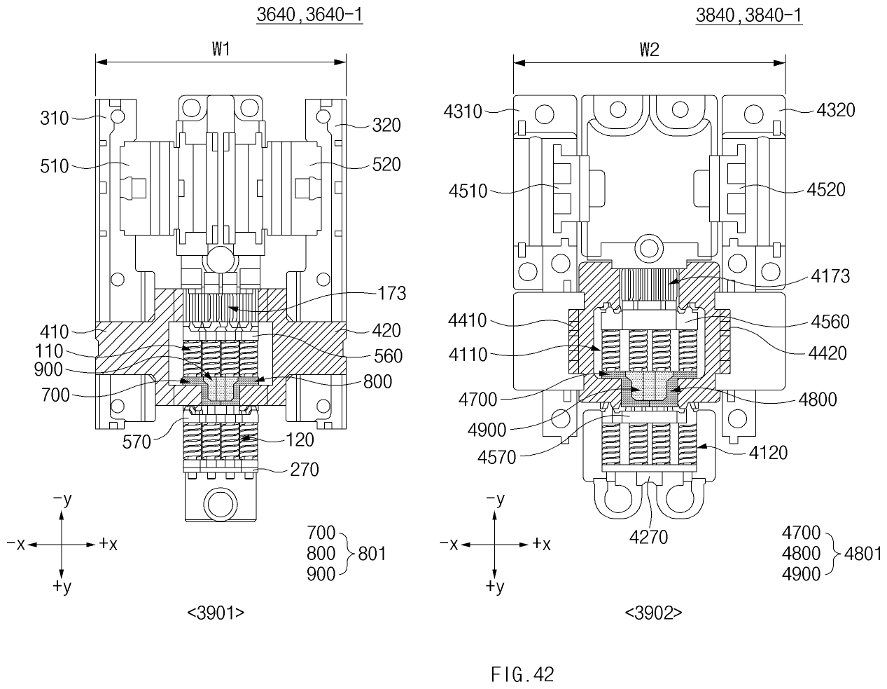

FIG. 42 is a view illustrating an embodiment of a hinge structure included in a first hinge and a hinge structure included in a second hinge. In FIG. 42, <3901> is a view illustrating at least one of the first hinge structure (e.g., the first hinge structure 3640 of FIG. 40) and a second hinge structure (e.g., the second hinge structure 3640-1 of FIG. 40) included in the first hinge (e.g., the first hinge 3601 of FIGS. 39A to 41), and <3902> is a view illustrating at least one of the third hinge structure (e.g., the third hinge structure 3840 of FIG. 40) and a fourth hinge structure (e.g., the fourth hinge structure 3840-1 of FIG. 40) included in a second hinge (e.g., the second hinge 3602 of FIGS. 39A to 41).

Referring to FIG. 39A to 42, in an embodiment, each of the first hinge structure 3640, the second hinge structure 3640-1, the third hinge structure 3840, and the fourth hinge structure 3840-1 may include a configuration corresponding to any one of the hinge structures of the first to eighth types of the embodiments described above. In an embodiment, each of the first hinge structure 3640, the second hinge structure 3640-1, the third hinge structure 3840, and the fourth hinge structure 3840-1 may include a fixing bracket, an interlocking gear 173 and 4173, a first rotation member 510 and 4510, a second rotation member 520 and 4520, a first arm member 410 and 4410, a second arm member 420 and 4420, a shaft fixing part 270 and 4270, a friction structure 801 and 4801, a cam member 560, 570, 4560, and 4570, a first elastic structure 110 and 4110, and a second elastic structure 120 and 4120. Each of the friction structures 801 and 4801 may include a first friction member 700 and 4700, a second friction member 800 and 4800, and a support member 900 and 4900.

In an embodiment, the fixing bracket, the interlocking gear 173 and 4173, the first rotation member 510 and 4510, the second rotation member 520 and 4520, the first arm member 410 and 4410, the second arm member 420 and 4420, the shaft fixing part 270 and 4270, the friction structure 801 and 4801, the cam member 560, 570, 4560, and 4570, the first elastic structure 110 and 4110, and second elastic structure 120 and 4120 included in each of the hinge structures 3640, 3640-1, 3840, and 3840-1 may have the same or similar operation and structure as those of the fixing bracket 530, the interlocking gear 173, the first rotation member 510, the second rotation member 520, the shaft fixing part 270, the cam member 560 and 570, the first elastic structure 110, and the second elastic structure 120 described above with reference to FIGS. 3 to 35.

In an embodiment, the first hinge structure 3640 and the second hinge structure 3640-1 included in the first hinge 3601 may be disposed to correspond to the first folding area 3721 of the display 3730. The third hinge structure 3840 and the fourth hinge structure 3840-1 included in the second hinge 3602 may be disposed to correspond to the second folding area 3722 of the display 3730.

In an embodiment, at least any one of the first hinge structure 3640 and the second hinge structure 3640-1 that overlap the first folding area 3721 may be formed to have a width W1 corresponding to the first width NW of the first hinge 3601. At least any one of the third hinge structure 3840 and the fourth hinge structure 3840-1 that overlap the second folding area 3722 may be formed to have a width W2 corresponding to the second width WW of the second hinge 3602. The width W2 of at least any one of the third hinge structure 3840 and the fourth hinge structure 3840-1 may be larger than the width W1 of at least any one of the first hinge structure 3640 and the second hinge structure 3640-1.

In an embodiment, at least any one of the fixing bracket, the interlocking gear 173, the first rotation member 510, the second rotation member 520, the first arm member 410, the second arm member 420, the shaft fixing part 270, the friction structure 801, the cam members 560 and 570, the first elastic structure 110, and the second elastic structure 120 included in at least any one of the first hinge structure 3640 and the second hinge structure 3640-1 may be formed to have a smaller width of that of a corresponding configuration (the fixing bracket, the interlocking gear 4173, the first rotation member 4510, the second rotation member 4520, the first arm member 4410, the second arm member 4420, the shaft fixing part 4270, the friction structure 4801, the cam members 4560 and 4570, the first elastic structure 4110, and the second elastic structure 4120) included at least any one of the third hinge structure 3840 and the fourth hinge structure 3840-1.

In an embodiment, the spacing distance between the elastic members included in at least any one of the first elastic structure 4110 and the second elastic structure 4120 of the third hinge structure 3840 and the fourth hinge structure 3840-1 may be greater than the spacing distance between the elastic members included in at least any one of the first elastic structure 110 and the second elastic structure 120 of the first hinge structure 3640 and the second hinge structure 3640-1. In an embodiment, in the electronic device, the display 3730 may be folded a plurality of times, through the first hinge structure 3640 and the second hinge structure 3640-1, and the third hinge structure 3840 and the fourth hinge structure 3840-1 having different widths from those of the first hinge structure 3640 and the second hinge structure 3640-1.

Based on at least some of the above-described embodiments, a foldable electronic device according to at least one of the plurality of embodiments of the disclosure may include: a display 230; a first housing 210 and a second housing 220, in which at least a portion of the display is disposed; and hinge structures 240 and 240-1 coupled to the first housing and the second housing, and at least any one of the hinge structures 240 and 240-1 may include: a first rotation member 510 being rotated in response to rotation of the first housing; a second rotation member 520 being rotated in response to rotation of the second housing; a first arm member 410 being rotated in response to rotation of the first rotation member 510; a second arm member 420 being rotated in response to rotation of the second rotation member 520; a first shaft 131 coupled to the first arm member 410; a second shaft 132 coupled to the second arm member 420; a third shaft 133 and a fourth shaft 134 disposed between the first shaft 131 and the second shaft 132; a first elastic structure 110 including a first elastic member 111 disposed in the first shaft 131, a second elastic member 112 disposed in the second shaft 132, a third elastic member 113 disposed in the third shaft 133, and a first elastic structure 110 including a fourth elastic member 114 disposed in the fourth shaft 134; and a friction structure 801 disposed between the first arm member 410 and the second arm member 420.

In an embodiment, the friction structure 801 includes: a first friction member 700 disposed between the first elastic member 111 and a portion of the first arm member 410, and including a first curved surface 751 corresponding to a first outer peripheral surface 435 of the first arm member 410; a second friction member 800 disposed between the second elastic member 112 and a portion of the second arm member 420, and including a second curved surface 851 corresponding to a second outer peripheral surface 1435 of the second arm member 420; and a support member 900 disposed between the first friction member 700 and the second friction member 800, configured to press the second friction member 800 in a second direction facing the second arm member 420 while pressing the first friction member 700 in a first direction facing the first arm member 410 based on an elastic force from the third elastic member 113 and the fourth elastic member 114, configured to allow the first curved surface 751 of the first friction member 700 to form a frictional contact with the first outer peripheral surface 435 of the first arm member 410 in at least a partial rotation range of the first arm member 410 and to allow the second curved surface 851 of the second friction member 800 to form a frictional contact with the second outer peripheral surface 1435 of the second arm member 420 in at least a partial rotation range of the first arm member 410.

In an embodiment, the friction structure 801 may include: a first friction member 700 disposed between the first elastic member and the first arm member 410, and including a first curved surface 751 that generates friction while contacting a first outer peripheral surface 435 of the first arm member 410 in response to the rotation of the first arm member 410; a second friction member 800 disposed between the first elastic member and the second arm member 420, and including a second curved surface 851 that generates friction while contacting a second outer peripheral surface 1435 of the second arm member 420 in response to the rotation of the second arm member 420; and a support member 900 disposed between the first friction member 700 and the second friction member 800, and configured to press the first friction member and the second friction member.

In an embodiment, while the foldable electronic device is moved in a first partial rotation range between an unfolded state and a folded state, the first curved surface 751 of the first friction member 700 may increase a frictional contact with the first outer peripheral surface 435 of the first arm member 410 due to an increased pressure of the support member 900, and the second curved surface 851 of the second friction member 800 may increase a frictional contact with the second outer peripheral surface 1435 of the second arm member 420 due to an increased pressure of the support member 900.

In an embodiment, while the foldable electronic device is moved in a second partial rotation range between an unfolded state and a folded state, the first curved surface 751 of the first friction member 700 may decrease a frictional contact with the first outer peripheral surface 435 of the first arm member 410 due to a decreased pressure of the support member 900, and the second curved surface 851 of the second friction member 800 may decrease a frictional contact with the second outer peripheral surface 1435 of the second arm member 420 due to a decreased pressure of the support member 900.

In an embodiment, while the foldable electronic device is changed from the unfolded state to the folded state or from the folded state to the unfolded state, the first curved surface 751 of the first friction member 700 may maintain contact with the first outer peripheral surface 435 of the first arm member 410 in response to the press of the support member 900, and the second curved surface 851 of the second friction member 800 may maintain contact with the second outer peripheral surface 1435 of the second arm member 420 in response to the press of the support member 900.

In an embodiment, the first elastic member 111 may press the first friction member 700 in a third direction being perpendicular to the first direction, and the second elastic member 112 may press the second friction member 800 in the third direction being perpendicular to the second direction.

In an embodiment, the first arm member 410 may include: a first arm part 411 formed in a cylindrical shape surrounding the first arm hole, into which the first shaft 131 is inserted, and the first arm part 411 may include: a first arm surface 431 facing the first elastic member 111; and a first outer peripheral surface 435 facing the first friction member 700.

The second arm member 420 may include: a third arm part 421 formed in a cylindrical shape surrounding the second arm hole, into which the second shaft 132 is inserted, and the third arm part 421 may include: a third arm surface facing the second elastic member 112; and a third arm part including an outer peripheral surface facing the second friction member 800.

In an embodiment, the first friction member 700 may include: a first body 713 including a first body 713 including a first curved surface surrounding a portion of the first outer peripheral surface of the first arm part; a first outer part 711 protruding between the first elastic member and the first arm surface from the first body, and including a first outer hole communicating the first arm hole; and a second outer part 712 protruding between the support member and the cam member from the first body, and including a second outer hole, into which the third shaft is inserted.

In an embodiment, the second friction member 800 may include: a second body including the second curved surface surrounding a portion of the outer peripheral surface of the third arm part; a third outer part 811 protruding between the second elastic member and the third arm surface from the second body, and including a third outer hole communicating with the second arm hole 442; and a fourth outer part 812 protruding from the second body between the support member and the cam member, and including a fourth outer hole 814, into which the fourth shaft 134 is inserted.

In an embodiment, the support member 900 may include: a first support part 911 including a first inner hole 914, into which the third shaft 133 is inserted, and communicating with the second outer hole 714; and a second support part 912, into which the fourth shaft 134 is inserted, and communicating with the fourth outer hole 814.

In an embodiment, the first support part 911 and the second support part 912 may be spaced apart from each other through an opening.

In an embodiment, the first friction member 700 may include: at least one outer inclined surface 761 and 762 formed to be inclined at a predetermined angle with respect to the first outer part 711 and the first body 713, respectively, and the second friction member 800 may include: at least one outer inclined surface 861 and 862 formed to be inclined at a predetermined angle with respect to the third outer part 811 and the second body, respectively.

In an embodiment, the support member 900 may include: a plurality of inner inclined surfaces 961, 962, 971, and 972 facing the outer inclined surface of the first friction member 700 and the outer inclined surface of the second friction member 800.

In an embodiment, the first arm member 410 further may include: a second arm part 412 spaced apart from the first arm part 411 with the first elastic structure 110 interposed therebetween, and the second arm member 420 further may include: a fourth arm part 422 spaced apart from the third arm part with the first elastic structure 110 interposed therebetween.

In an embodiment, the cam member may include: a second cam member 570 coupled to the first cam structure formed in the first am part and the third cam structure formed in the third arm part; and a first cam member 560 coupled to the second cam structure formed in the second arm part and the fourth cam structure formed in the fourth arm part.

In an embodiment, the foldable electronic device may further include: a shaft fixing part 270 fixing the first shaft, the second shaft, the third shaft, and the fourth shaft; and a second elastic structure 120 disposed between the shaft fixing part and the first cam member 570.

In an embodiment, the second elastic structure 120 may include: a fifth elastic member 121 disposed in the first shaft 131; a sixth elastic member 122 disposed in the second shaft 132; a seventh elastic member 123 disposed in the third shaft 133; and an eighth elastic member 124 disposed in the fourth shaft 134.

In an embodiment, the foldable electronic device may further include: a second friction structure 2100 disposed between each of the first friction member 700 and the second friction member 800, and the second elastic structure 120, and including a first lower inclined surface 2101 and a second lower inclined surface 2102 being symmetrical to each other.

In an embodiment, the first friction member 700 further may include: a first upper inclined surface 763 facing the first lower inclined surface, and the second friction member further may include: a second upper inclined surface 863 facing the second lower inclined surface.

A hinge structure in an embodiment of the disclosure may include: a first rotation member 510 being rotated around a first axis; a first arm member 410 being rotated in response to rotation of the first rotation member; a second rotation member 520 being rotated around a second axis; a second arm member 420 being rotated in response to rotation of the second rotation member; a first shaft 131 fastened to the first arm member; a second shaft 132 between the first elastic structure and the cam members the second arm member; a third shaft disposed between the first shaft and the second shaft; fourth shaft 134 disposed between the third shaft and the second shaft; first elastic structure 110 including a plurality of elastic members disposed in the first shaft, the second shaft, the third shaft, and the fourth shaft, respectively; and a friction structure 801 disposed between the first elastic structure and the cam member.

In an embodiment, the friction structure 801 may include: a first friction member 700 disposed between the first elastic member and the first arm member 410, and contacting the first arm member; a second friction member 800 disposed between the first elastic member and the second arm member 420, and contacting the arm member; and a support member 900 configured to press the first friction member toward the first arm member in response to the rotation of the first arm member and press the second friction member toward the second arm member in response to the second arm member.

In an embodiment, the first arm member 410 may include: a first arm part 411 formed in a cylindrical shape surrounding a first arm hole, into which the first shaft 131 is inserted.

In an embodiment, the first arm part 411 may include: a first arm surface 431 facing the first elastic structure; and a first outer peripheral surface 435 facing the first friction member.

In an embodiment, the second arm member 420 includes: a third arm part 411 formed in a cylindrical shape surrounding a second arm hole, into which the second shaft 132 is inserted.

In an embodiment, the third arm part 421 may include: a third arm part including a third arm surface facing the first elastic structure, and an outer peripheral surface facing the first friction member.

In an embodiment, the first friction member 700 may include: a first body 713 including a first curved surface surrounding a portion of the first outer peripheral surface of the first arm part; a first outer part 711 protruding between the first elastic member and the first arm surface from the first body, and including a first outer hole communicating with the first arm hole; a second outer part 712 protruding from the first body between the support member and the cam member, and including a second outer hole, into which the third shaft is inserted; and at least one outer inclined surfaces 761 and 762 formed to be inclined at a predetermined angle with respect to the first outer part 711 and the first body 713.

In an embodiment, the second friction member 800 may include: a second body including the second curved surface surrounding a portion of the outer peripheral surface of the third arm part; a third outer part 811 protruding between the second elastic member and the third arm surface from the second body, and including a third outer hole communicating with the second arm hole; a fourth outer part 812 protruding from the second body between the support member and the cam member, and including a fourth outer hole, into which the fourth shaft is inserted; and at least one outer inclined surface 861 and 862 formed to be inclined at a predetermined angle with respect to the third outer part 811 and the second body.

In an embodiment, the support member 900 may include: a first support part 911 including a first inner hole 914, into which the third shaft is inserted, and communicating with the second outer hole; a second support part 912, into which the fourth shaft is inserted, and communicating with the fourth outer hole; and a plurality of inner inclined surfaces 961, 962, 971, and 972 facing an outer inclined surface of the first friction member and an outer inclined surface of the second friction member.

In an embodiment, the electronic device of various embodiments disclosed in the disclosure may include a mobile electronic device, and may be provided as being included in a computer program product related to the operation of the mobile electronic device. The computer program product may be traded between a seller and a buyer as a product. The computer program product may be distributed in the form of a machine-readable storage medium (e.g., compact disc read only memory (CD-ROM)) or may be distributed (e.g., downloaded or uploaded), through an application store (e.g., PlayStore™), directly between two user devices (e.g., smartphones), or online. In the case of on-line distribution, at least part of the computer program product may be at least temporarily stored in the machine-readable storage medium such as the memory of a manufacturer's server, an application store's server, or a relay server or may be generated temporarily.

According to various embodiments, each component (e.g., a module or a program) of the above-described components may include a single entity or a plurality of entities, and some of the plurality of objects may be separately arranged on other components. According to various embodiments, one or more components of the above-described components or operations may be omitted, or one or more other components or operations may be added. In an alternative embodiment or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to various embodiments, operations executed by modules, programs, or other components may be executed by a successive method, a parallel method, a repeated method, or a heuristic method. In an alternative embodiment, at least one or more of the operations may be executed in another order or may be omitted, or one or more operations may be added.

What is claimed is:

1. A foldable electronic device comprising:
a display;
a first housing and a second housing in which at least a portion of the display is disposed; and
first hinge structures coupled to the first housing and the second housing, at least one of the first hinge structures including:
a first rotation member configured to rotate with rotation of the first housing;
a second rotation member configured to rotate with rotation of the second housing;
a first arm member configured to rotate with rotation of the first housing;
a second arm member configured to rotate with rotation of the second housing;
a first shaft coupled to the first arm member;
a second shaft coupled to the second arm member;
a third shaft and a fourth shaft disposed between the first shaft and the second shaft;
a first elastic structure including:
a first elastic member disposed on the first shaft;
a second elastic member disposed on the second shaft;
a third elastic member disposed on the third shaft; and
a fourth elastic member disposed on the fourth shaft; and
a friction structure disposed between the first arm member and the second arm member, the friction structure including:
a first friction member disposed between the first elastic member and a portion of the first arm member, the first friction member including:
a first curved surface configured to correspond with a first outer circumferential surface of the first arm member;
a second friction member disposed between the second elastic member and a portion of the second arm member, the second friction member including:
a second curved surface configured to correspond with a second outer circumferential surface of the second arm member; and
a support member disposed between the first friction member and the second friction member and configured to press the first friction member in a first direction toward the first arm member while pressing the second friction member in a second direction toward the second arm member, based on an elastic force from the third elastic member and the fourth elastic member to cause the first curved surface of the first friction member to establish a frictional contact with the first outer circumferential surface of the first arm member during at least a partial rotation range of the first arm member, and to cause the second curved surface of the second friction member to establish a frictional contact with the second outer circumferential surface of the second arm member during at least a partial rotation range of the second arm member.

2. The foldable electronic device of claim 1, wherein, while the foldable electronic device is moved through a first partial rotation range between an unfolded state and a folded state,
the first curved surface of the first friction member is configured to increase frictional contact with the first outer circumferential surface of the first arm member caused by increased pressing of the support member, and
the second curved surface of the second friction member is configured to increase frictional contact with the second outer circumferential surface of the second arm member caused by increased pressing of the support member.

3. The foldable electronic device of claim 1, wherein, while the foldable electronic device is moved through a second partial rotation range between an unfolded state and a folded state,
the first curved surface of the first friction member is configured to decrease frictional contact with the first outer circumferential surface of the first arm member caused by decreased pressing of the support member, and
the second curved surface of the second friction member is configured to decrease frictional contact with the second outer circumferential surface of the second arm member caused by decreased pressing of the support member.

4. The foldable electronic device of claim 1, wherein the first elastic member is configured to press the first friction member in a third direction perpendicular to the first direction,
wherein the second elastic member is configured to press the second friction member in the third direction perpendicular to the second direction, and
wherein the third elastic member and the fourth elastic member are configured to press the support member in the third direction.

5. The foldable electronic device of claim 1, wherein the first arm member includes a first arm part into which the first shaft is inserted,
wherein the first arm part includes:
a first arm surface facing the first elastic member; and
the first outer circumferential surface facing the first friction member,
wherein the second arm member includes a third arm part into which the second shaft is inserted, and
wherein the third arm part includes:
a third arm surface facing the second elastic member; and
the second outer circumferential surface facing the second friction member.

6. The foldable electronic device of claim 5,
wherein the first friction member includes:
a first body including the first curved surface surrounding a portion of the first outer circumferential surface of the first arm part;
a first outer part protruding from the first body between the first elastic member and the first arm surface and including a first outer hole into which the third shaft is inserted, and
a second outer part protruding from the first body in the second direction and including a second outer hole into which the third shaft is inserted.

7. The foldable electronic device of claim 6, wherein the second friction member includes:
a second body including the second curved surface surrounding a portion of the outer circumferential surface of the third arm part;
a third outer part protruding from the second body between the second elastic member and the third arm surface and including a third outer hole into which the second shaft is inserted; and
a fourth outer part protruding from the second body in the first direction and including a fourth outer hole into which the fourth shaft is inserted.

8. The foldable electronic device of claim 7, wherein the support member includes:
a first support part including a first inner hole into which the third shaft is inserted and communicating with the second outer hole; and
a second support part including a second inner hole into which the fourth shaft 134 is inserted and communicating with the fourth outer hole.

9. The foldable electronic device of claim 7, wherein the first friction member includes at least one outer inclined surface and inclined at a predetermined angle with respect to each of the first outer part and the first body, and
wherein the second friction member includes at least one outer inclined surface inclined at a predetermined angle with respect to each of the third outer part and the second body.

10. The foldable electronic device of claim 9, wherein the support member includes a plurality of inner inclined surfaces facing each of the at least one outer inclined surface of the first friction member and the at least one outer inclined surface of the second friction member.

11. The foldable electronic device of claim 10, wherein the first arm member further includes a second arm part spaced apart from the first arm part with the first elastic structure interposed therebetween, and
wherein the second arm member further includes a fourth arm part spaced apart from the third arm part with the first elastic structure interposed therebetween.

12. The foldable electronic device of claim 11, further comprising:
a first cam member supporting the first elastic structure; and
a second cam member coupled to each of the first arm member and the second arm member,
wherein the first cam member is coupled to a first cam structure included in the first arm member and a second cam structure included in the second arm member, and
wherein the second cam member is coupled to a third cam structure included in the first arm member and a fourth cam structure included in the second arm member.

13. The foldable electronic device of claim 12, further comprising:
a shaft fixing part which fixes the first shaft, the second shaft, the third shaft and the fourth shaft; and
a second elastic structure disposed between the shaft fixing part and the second cam member,
wherein the second elastic structure includes:
a fifth elastic member disposed on the first shaft;
a sixth elastic member disposed on the second shaft;
a seventh elastic member disposed on the third shaft; and
an eighth elastic member disposed on the fourth shaft.

14. The foldable electronic device of claim 13, further comprising:
a second friction structure disposed between each of the first friction member and the second friction member, and the second elastic structure,
wherein the second friction structure includes a first lower inclined surface and a second lower inclined surface symmetrical to each other.

15. The foldable electronic device of claim 14, wherein the first friction member further includes a first upper inclined surface facing the first lower inclined surface, and
wherein the second friction member further includes a second upper inclined surface facing the second lower inclined surface.

16. The foldable electronic device of claim 1, wherein the first arm member includes a first arm protrusion protruding toward the first friction member, and
wherein the second arm member includes a second arm protrusion protruding toward the second friction member.

17. The foldable electronic device of claim 1, further comprising:
a third housing; and
second hinge structures and coupling to the first housing and the third housing,
wherein a first width of at least one of the first hinge structures that couples the first housing and the second housing is formed to be different from a second width of at least one of the second hinge structures.

18. A hinge structure included in a foldable electronic device, the hinge structure comprising:
a first rotation member configured to rotate around a first axis;
a first arm member configured to rotate in response to rotation of the first rotation member;
a second rotation member configured to rotate around a second axis;
a second arm member configured to rotate in response to rotation of the second rotation member;
a first shaft coupled to the first arm member;
a second shaft coupled to the second arm member;
a third shaft disposed between the first shaft and the second shaft;
a fourth shaft disposed between the third shaft and the second shaft;
a first elastic structure including:
a plurality of elastic members disposed in the first shaft, the second shaft, the third shaft, and the fourth shaft, respectively; and
a friction structure disposed between the first arm member and the second arm member, the friction structure including:
a first friction member disposed between a first elastic member of the plurality of elastic members and the first arm member, and including a first curved surface contacting a first outer peripheral surface of the first arm member;
a second friction member disposed between a first elastic member of the plurality of elastic members and the second arm member, and including a second curved surface contacting a second outer peripheral surface of the second arm member; and
a support member disposed between the first friction member and the second friction member, and configured to press the first friction member and the second friction member.

19. The hinge structure of claim 18, wherein, while the hinge structure is changed from an unfolded state to a folded state or from the folded state to the unfolded state,
the first curved surface of the first friction member maintains contact with the first outer peripheral surface of the first arm member in response to the press of the support member, and
the second curved surface of the second friction member maintains contact with the second outer peripheral surface of the second arm member in response to the press of the support member.

20. The hinge structure of claim 19, wherein, while the hinge structure is moved through a first partial rotation range between the unfolded state and the folded state, the first curved surface of the first friction member is configured to increase a frictional contact with the first outer peripheral surface of the first arm member caused by increased pressing of the support member, and the second curved surface of the second friction member is configured to increase frictional contact with the second outer peripheral surface of the second arm member caused by increased pressing of the support member, and
wherein, while the hinge structure is moved through a second partial rotation range between the unfolded state and the folded state,
the first curved surface of the first friction member is configured to decrease frictional contact with the first outer peripheral surface of the first arm member caused by decreased pressing of the support member, and the second curved surface of the second friction member is configured to decrease frictional contact with the second outer peripheral surface of the second arm member caused by decreased pressing of the support member.
